(19) United States
(12) Patent Application Publication
(10) Pub. No.: US 2009/0201176 A1
(43) Pub. Date: Aug. 13, 2009

(54) Route guidance system

(76) Inventors: Takanori Shimada, Tokyo (JP); Yoshiyuki Furukawa, Tokyo (JP)

Correspondence Address: DAY PITNEY LLP, 7 TIMES SQUARE, NEW YORK, NY, 10036-7311, US

(21) Appl. No.: 10/333,677

(22) PCT Filed: Sep. 10, 2001
(86) PCT No.: PCT/JP01/07845

§ 371 Date: Apr. 21, 2009

(30) Foreign Application Priority Data
Sep. 11, 2000 (JP) 2000-274613

(51) Int. Cl. G08G 1/095; G06K 9/00

(52) U.S. Cl. 340/944; 382/100

(57) ABSTRACT

Provided is a route guidance system that provides a route in premises in order to perform service of route guidance in the premises, which includes: a route guidance apparatus, which is comprised of visible region calculation means that calculates a range where a user can see, signpost extraction means that extracts a signpost to be guided from a visible region, route search means that searches the route from a starting point to a destination, route information generation means that comprises guidance map generation means that generates a map for guidance and guidance sentence generation means that generates the guidance sentence, route leading means that obtains current positional information to send appropriate guidance information to a portable terminal, and position determination means that performs coordinate conversion to information from a position detection apparatus of the user; a portable terminal apparatus including a user interface, which displays an image or a route guidance sentence; a position detection apparatus that obtains current positional information of the user; a map DB that stores data/signpost information regarding the route; a guidance sentence DB that stores basic data for generating the guidance sentence; and route information data that stores guidance data output from the route information generation means.

### BACKGROUND OF THE INVENTION

1. Field of the Invention

The present invention relates to an apparatus and a system for providing a person, who is not good at reading a map, with guidance including landmark information and route information regarding a direction where the moving person needs to proceed when moving in an architectural structure such as a building with a method using an image or the like such that the user does not became lost in an open space. Further, the present invention also relates to a calculation apparatus of a visible region and a program thereof, which are necessary in extracting a land mark to support the movement of the moving person.

2. Description of the Prior Art

In the prior art, there has existed the following known references regarding a system that performs route guidance in premises or in a building.

The invention disclosed in Japanese Patent Laid-open No. 8-190688 is one that provides a pedestrian in the premises, who is a pedestrian having difficulty to obtain whereabouts of himself/herself or guidance information to a destination, of appropriate guidance information. A user reads information of radio wave reaction apparatuses embedded in the premises using an information reader, and the information to be output changes according to user's information set in a user information setting section although its contents are fixed. Further, a pedestrian guidance apparatus can be provided inexpensively.

Furthermore, in the invention disclosed in Japanese Patent Laid-Open No. 11-276516, it is one that provides a vision-impaired person in a train station with information such as a route to a destination and a landmark through a portable terminal by audio input/output, detects the position of the handicapped person by a tag, and lends/guides the vision-impaired person safely and accurately.

However, the following problems have not been solved in the prior art. There have been the problems:

(1) In the prior art, a movement instruction at an intersection such as ‘Turn right at the intersection of . . . ’ is shown based on route data. But, in the premises in the case of diagonally crossing an open space such as an atrium, a vault and a concourse although giving route guidance based on landmarks is more simple, the prior art gives a guidance so as to go around the sides of the open space, for example, along the route data on the map;
(2) In the route guidance using the portable terminal of a low resolution and a small screen, a color image is hard to watch when it is directly sent to the terminal. In addition, the color image requires a long transfer time due to a large data quantity. Further, in an image of low compress ion effect even by a binary image, many route guidance points cannot be displayed when the route becomes long;
(3) In the case of guiding a route with a map divided in frames, there are individual variations as to where to display the route to be more understandable, some users feel that the route is hard to read if it is always displayed in the center because of lack of continuity between frames and other users feel it is better to display the route always in the center, therefore, display must be changed for each user;
(4) In the case of performing route leading, since current positional information of the user from position detection means includes an error, the current position goes off from a position where the user actually is when the current position is guided based on the positional information from the position detection means. Further, when a traveling direction of the route is guided based on the positional information from the position detection means, it is different from the actual traveling direction of the user; and
(5) In the case of performing position detection using the tag, there is a case where a reader cannot detect the tag, and thus appropriate route leading cannot be made.

Furthermore, as shown in Japanese Patent Laid-open No. 9-167297 ‘Intersection guidance apparatus’, in a system that performs route guidance taking in consideration things that come into view, there is a case where an intersection guided cannot be seen from the current position in guiding information regarding the intersection such as ‘Turn right at the next intersection’ in a car navigation system. In this case, whether or not a range of vision from the current position to the intersection guided is blocked is calculated, and the guidance is announced at the point when a vehicle has traveled to a point where vision is not blocked.

However, in Japanese Patent Laid-Open No. 9-1672 97, whether or not a straight line from the current posit ion to the intersection crosses a polygon, which constitutes landmarks near the intersection is only deter mined, and since this is not a processing to determine what is in the range of vision, it is impossible to extract the landmark in the range of vision and guide the route utilizing the landmark.

Further, as a visible region calculation algorithm in the case of a plurality of polygons as shown in ‘Computational geometry and geographical information processing’ (the second edition) (4.6.2. problem of visibility), when a set of n pieces of line segments, which do not cross with each other except for an end point, and a viewpoint are given, there exists a method that calculates by a task of O(n log n) assuming that the sum of sides of an polygons by a plane scanning method is n, in which a half line from the viewpoint is made rotate once. A processing outline is shown as follows. In the processing, the visible region is calculated while finding the sets of line segments (S₀, S₁, S₂, . . . ).

(Pre-processing) The end points that constitute each line segment are arranged in an argument order. Herein, the argument is an angle formed by a half line l from the viewpoint, which shows a reference direction, and a half line drawn from the viewpoint to the end point of the line segment. A result where the end points of the line segments are arranged in the argument order is shown as L, and the number of L elements is shown as N. An order is put to the end points of each line segment in an anti-clockwise order around the viewpoint, which is defined as an origin and an ending point. Further, the L elements can be brought out in the order where they have been arranged from the natural number of 0.

(1) The set S₀ of the first line segments that cross the half line l from the viewpoint, which shows a reference direction, is obtained. Among line segments that cross the half line l, an inters acting point with a line segment nearest the viewpoint is stored as an origin Ps of a visible polygon.

(2) It is assumed that i=0.

(3) The i-th element of L is brought out. If the line segment having the i-th element as the end point is included in Sᵢ, the line segment is pulled out from Sᵢ, and the line segment is added if it is not included in Sᵢ. The result is set as Sᵢ₊₁.

There exists the foregoing method. Assuming from the foregoing, the processing is considered to proceed as follows. Specifically, the line segments of Sᵢ₊₁ are sorted from the one nearest the viewpoint, that is, from the one having the intersecting point with the half line drawn from the viewpoint to an end point of the i-th element, which is nearest the viewpoint.

i) The followings are performed when the number of the L elements is two or more.

When the top element is pulled out regarding Sᵢ, the line segment from the origin Ps of the visible polygon to a point Pc of the element is drawn because the element is the ending point. Further, a point Pₓ where the half line from the viewpoint, which passes the element Pc, crosses the line segment being the second element from the top of Sᵢ is obtained, the line segment from Pc to Pₓ is drawn, and Pₓ is set as Ps.

When the top element is added regarding Sᵢ, a point Pₓ where the half line from the viewpoint, which passes the element Pc, crosses the line segment being the top element of Sᵢ is obtained because the element is the origin, the line segment from Ps to Pₓ is drawn and the line segment from Pₓ to Pc is drawn. Pc is set as Ps.

ii) The following is performed, because when the number of the L elements is less than two, it is the outer most line segment.

When the top element is pulled out regarding Sᵢ, the line segment from Ps to the point Pc of the element is drawn because the element is the ending point of the line segment. Pc is set as Ps.

When the top element is added regarding Sᵢ, the line segment from Ps to Pc is drawn because the element is the origin of the segment. Pc is set as Ps.

(4) i=i+1. That is, i is incremented by one. The processing stops when i=N. (If not, it proceeds to iii).

A specific example of the foregoing processing will be described: assuming the viewpoint shown by ⋆, the half line 1 showing the reference direction, and the line segment are given as in FIG. 98 (a line segment having the end points z₀ and z₁ shall be expressed in z), the processing proceeds as follows.

The case of i=0: Since a is included in S₀={b,a,g}, it is pulled out and sorted, and S₁={b,g} is set. Drawing is not performed because a is not the top of a list.

The case of i=1: Since b is included in S₁={b,g}, it is pulled out and sorted, and S₂={g} is set. The line segment bₓb₁gₓ is drawn from be that is Ps, and gₓ is stored as Ps.

The case of i=2: Since g is included in S₂={g}, it is pulled out and sorted, and S₃={ } is set. The line segment gₓg₁ is drawn from gₓ that is Ps, and g₁ is stored as Ps.

The case of i=3: Since h is not included in S₃={ }, it is added and sorted, and S₄={h} is set. The line segment g₁h₀ is drawn from g₁ that is Ps, and h₀ is stored as Ps.

The case of i=4: Since c is not included in S₄={h}, it is added and sorted, and S₅={c,h} is set. The line segment h₀hₓc₀ is drawn from h₀ that is Ps, and c₀ is stored as Ps.

The case of i=5: Since c is included in S₅={c,h}, it is pulled out and sorted, and S₆={h} is set. The line segment c₀c₁hₓ is drawn from c₀ that is Ps, and hₓ is stored as Ps.

However, in the method by the plane scanning method in which the half line from the viewpoint is made rotate once, although n log n is certainly enough for the processing of (3), S₀ needs to be obtained after an optimal line segment 1 is decided in the processing of (1), and there has existed a problem that a calculation amount in deciding the half line l was large and it was not necessarily performed by a small task considering the processing of (1).

The present invention solves the problem, forms the visible region faster than before, and provides the visible landmark when the user moves on the route based on the visible region formed even in the case where the open space has an obstacle that blocks the range of vision, and its object is to provide a route guidance system that includes the following a to k:

a. visible region calculation means that calculates a region where the moving person can look over in the open space even in the case where the obstacle exists;

b. route search means that searches the route from a starting point to the destination;

c. guidance sentence generation means that generates a route guidance sentence;

d. guidance map generation means that generates a map used in the route guidance;

e. signpost extraction means that extracts a signpost to be guided out of the foregoing visible region;

f. route information generation means;

g. position determination means that converts the positional information obtained from position detection means into a coordinate on the map;

h. route leading means;

i. position detection means that identifies a plane where the moving person is;

j. a portable terminal by which the moving person receives the route guidance information; and

k. a route map database where route data is stored.

### SUMMARY OF THE INVENTION

The present invention is characterized in that it comprises: the position determination means that detects the current position of the user; the visible region calculation means that calculates the range where the user can see from the current position detected; the route search means that searches the route from the starting point to the destination; traveling direction calculation means that calculates a traveling direction from the visible region and the route; the signpost extraction means that extracts the signpost to be guided out of the visible region; and route guidance sentence generation means that generates the route guidance sentence of the route found, and the invention is further characterized in that it comprises: image data retrieval means that retrieves binary image data or illustration image data, which are specified to guide a point passing the route; and guidance sentence synthesis means to synthesize guidance sentences to guide the point to pass, and the invention is further characterized in that it comprises: a position detection apparatus that identifies the place where the moving person is; route leading means 1 that performs route guidance every time when a position is detected by a tag; route leading means 2 that performs route guidance by a key operation of the user; and position estimation means that estimates the position of the user when the tag cannot be read.

With the foregoing, the region where the user can look over is calculated by the positional information of the user, the route guidance that guides the signpost regardless of how the route data is formed on the database is enabled, and it is enabled that the route guidance is performed without interruption either by estimating the position or the key operation of the user even in the case where the position detection means fails to detect the tag.

Furthermore, the present invention comprises: the visible range calculation means that calculates the range where the user can see; target extraction means that extracts a target to be guided out of the visible region; the route search means that searches the route from the starting point to the destination; route information generation means including the guidance map generation means that generates the map for guidance and the guidance sentence generation means that generates the guidance sentence; the route guidance apparatus comprises the route leading means that obtains current positional information to send appropriate guidance information to the portable terminal and the position determination means that converts the information from a user's position detection apparatus into a coordinate; a terminal having a user interface, which displays an image or the route guidance sentence; the position detection apparatus that obtains user's current positional information; a map database that stores data regarding the route and landmark information; a guidance sentence database that stores basic data to generate the guidance sentence; and a route information database that stores the guidance data output from the route information generation means.

With the foregoing, the route information easy for the user to understand can be provided.

Further, in the present invention, a visible region calculator is pro vided. In which it calculates a visible range regarding the outermost visible region first and then calculates the visible region in the order where the line segments constituting the obstacles are rearranged based on the argument.

Accordingly, the visible region can be calculated more efficiently than a conventional plane operation method, and the route guidance processing thus can be efficiently performed.

### BRIEF DESCRIPTION OF THE DRAWINGS

FIG. 1 is a configuration view of a route guidance system of the present invention.

FIG. 2 is a system configuration view of the route guidance means 1.

FIG. 3 is a configuration view of a portable terminal apparatus.

FIG. 4 is an entire view of premises used in embodiment 2.

FIG. 5 is a flowchart of the route guidance means 1.

FIG. 6 is a view of a visible polygon used in embodiment 1.

FIG. 7 is a view where the visible polygon and a route are superposed near a destination, which is used in embodiment 1.

FIG. 8 is a system configuration view of the route guidance means 2.

FIG. 9 a flowchart of the route guidance means 2.

FIG. , is a view used in embodiment 2, where the visible polygon is calculated from E in a premises view.

FIG. 11 is a view of a binary image at point U in FIG. 4.

FIG. 12 is a view of a binary image at point Q in FIG. 4.

FIG. 13 is a view of a binary image at point R in FIG. 4.

FIG. 44 is a view of a binary image at point S in FIG. 4.

FIG. 15 is a view of a binary image at point T in FIG. 4.

FIG. 16 is a system configuration view of a route guidance means 3.

FIG. 17 is a flowchart of the route guidance means 3.

FIG. 18 is a flow chart of frame map generation means 1.

FIG. 19 is a view showing an example of a display screen size of the portable terminal used in embodiment 3.

FIG. 20 is an entire premises view used in embodiment 3.

FIG. 21 is a flow chart of frame map generation means 2.

FIG. 22 is a view in which the entire premises view used in embodiment 3 is cut into the display screen size of the portable terminal.

FIG. 23 is a view of an illustration image at point U in FIG. 4.

FIG. 24 is a view of an illustration image at point Q in FIG. 4.

FIG. 25 is a view of an illustration image at point R in FIG. 4.

FIG. 26 is a view of an illustration image at point S in FIG. 4.

FIG. 27 is a view of an illustration image at point T in FIG. 4.

FIG. 28 is a flowchart of the route leading means 1.

FIG. 29 is a view showing an example of a route and frame views divided along the route, which are used in embodiment 6.

FIG. 30 is a flowchart of the route leading means 2.

FIG. 31 is an exemplary view of a table in which tags, coordinate data, and tag ID's are correlated and accumulated.

FIG. 32 is an exemplary view of a table in which destinations and coordinate data are correlated and accumulated.

FIG. 33 is a view showing the guidance sentence.

FIG. 34 is a view showing examples of the route guidance sentence.

FIG. 35 is an exemplary view of guidance mark data.

FIG. 36 is an exemplary view of the guidance mark data.

FIG. 37 is an exemplary view of a table in which passage orders of nodes, the binary image data, and the illustration image data are correlated and accumulated.

FIG. 38 is an exemplary view of a table in which the passage orders of nodes and guidance sentence data are correlated and accumulated.

FIG. 39 is an exemplary view of a frame-route elements row correspondence table.

FIG. 40 is an exemplary view of a tag-node/facilities correspondence table.

FIG. 41 is an exemplary view of the frame-route elements row correspondence table.

FIG. 42 is an view showing the guidance sentences.

FIG. 43 is an exemplary view of a table where a terminal ID, a terminal status, an ID of the frame view displayed, an ID of the guidance sentence, an ID of the tag picked up immediately previously, an element row of the routes, a row of the frame view ID's, and a row of the guidance sentence ID's are stored.

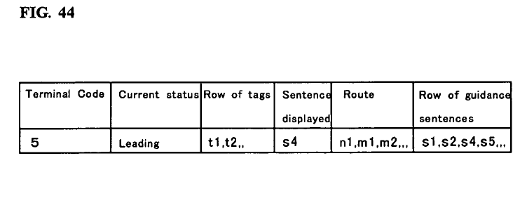

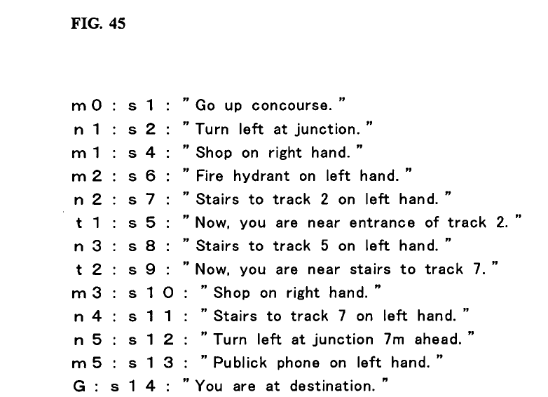

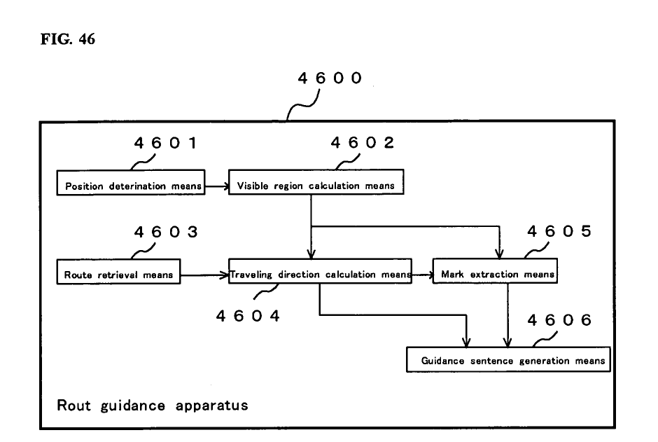

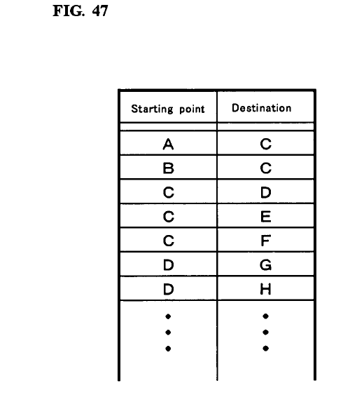

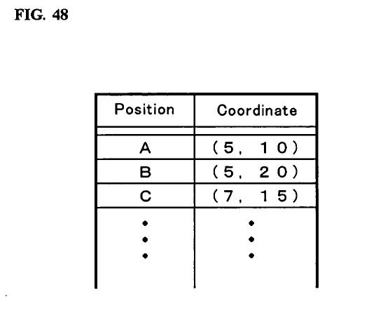

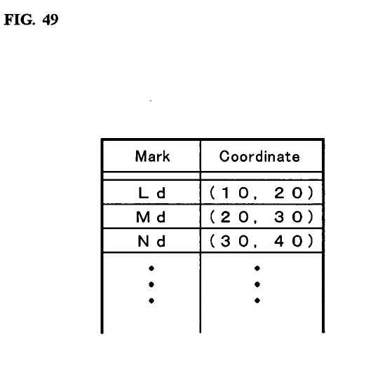

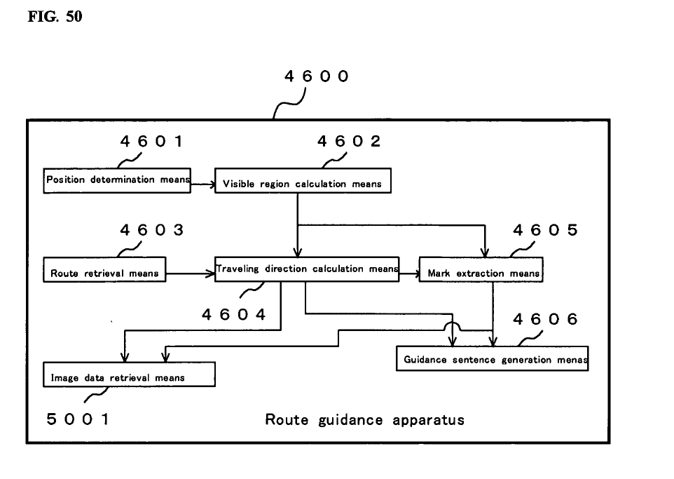

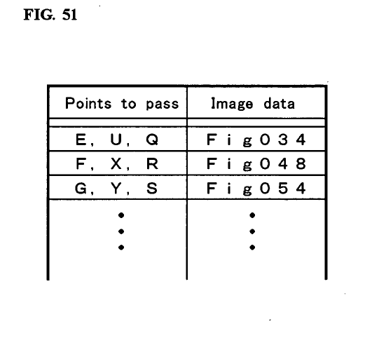

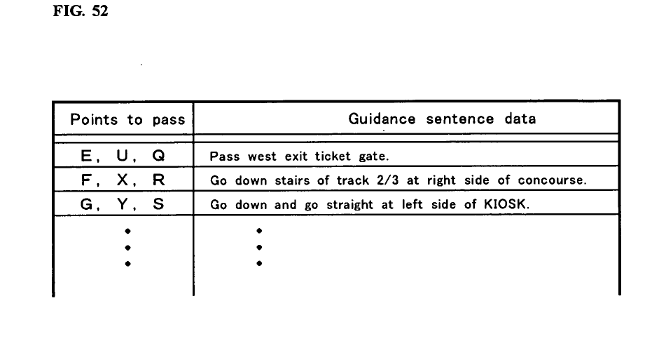

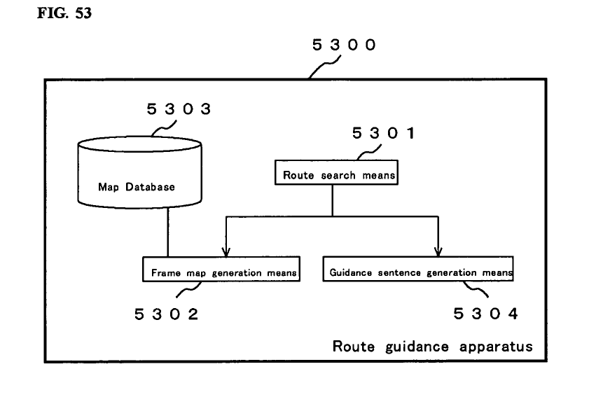

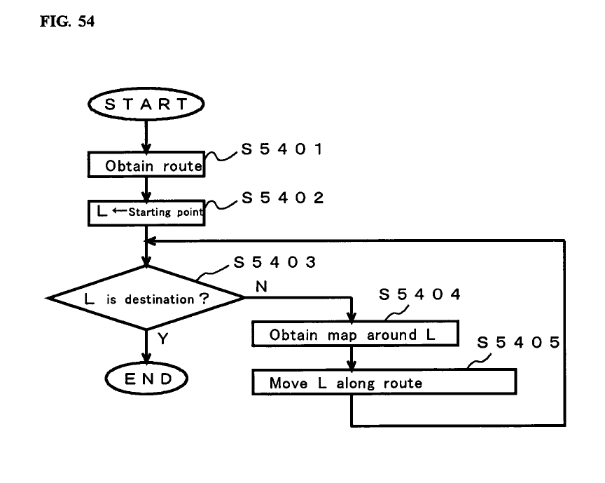

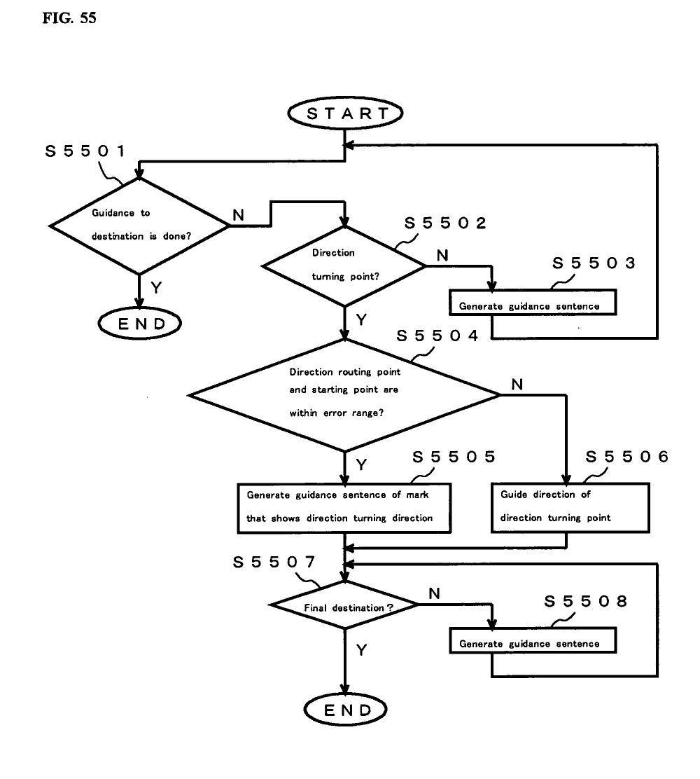

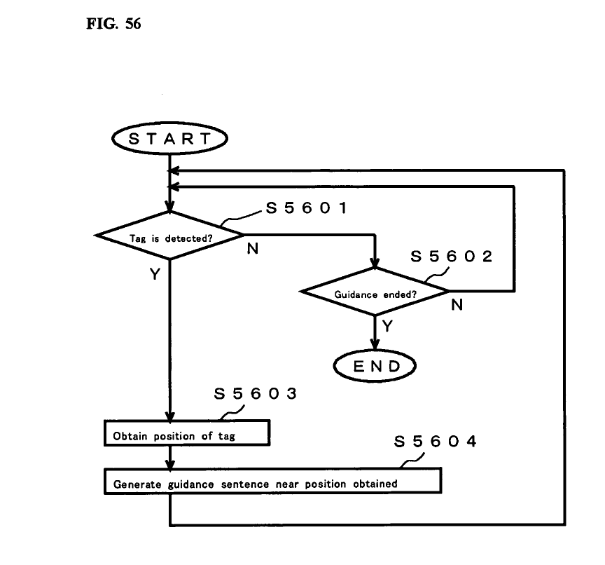

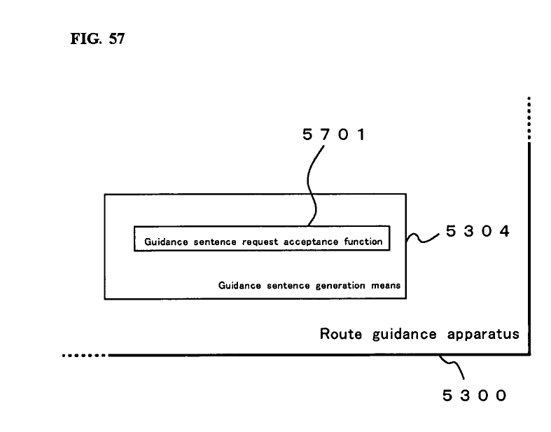

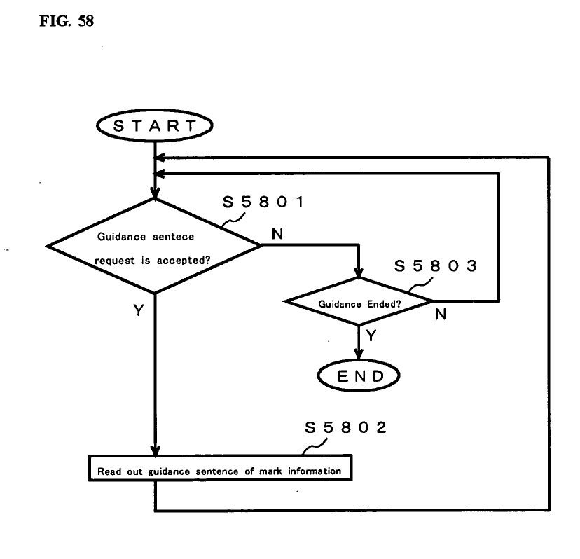

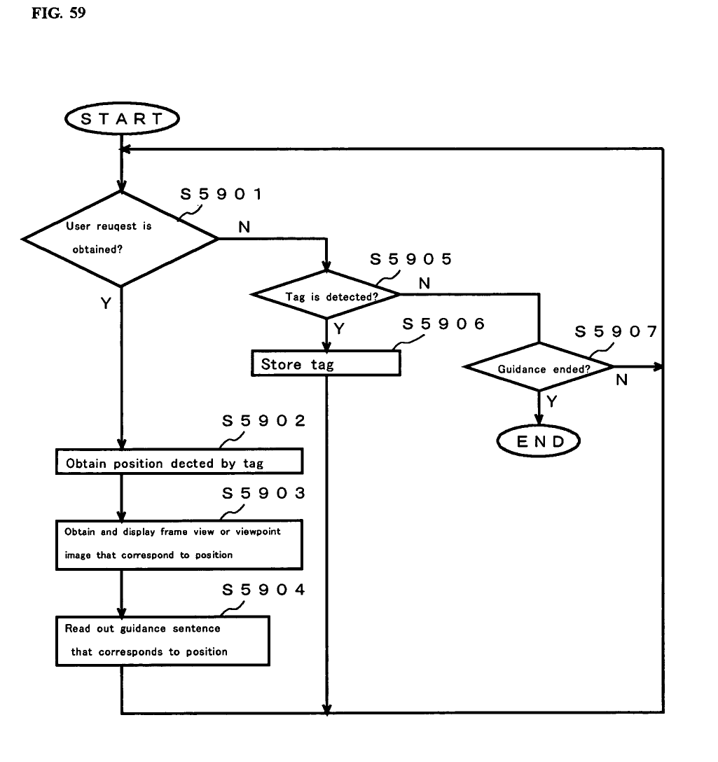

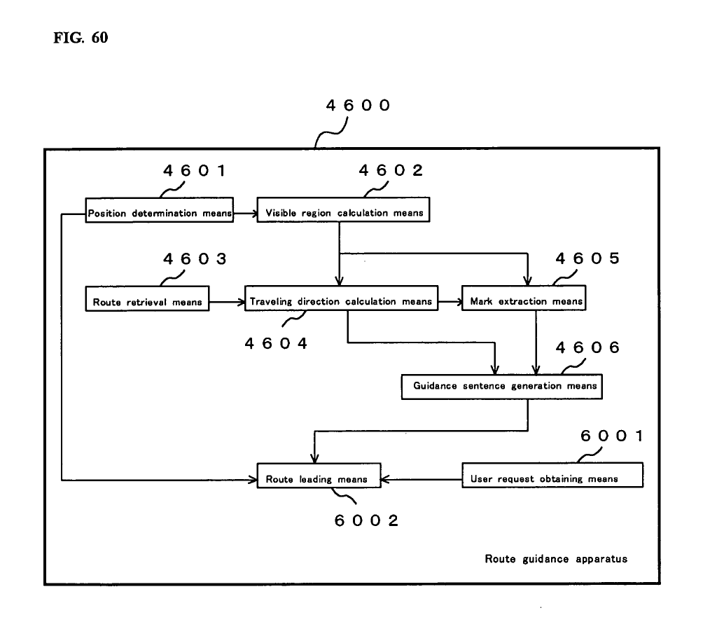

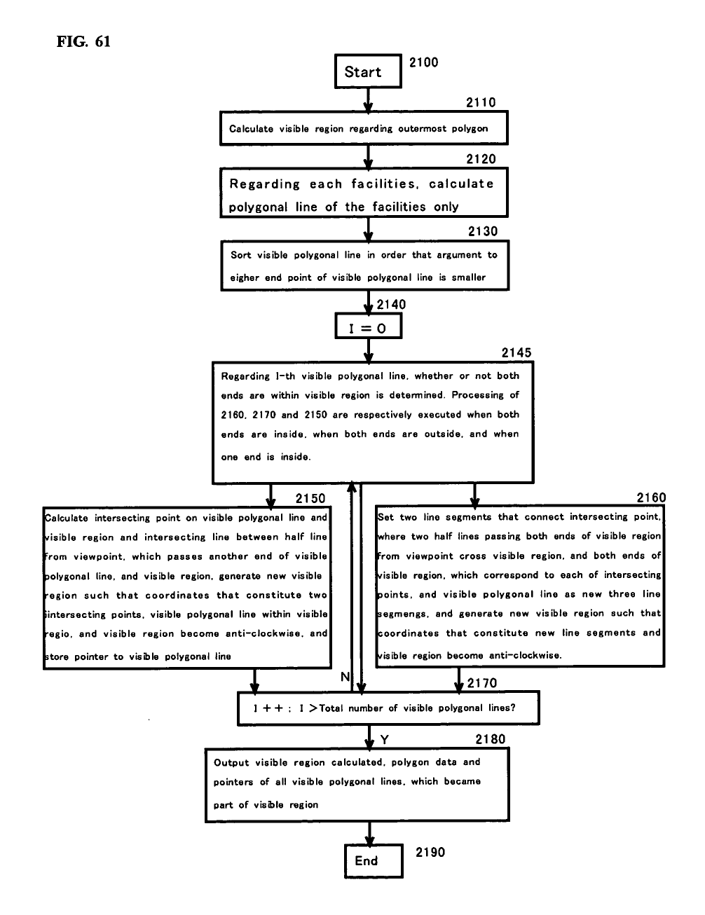

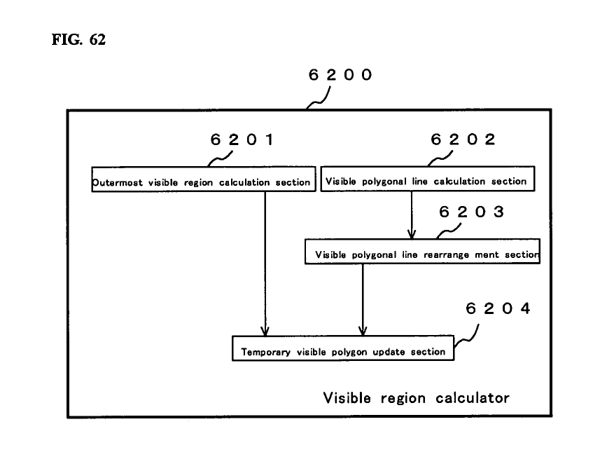

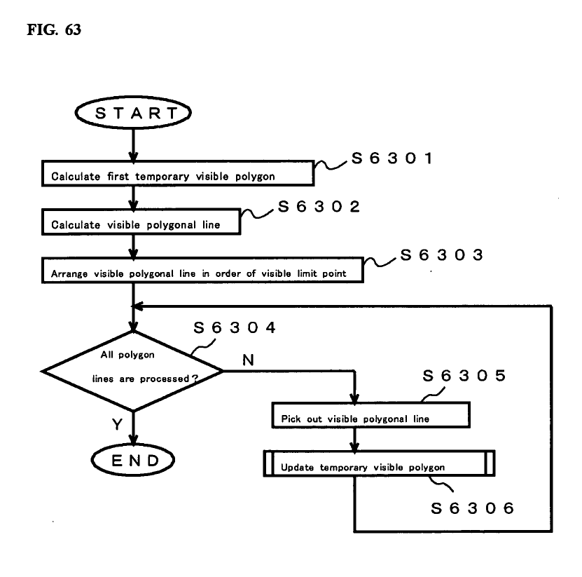

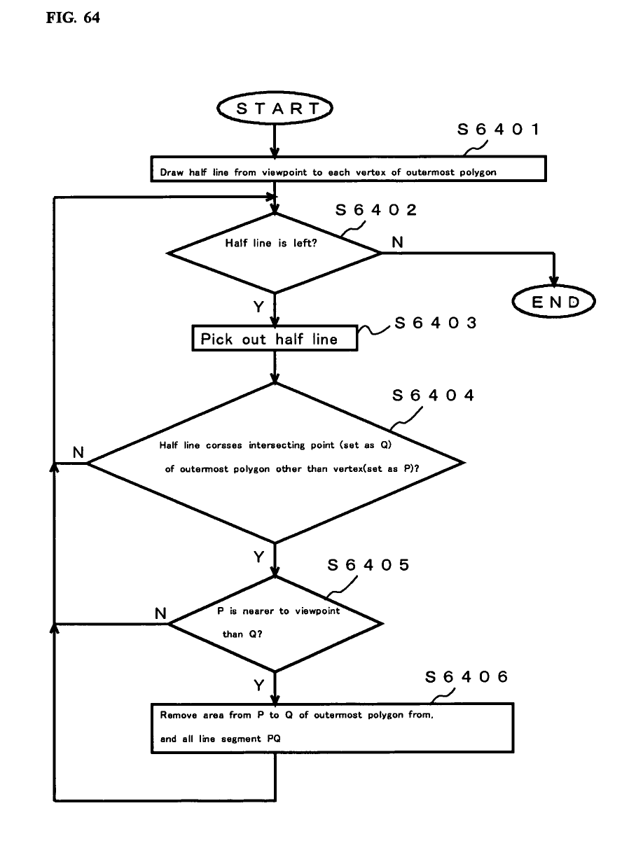

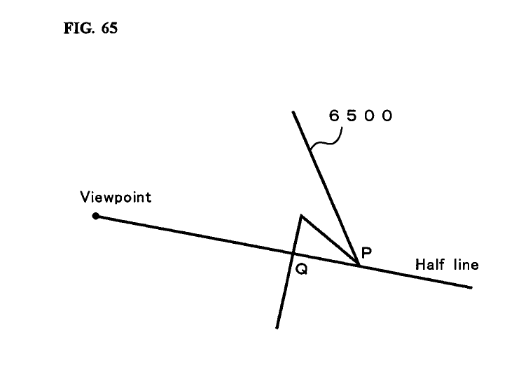

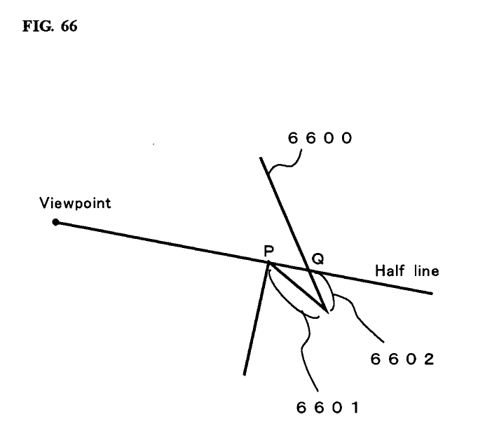

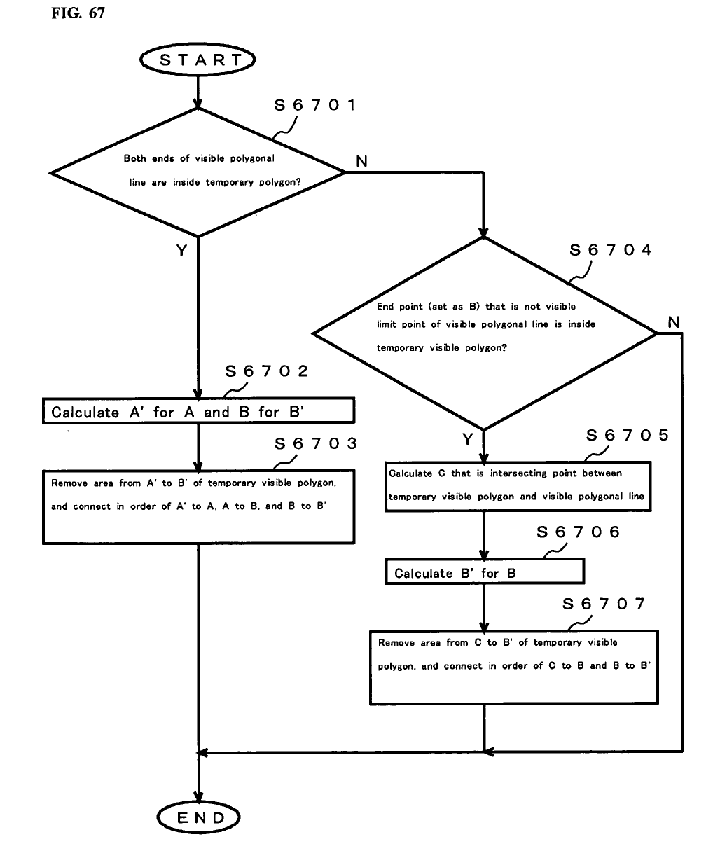

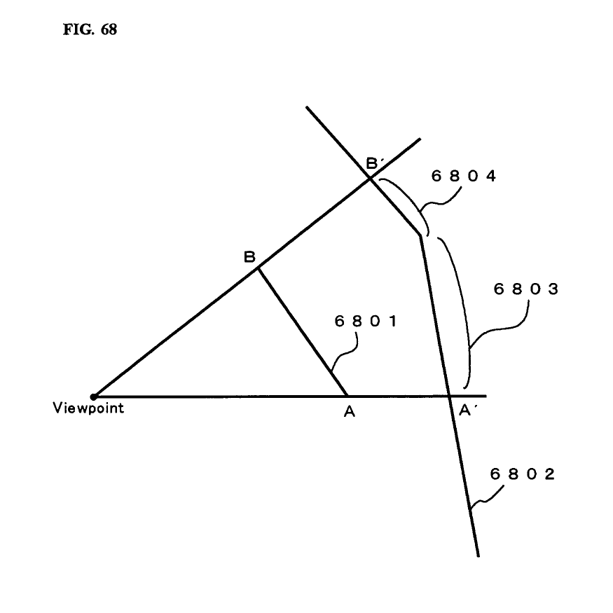

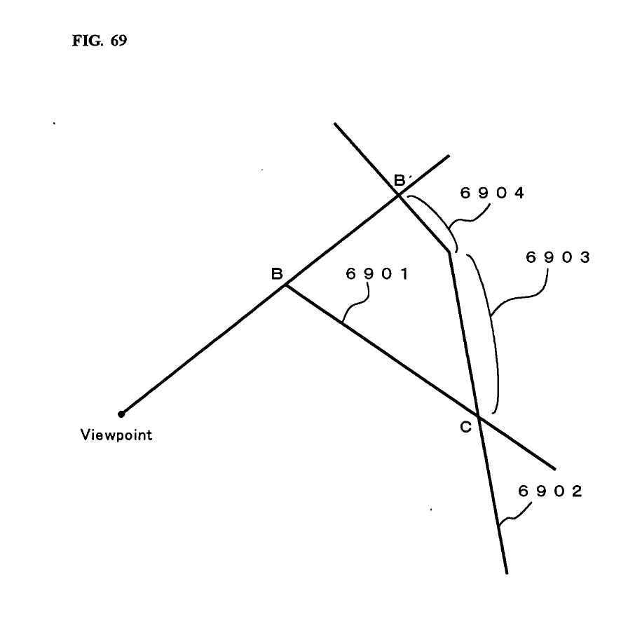

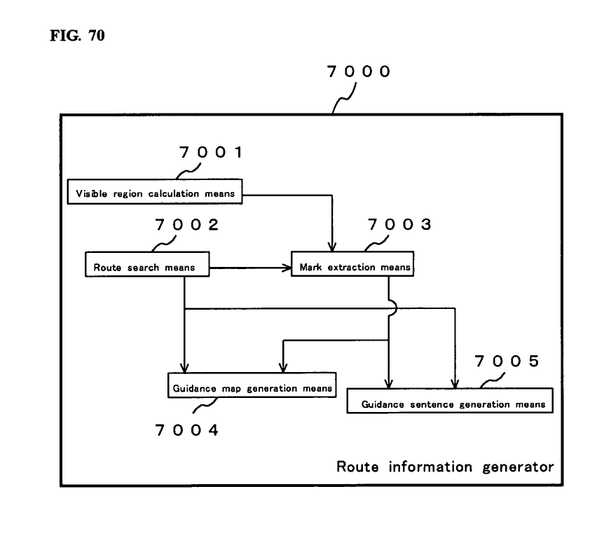

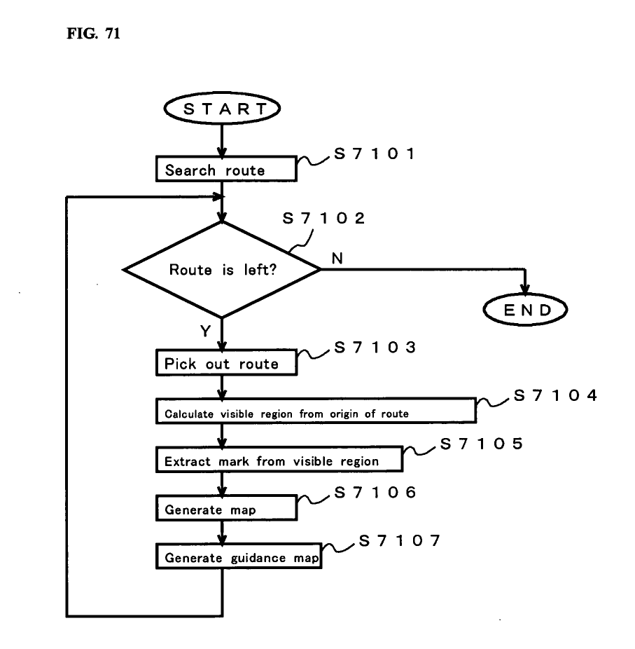

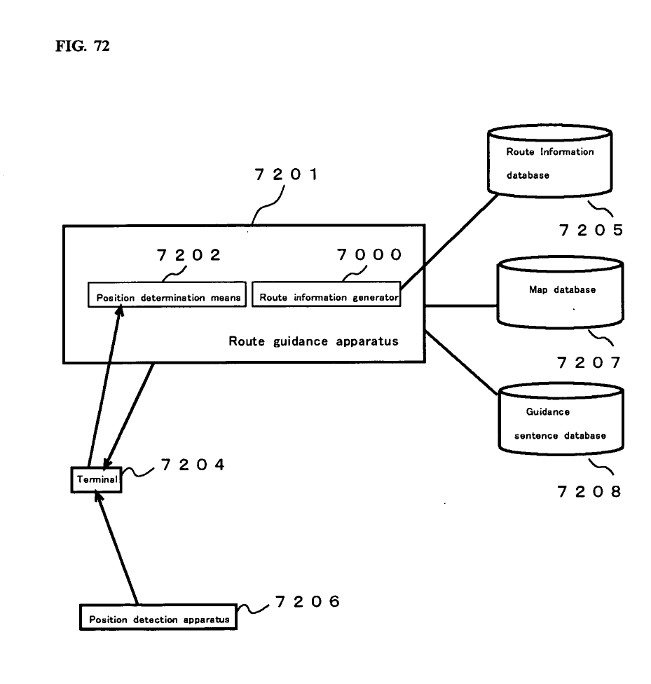

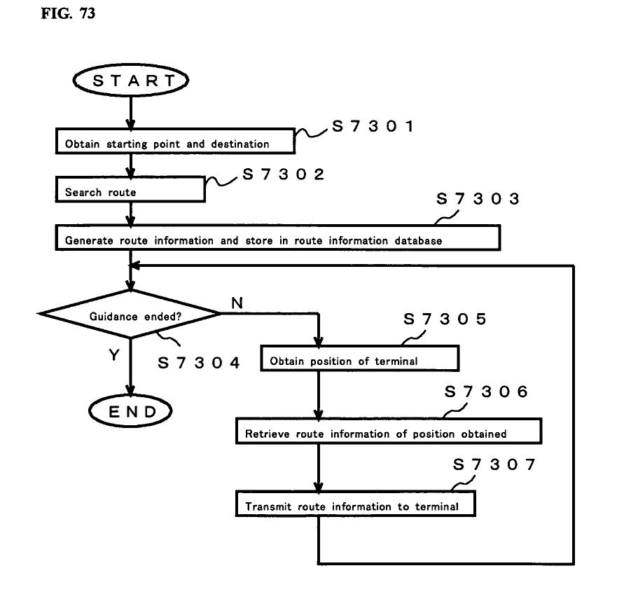

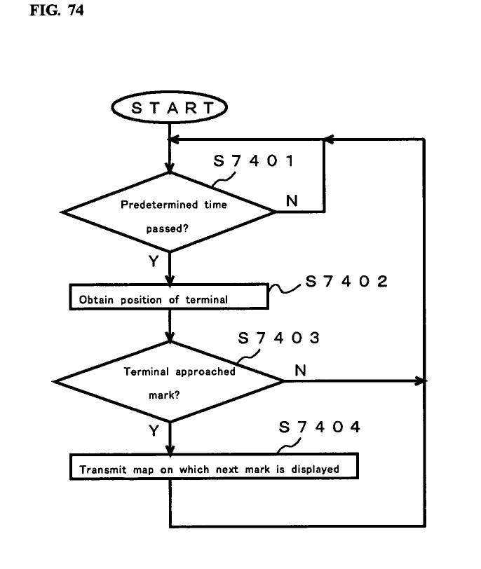

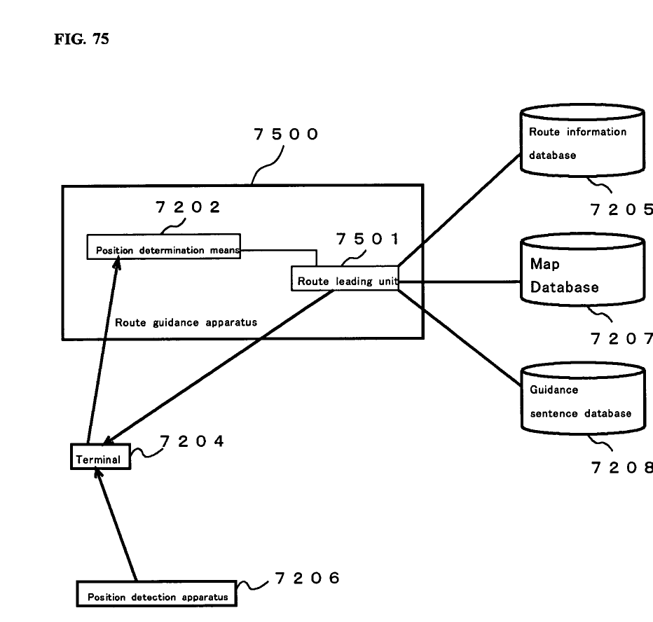

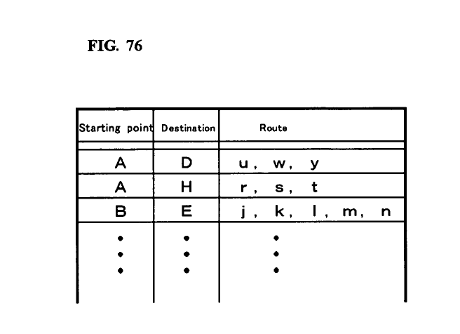

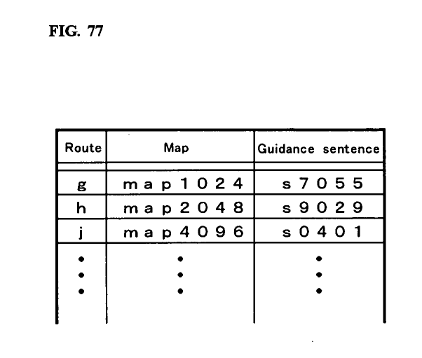

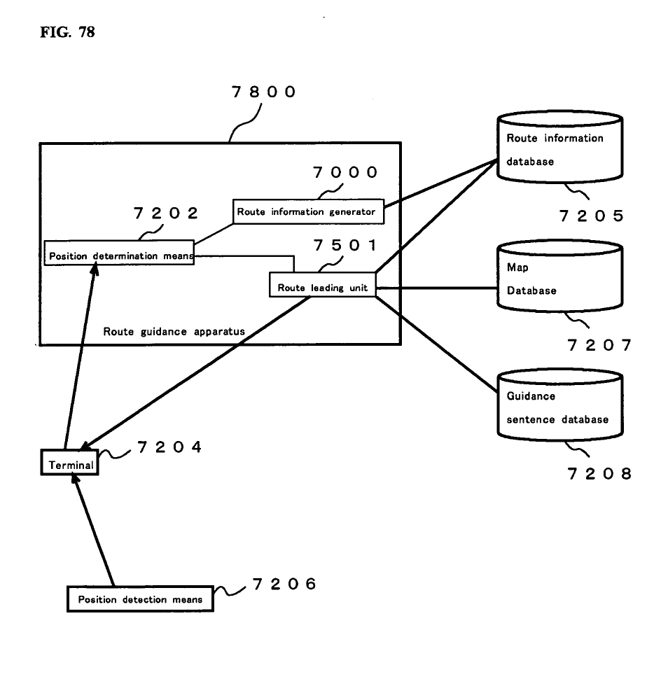

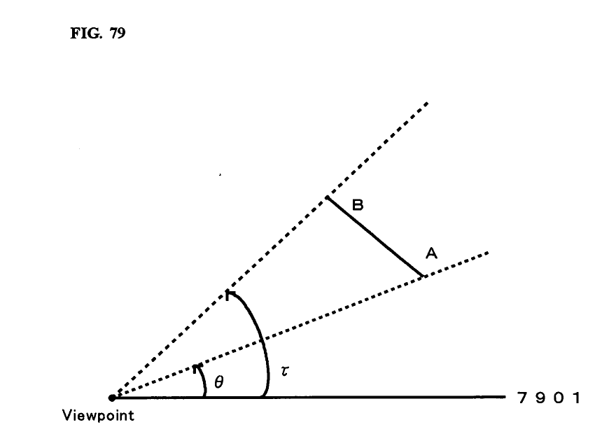

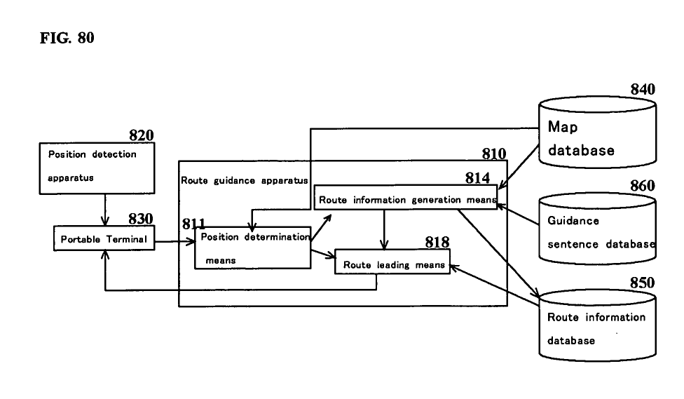

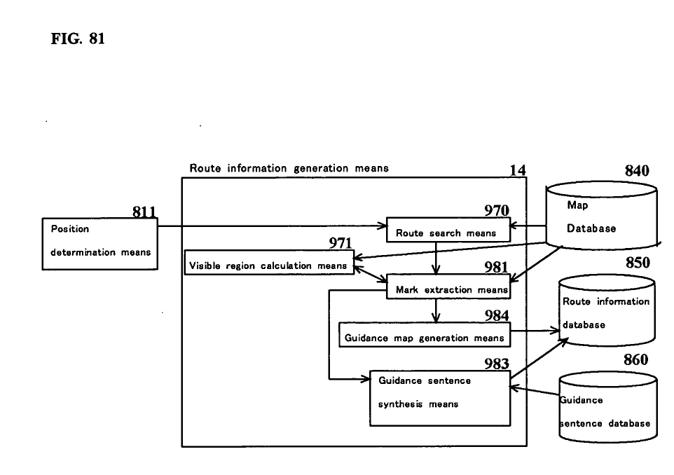

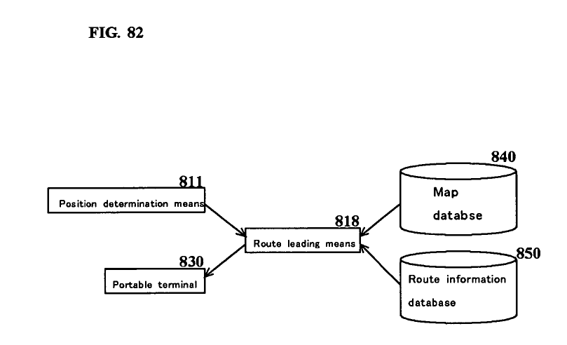

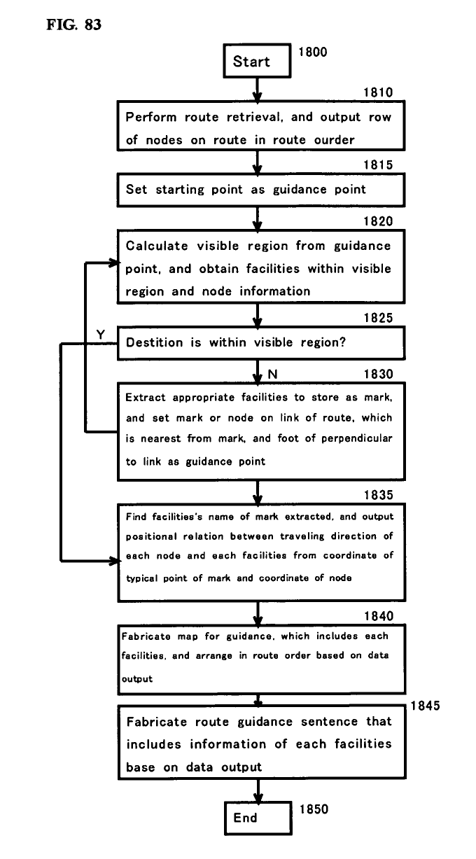

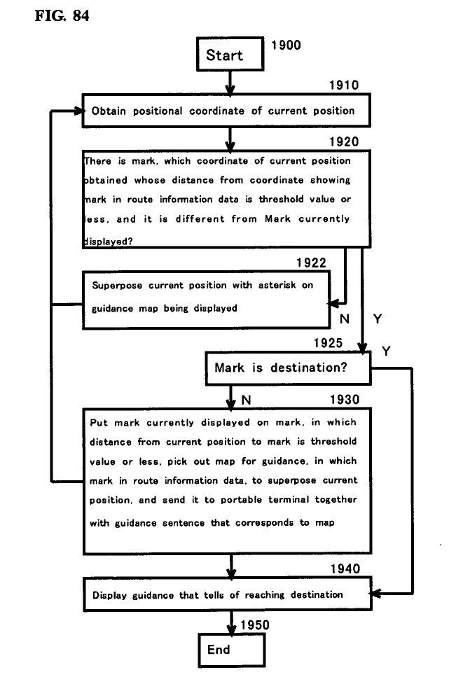

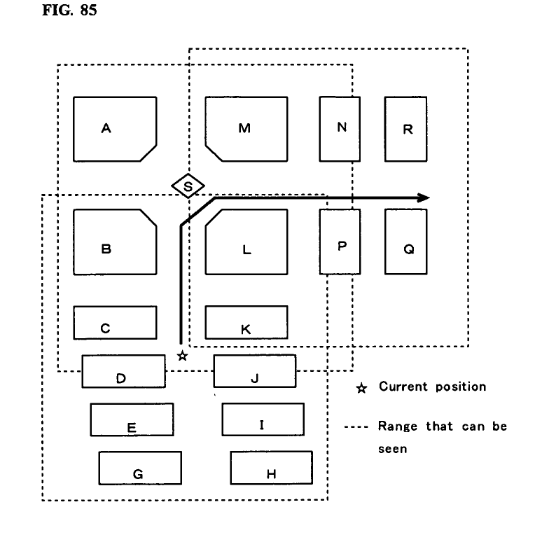

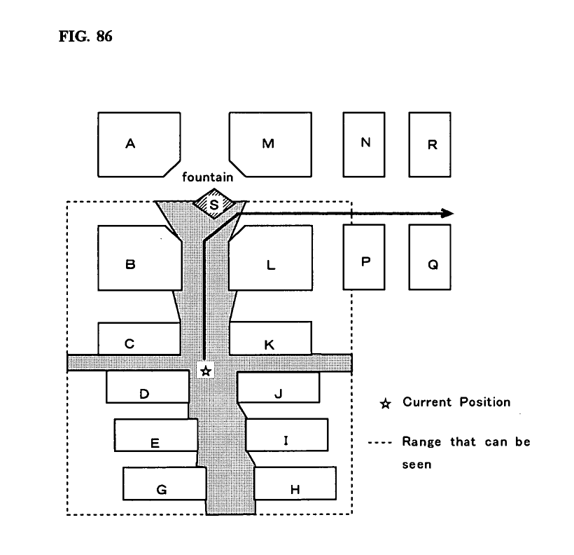

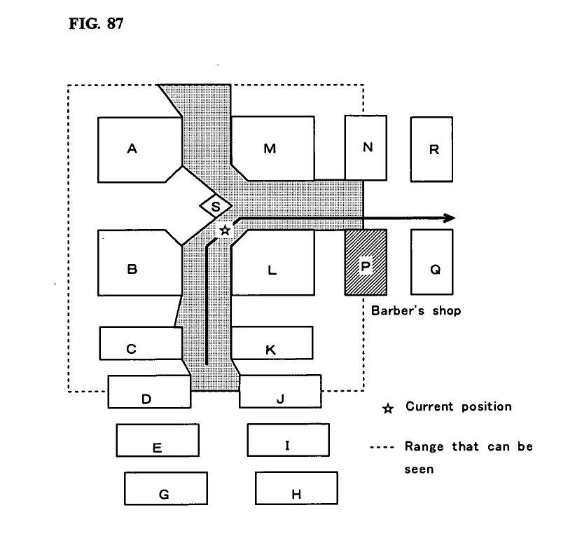

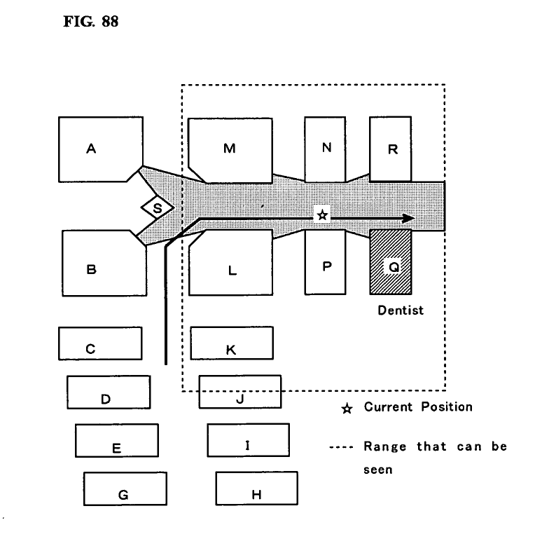

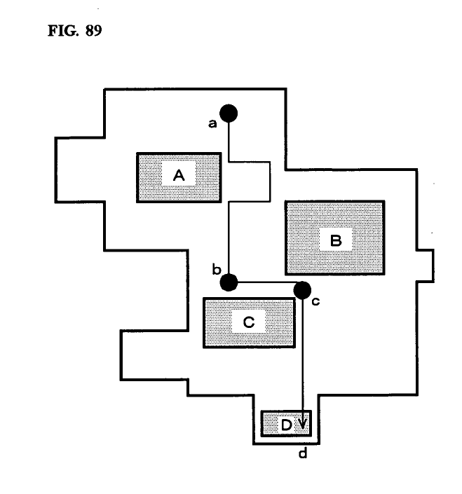

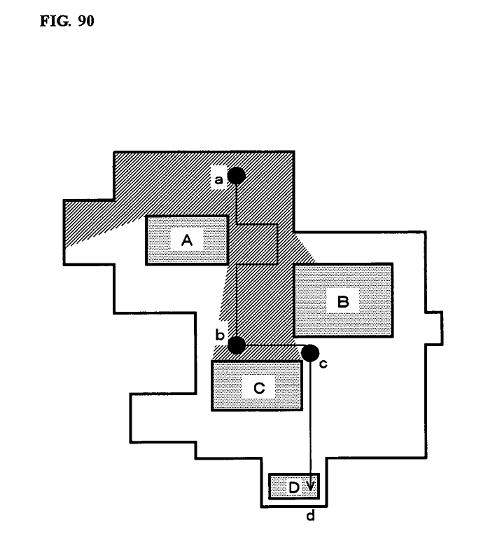

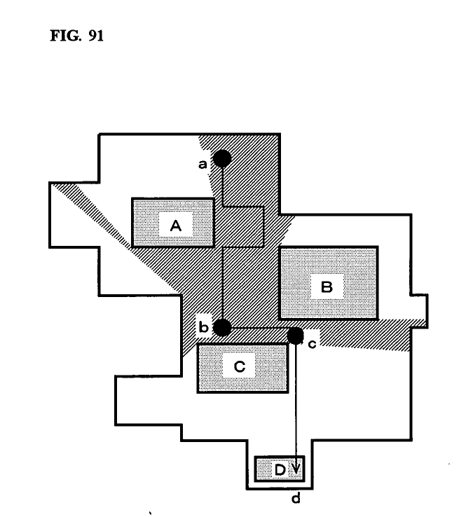

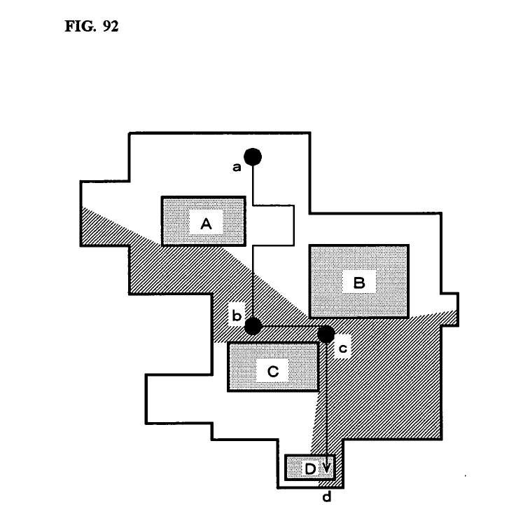

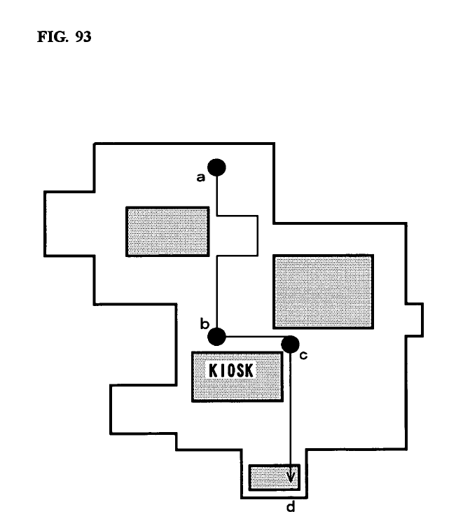

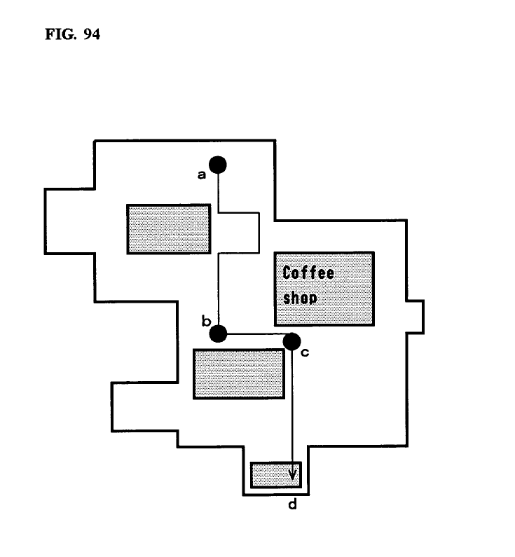

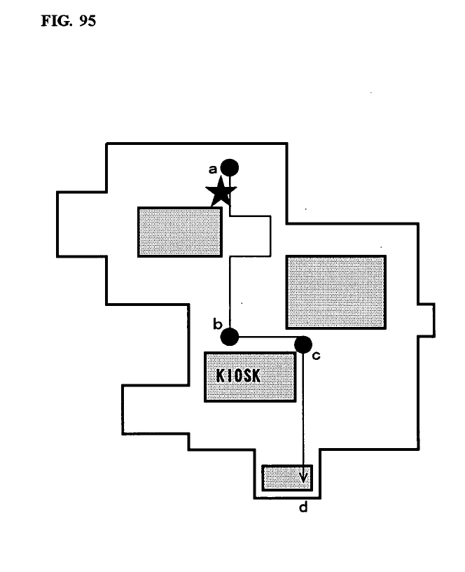

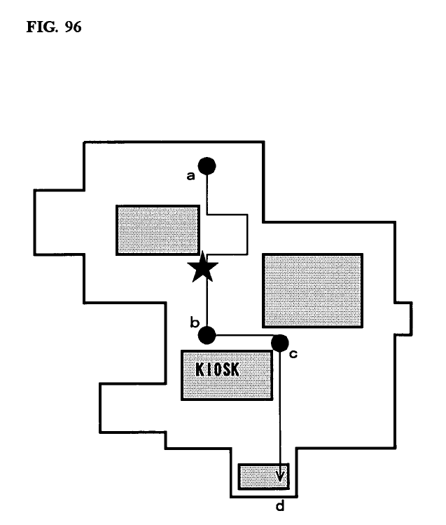

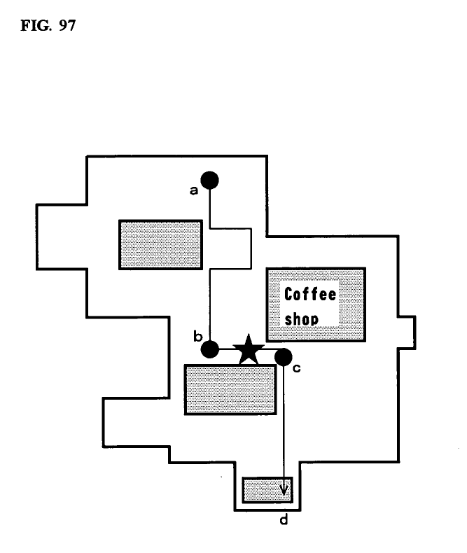

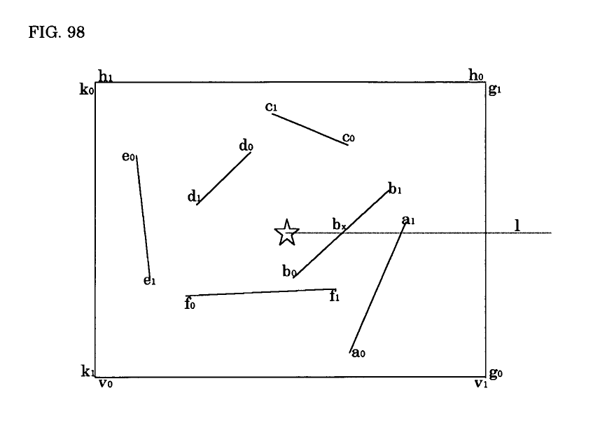

FIG. 44 is an exemplary view of a table where the terminal ID, the terminal status, a tag row, the ID of the guidance sentence, and the row of the guidance sentence ID's are stored.

FIG. 45 is a view showing an example of the guidance sentence data.

FIG. 46 is a function block diagram of the route guidance apparatus in embodiment 7.

FIG. 47 is an exemplary view of a table where starting points and destinations are correlated and accumulated.

FIG. 48 is an exemplary view of a table where posit ions and coordinates thereof are correlated and accumulated.

FIG. 49 is an exemplary view of a table where marks and coordinates thereof are correlated and accumulated.

FIG. 50 is a function block diagram of the route guidance apparatus in embodiment 8.

FIG. 51 is an exemplary view of a table where points to pass and image data are correlated and accumulated.

FIG. 52 is an exemplary view of a table where the points to pass and guidance sentence data are correlated and accumulated.

FIG. 53 is a function block view of the route guidance apparatus in embodiments 9 and 10.

FIG. 54 is a flow chart explaining the processing of the route guidance apparatus in embodiment 9.

FIG. 55 is a flowchart explaining the generation processing of guidance sentence by the guidance sentence generation means in embodiment 13.

FIG. 56 is a flow chart explaining the processing of the route guidance apparatus in embodiment 14.

FIG. 57 is a view showing a part of a function block diagram of the route guidance apparatus in embodiment 15.

FIG. 58 is a flow chart explaining the processing of the route guidance apparatus in embodiment 15.

FIG. 59 is a flow chart explaining the operations of the position determination means, user request obtaining means, and the route leading means.

FIG. 60 is a function block diagram of the route guidance apparatus in embodiment 17.

FIG. 61 is a flowchart explaining the operation of a visible region calculation apparatus in embodiment 18.

FIG. 62 is a function block diagram of the visible region calculator in embodiment 19.

FIG. 63 is a flowchart explaining the operation of a visible region calculator in embodiment 18.

FIG. 64 is a flow chart explaining an operation when the visible region calculator in embodiment 19 calculates a temporary visible region.

FIG. 65 is an exemplary view showing the relation between the temporary visible region and a half line drawn from the viewpoint.

FIG. 66 is an exemplary view showing the relation between the visible region and the half line drawn from the viewpoint.

FIG. 67 is a flowchart explaining the operation of the visible region calculator in embodiment 19.

FIG. 68 is an exemplary view showing the relation between a visible polygonal line and a temporary visible polygon.

FIG. 69 is an exemplary view showing the relation between the visible polygonal line and the temporary visible polygon.

FIG. 70 is a function block diagram of a route information generator in embodiment 20.

FIG. 71 is a flow chart explaining the processing of the route information generator in embodiment 20.

FIG. 72 is a function block diagram of the route guidance system in embodiment 21.

FIG. 73 is a flowchart explaining the operation of the route guidance system in embodiment 21.

FIG. 74 is a flowchart explaining the processing of a route leader in embodiment 22.

FIG. 75 is a function block diagram of the route guidance system in embodiment 23.

FIG. 76 is an exemplary view explaining a state where the starting points and the destinations are correlated and accumulated in the route information database.

FIG. 77 is an exemplary view of a table where the routes, the maps, and the guidance sentences are correlated and accumulated.

FIG. 78 is a function block diagram of the route guidance system in embodiment 24.

FIG. 79 is a view explaining the argument at the end point of the line segment.

FIG. 80 is a block diagram showing a configuration example of the route guidance system in embodiment 25.

FIG. 81 is a block configuration view of the route information generation means in embodiment 25.

FIG. 82 is a block configuration view of the route leading means in embodiment 25.

FIG. 83 is a flow chart explaining the processing of the route information generation means in embodiment 25.

FIG. 84 is a flow chart explaining the processing of the route leading means in embodiment 26.

FIG. 85 is an exemplary view of the map that shows the current position of the user and the route to go.

FIG. 86 is an exemplary view of the map that shows the visible region of the user at the starting point.

FIG. 87 is an exemplary view of the map that shows the visible region when the user has moved to reach a corner.

FIG. 88 is an exemplary view of the map that shows the visible region after the user has moved.

FIG. 89 is an example of the premises view used in embodiment 25.

FIG. 90 is a view of the visible region calculated at point a, which is used in embodiment 25.

FIG. 91 is a view of the visible region calculated at point b, which is used in embodiment 25.

FIG. 92 is a view of the visible region calculated at point c, which is used in embodiment 25.

FIG. 93 is a map for guidance, which is used in embodiment 25 and embodiment 26 and generated in embodiment 25.

FIG. 94 is a map for guidance, which is used in embodiment 25 and embodiment 26 and generated in embodiment 25.

FIG. 95 is a map for leading, which is displayed on the terminal used in embodiment 26.

FIG. 96 is a map for leading, which is displayed on the terminal used in embodiment 26.

FIG. 97 is a map for leading, which is displayed on the terminal used in embodiment 26.

FIG. 98 is an exemplary view of the viewpoint and the line segment to explain an example of the conventional plane scanning method.

### PREFERRED EMBODIMENT OF THE INVENTION

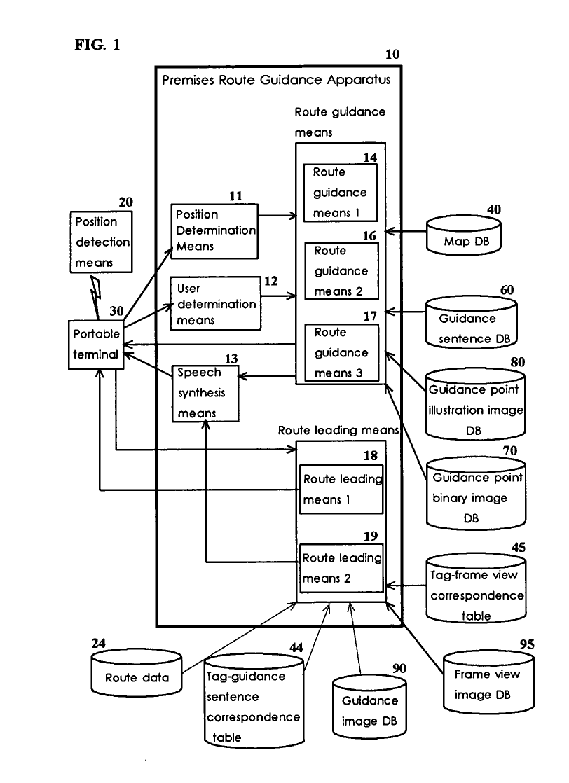

FIG. 1 is the block diagram showing the configuration example of the premises route guidance system according to the present invention, which is comprised of: a position detection apparatus 20 that informs the user's position; a portable terminal apparatus 30 that transmits position detection information from the position detection apparatus 20 and user information to a premises route guidance apparatus 10 to display a photographed image of the route or the mark; the map database (hereinafter, referred to as DB40) in which data of the map is accumulated; a guidance sentence DB60 where the guidance sentences, in which route guidance is performed using the direction of railway in a train station as a reference, of the route is accumulated; an must ration image DB80 where the illustration photographed images regarding guidance points are accumulated; a binary image DB70 where binary images regarding the guidance points are accumulated; route data 24 where the route search results are stored; a correspondence table 44 between tags and each guidance sentence; a frame view image 95; a guidance image DB90; a correspondence table 44 between the tags and each guidance sentence; and the premises route guidance apparatus 10 that processes the position detection (tag) information and photographed image information to guide route.

Among them, the position detection apparatus 20 transmits positional coordinate to the user. The portable terminal shown in FIG. 3 is equipped with user infer nation 33, position detection (tag) reading means 31, route data reading-out means 32, image data display means 34, and illustration image data extraction means 35, and it displays or reads out the image or text data processed by the route guidance apparatus on the portable terminal.

The premises route guidance apparatus 10 comprises: position determination means 11 that determines where the user is in the premises by the positional information; user determination means 12 that receives the characteristics of the user such as a vision-impaired person, a hearing-impaired person, and an able-bodied person to determine a para meter for route search, or decides output means such that it outputs the binary image or the illustration image when a terminal type used is a monochrome terminal and outputs a color image when it is a color terminal; speech synthesis means 13 that pronounces the route guidance sentence output; route guidance means 1(14); route guidance means 2(16); route guidance means 3(17); and route leading means 1(18) and route leading means 2(19), which leads the route.

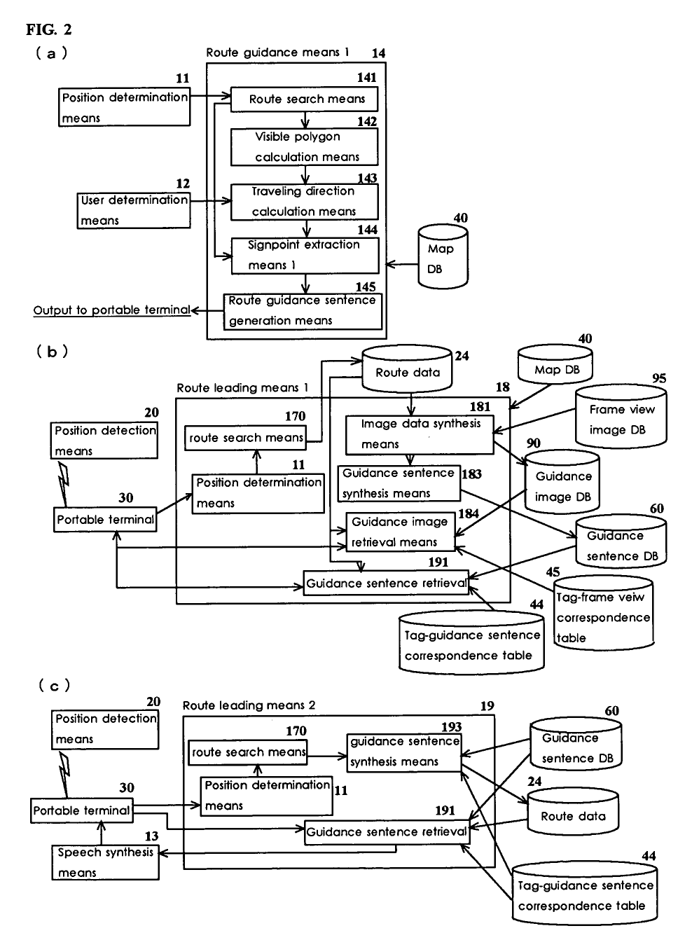

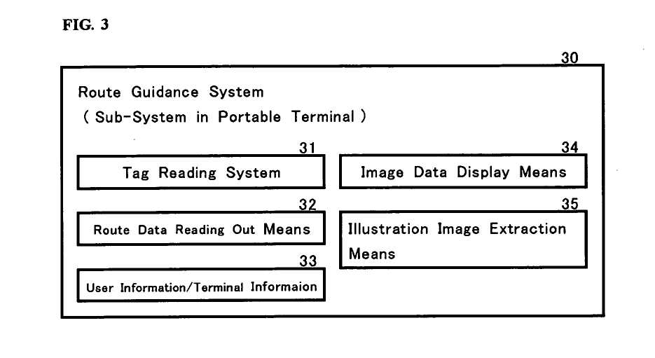

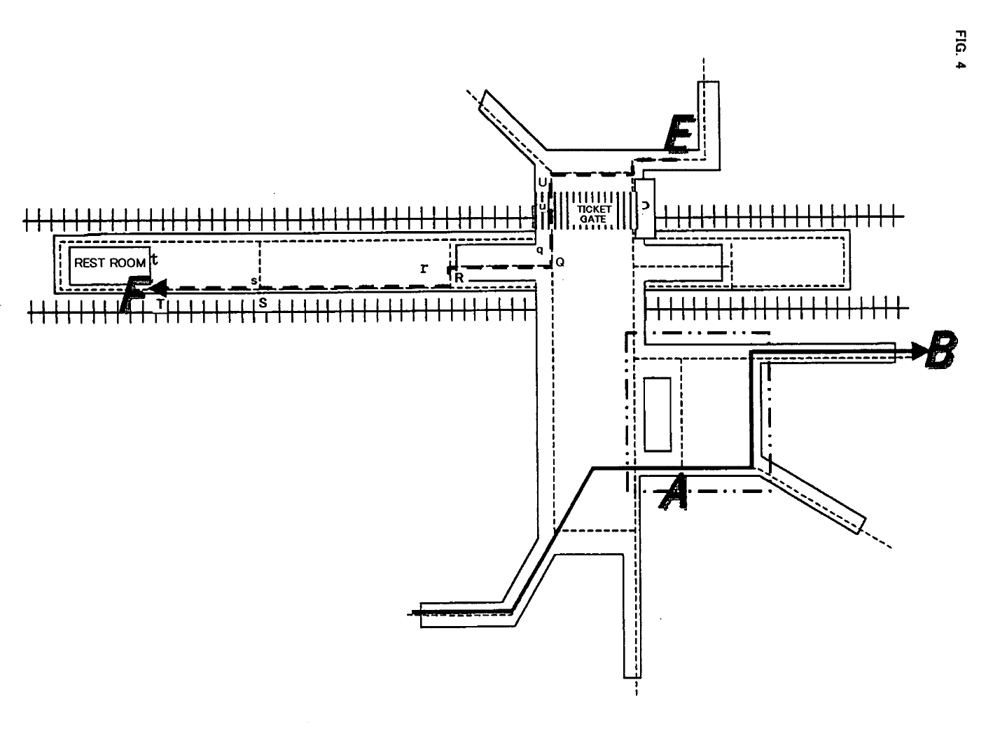

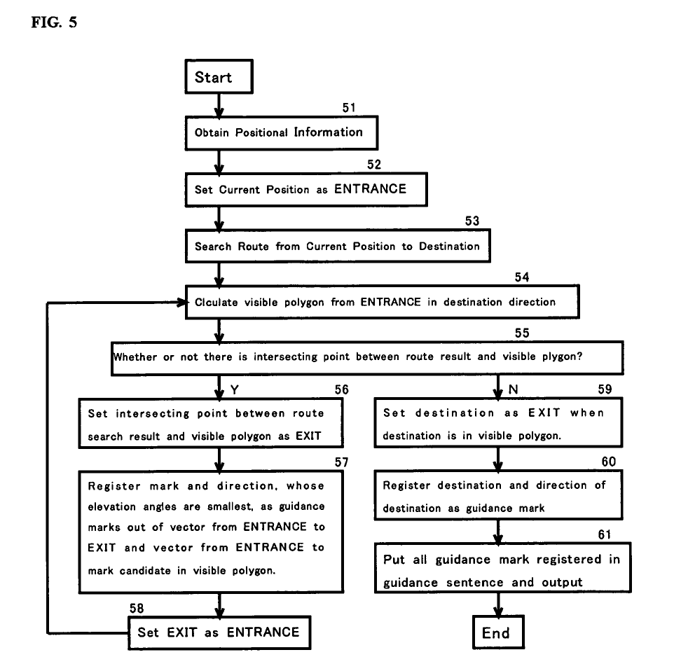

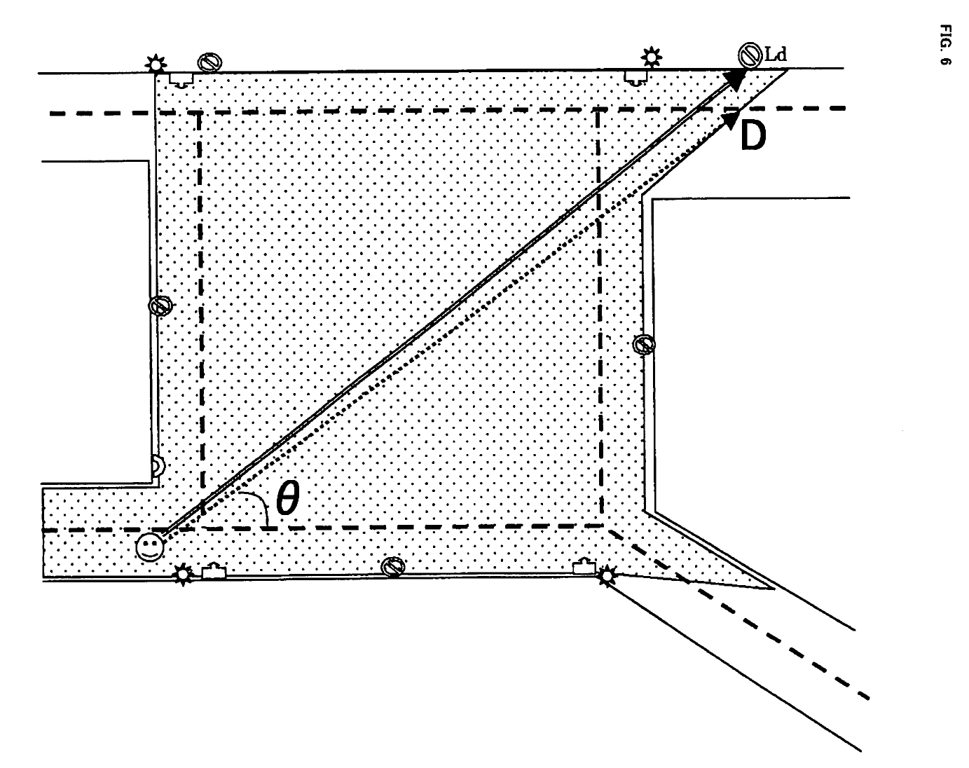

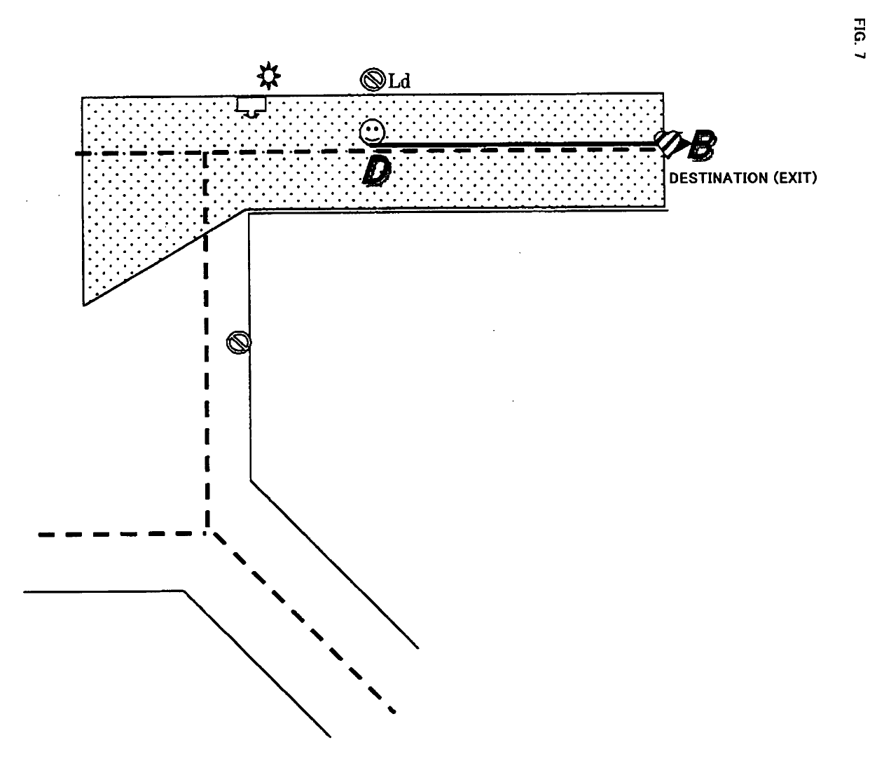

FIG. 2(a) is the block configuration view regarding the route guidance means 1 in the route guidance apparatus, which is comprised of: visible polygon calculation means 142 as an example of visible region calculation means that calculates a range that can be seen from a current position; route search means 141 that searches the route to the destination; traveling direction calculation means 143 that calculates which direction the traveling direction of the route is from the current position; signpost extract ion means 144 that extracts a mark showing the traveling direction; and route guidance sentence generation means 145 that generates the route guidance sentence.

FIG. 2(b) is the block configuration diagram regarding the route leading means 1(18) in the route guidance apparatus, which is comprised of: the position detection apparatus (20) that detects tag information; the portable terminal apparatus (30) that receives the positional information to provide the route information to the user; the position determination means 11 that determines the current position from the tag; route search means (170) that performs route search; the route data 24 that stores the route search results; image data synthesis means 181 that synthesizes the image data of frame view used in the route guidance; guidance sentence synthesis means 183 that synthesizes the guidance sentence that corresponds to each frame view; guidance image retrieval means 184 that retrieves a guidance image provided to the user every time the tag is detected; guidance sentence retrieval means 191 that retrieves the guidance sentence provided to the user every time the tag is detected; the map DB40; a frame view image DB95 that stores images of frame views, which are a source for synthesizing the guidance images; the guidance image DB90 that stores the guidance images synthesized; the guidance sentence DB60 that stores the guidance sentences and guidance sentence generation rules that generate the guidance sentence; the tag-frame view correspondence table 45; and the tag-guidance sentence correspondence table 44.

FIG. 2(c) is the block configuration diagram regarding the route leading means 2(19), which is comprised of: the position detection apparatus (20) that detects the tag information; the portable terminal apparatus (30) that receives the positional information to provide the route information to the user; the position determination means 11 that determines the position of the tag; the route search means (170) that performs route search; the guidance sentence retrieval means 191 that retrieves the guidance sentence that corresponds to the tag; guidance sentence synthesis means 193 that synthesizes the route guidance sentence near the tag; the guidance sentence DB60 that stores the guidance sentences and the guidance sentence generation rules that generate the guidance sentence; the route data 24 that stores the route search results; and the tag-guidance sentence correspondence table 44.

FIG. 7 is the block configuration view regarding the route leading means 1(18), which is comprised of: the portable terminal apparatus (30) that detects the tag information; the position determination means 11 that determines the position from the tag; image data retrieval means 181 that retrieves data of frame view that corresponds to the current position; and the guidance sentence synthesis means 183 that synthesizes the guidance sentence that corresponds to each frame view.

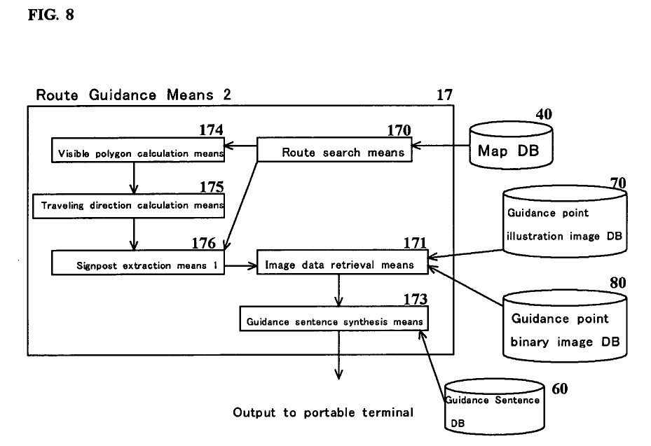

FIG. 8 is the block configuration view regarding the route leading means 2(19), which is comprised of: the portable terminal apparatus (30) that detects the tag information; the position determination means 11 that determines the position of the tag; the guidance sentence retrieval means 191 that retrieves the guidance sentence that corresponds to the tag; and the guidance sentence synthesis means 193 that synthesizes the route guidance sentence near the tag.

### Embodiment 1

The route guidance means 1 will be described based on an example. Herein, consideration will be given to the case of passing in the premises from A to B as shown by the solid line arrow. The route data is drawn in the premises in dotted lines on the map DB40. The user loses his/her way at point A, and rang a system using the portable terminal 30 first. The user enters a destination B through the user interface of the portable terminal 30. A portable terminal Pa reads an ID in Ta from the posit ion detection Ta, and transmits data: a tag ID; the terminal being a PDA type terminal; and the destination being B to the route guidance apparatus 10.

The processing will be described along the flowchart of the route guidance means 1 shown in FIG. 5.

In the route guidance means 1, the position determination means 11 outputs a user's position A(15,23) in the premises (step 51), the route search means 141 set the current position A as a variable (Entrance) (step 52), and performs route search from the current position A and the destination B to output the route where the user should proceed (step 53). The visible polygon calculation means 142 calculates the region in the premises that can be seen from A, which is shown in a dot-meshed region in FIG. 6, using the information of the current point A (step 54). In the traveling direction calculation means 143, the visible polygon and the route are superposed to calculate the intersecting point between them and obtains an intersecting point D of the destination (step 55), and D is bound to a variable (Exit) when there is an intersecting point (step 56). A vector AD shown by a broken line arrow in FIG. 6 is set as a direction where the user should proceed. In the signpost calculation means 144, a vector having the smallest angle is extracted from the traveling direction vector of the user and a vector connecting the tag and a target (double-line arrow in FIG. 6) in the visible polygon as the signpost and sets an Ld in FIG. 6 as a guidance mark, and an angle θ made, by an immediately preceding traveling direction and the double-line arrow vector is compartmentalized in a 45-degree step to register a corresponding sentence ‘Left ahead’ (step 57). An entity of the variable (Exit) is set as an entity of a new Entrance (step 58), and the processing returns to step 54. When the user arrives D in FIG. 7, the visible polygon is as shown in dot-mesh in FIG. 7, and the destination B is set as Exit since the mark B is at the place of destination (step 59). The destination B and the direction of the destination that is ‘Ahead’ are registered as the guidance marks (step 60). In the route guidance sentence generation means 145, arriving all guidance marks registered, the direction and the guidance mark in the guidance mark data shown in FIG. 35 and FIG. 36 are respectively applied to X and Y of a template, which is ‘Y of X is the destination.’ in the case of destination and ‘Walk toward Y of X.’ otherwise, and the guidance sentence shown in FIG. 33 is generated (step 61). In the case of this example, the route guidance sentences that depend on the route network are shown in FIG. 34.

The foregoing embodiment 1 calculates the region where the user can look over by the user's positional information in the open space in the premises, and the route guidance that guides the signpost regardless of how the route data is formed on a database is enabled.

### Embodiment 2

FIG. 8 is the block diagram showing the configuration example of the route guidance means 2 in the present invention, and it comprises: the map DB40 where the route data for searching the route in the premises; the route search means 170 that searches the route in the premises; the guidance point illustration image DB70 where the illustration images of the guidance points are accumulated; the guidance point binary image DB80 where the binary images of the guidance points are accumulated; image data retrieval means 171 that retrieves the image of the guidance point based on a route search result; the guidance sentence DB60 where the guidance sentences are accumulated; guidance sentence generation means 173 that generates the guidance sentence from the guidance sentence DB based on the route search result; visible polygon calculation means 174 as an example of the visible region calculation means that calculates a range that can be seen from the current position; traveling direction calculation means 175 that calculates which direction the traveling direction of the route is from the current position; and signpost extraction means 176 that extracts a nark showing the traveling direction.

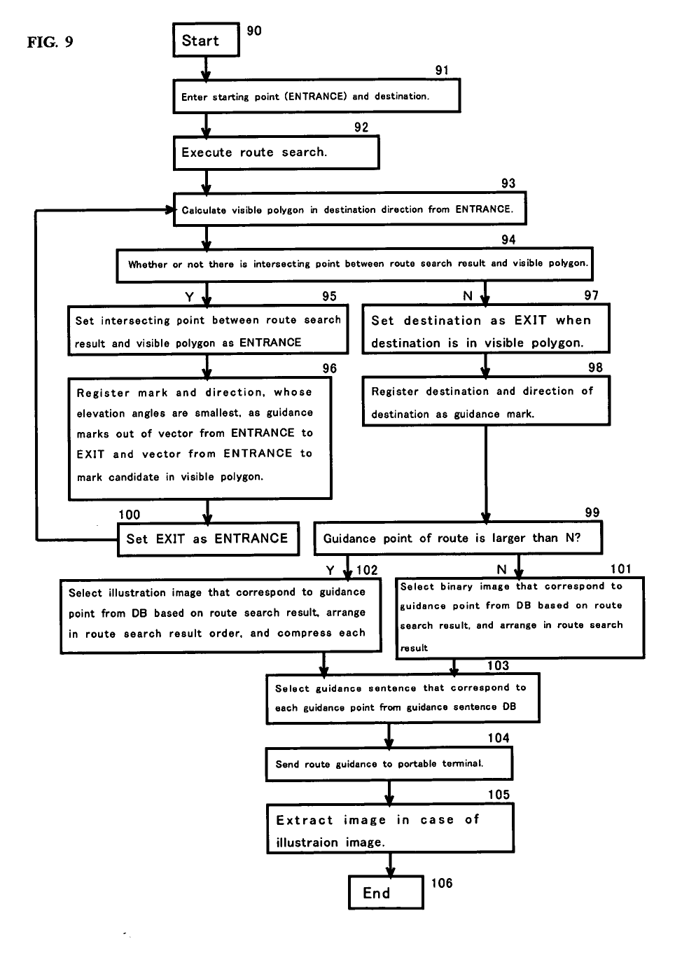

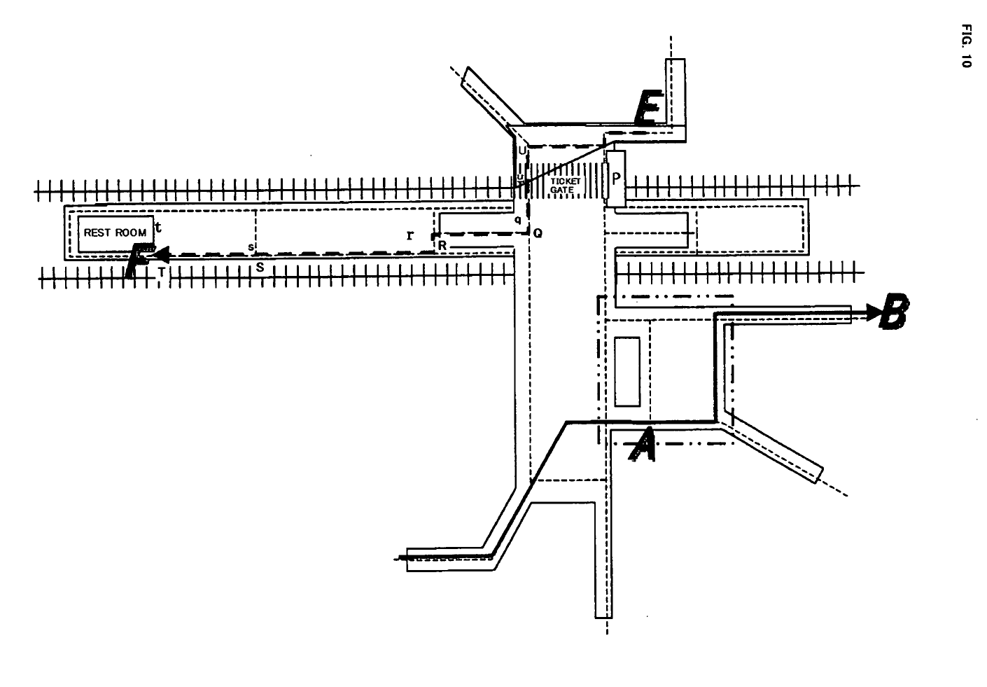

The processing of the embodiment of the route guidance means 2 will be described along the flowchart of the route guidance means 2 shown in FIG. 9. Herein, consideration will be given to the case of passing in the premises from E to F as shown by the broken line arrow. In the route guidance means 2, when the route search means 170 is activated (step 90), the starting point E, the destination F and the parameter of an output image are entered (step 91). The route search is executed to output a node row of E, U, Q, R, S, T and F is output as the route search result (step 92). Similarly to the processing (step 53 to step 60) of the flowchart of the route guidance means 1 in embodiment 1, the visible polygon is calculated in the route order to find guidance points of u, q, r, s and t.

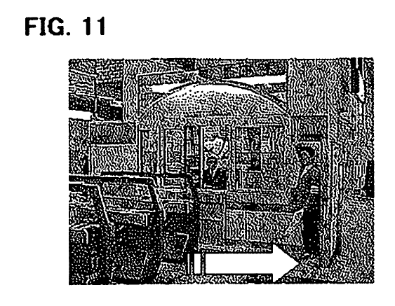

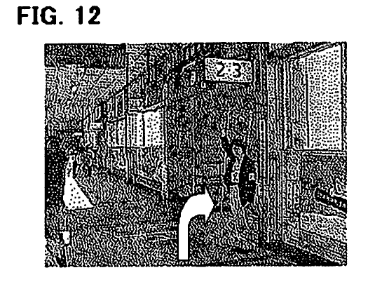

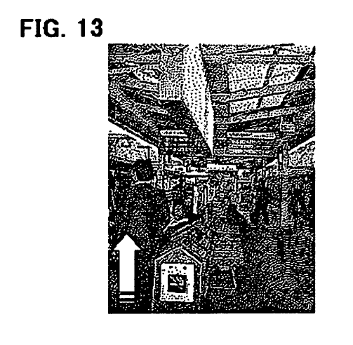

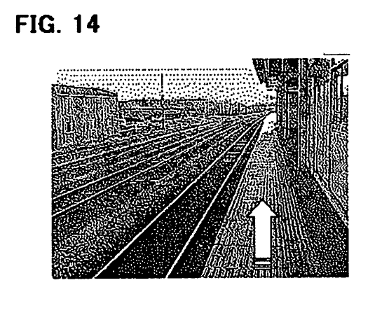

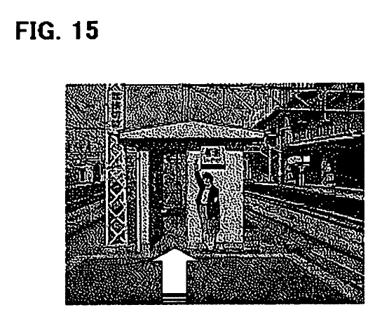

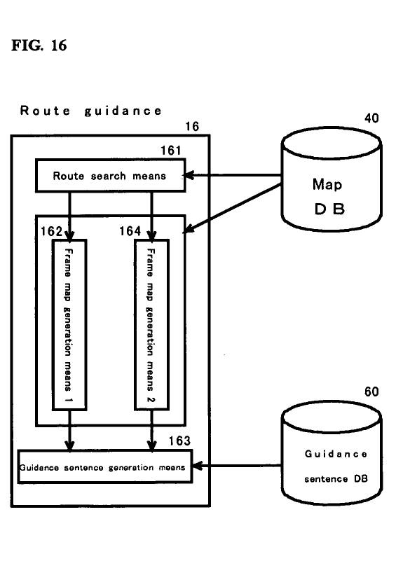

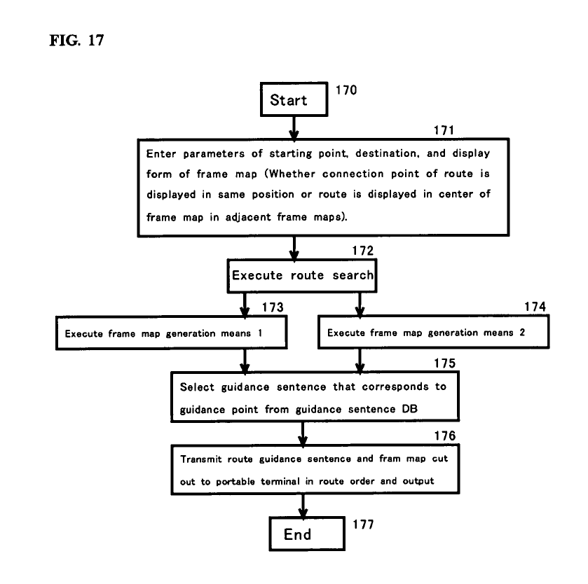

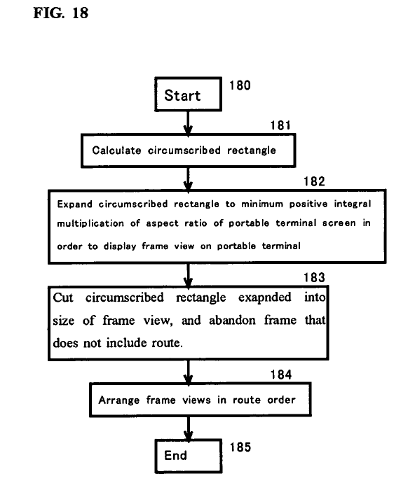

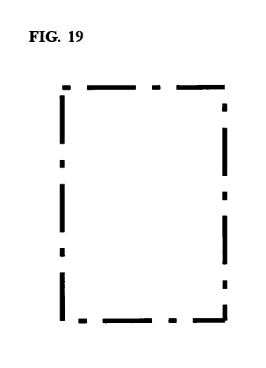

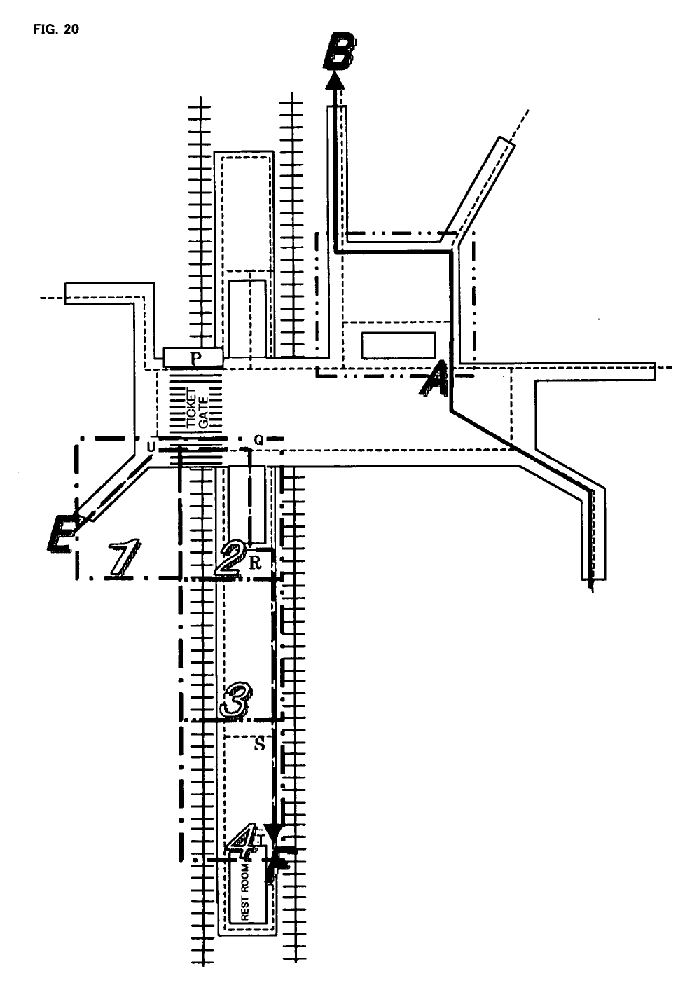

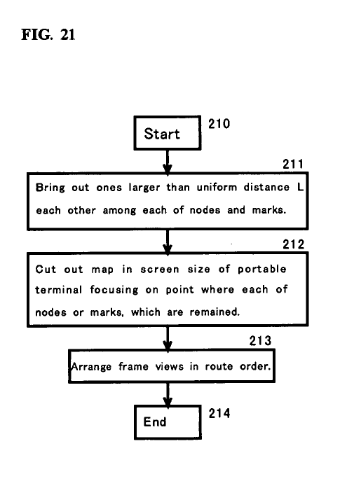

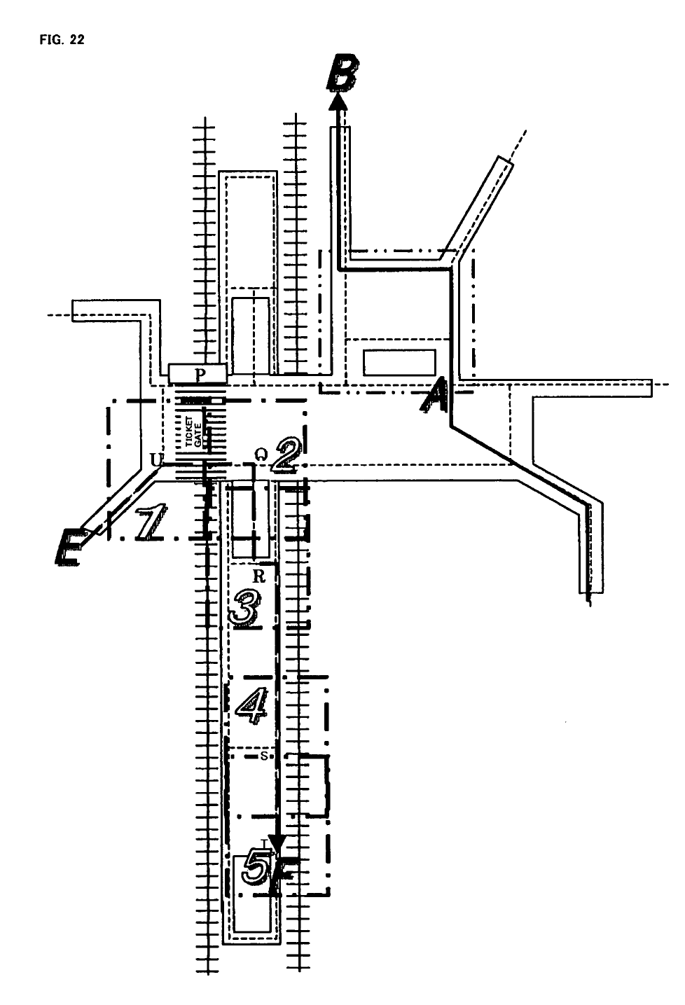

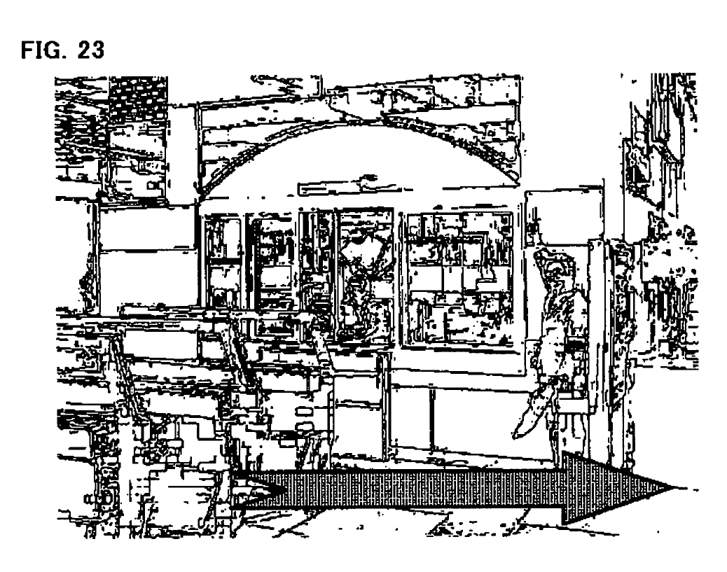

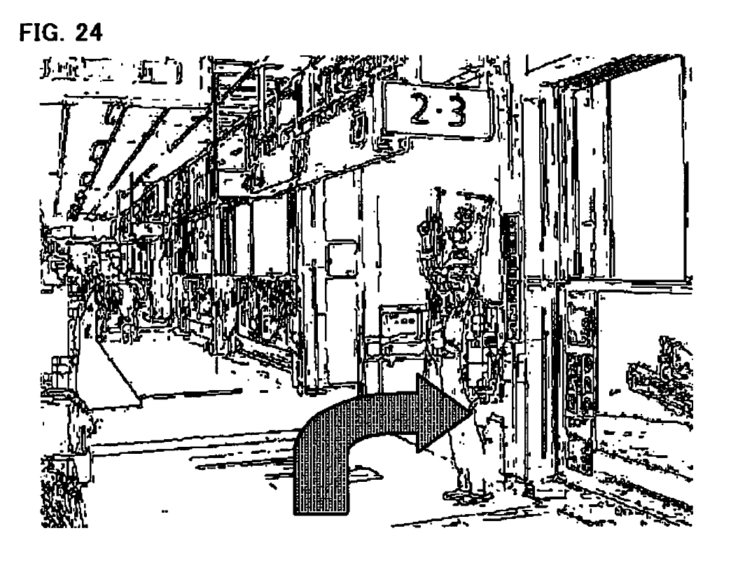

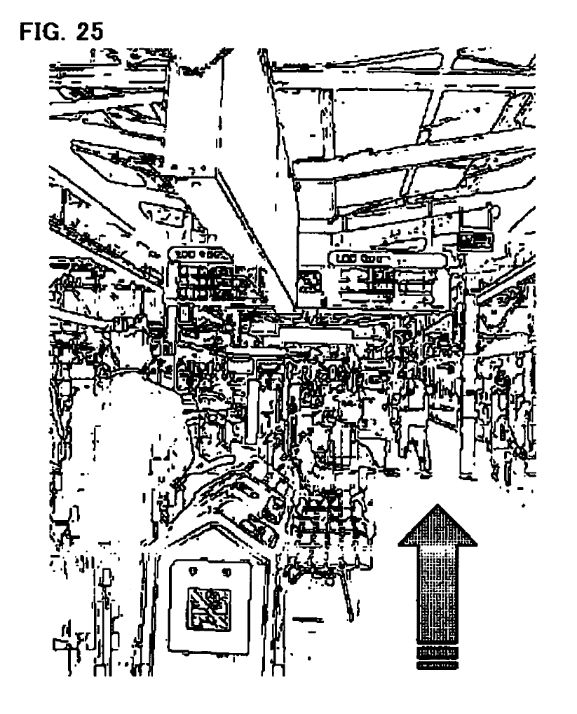

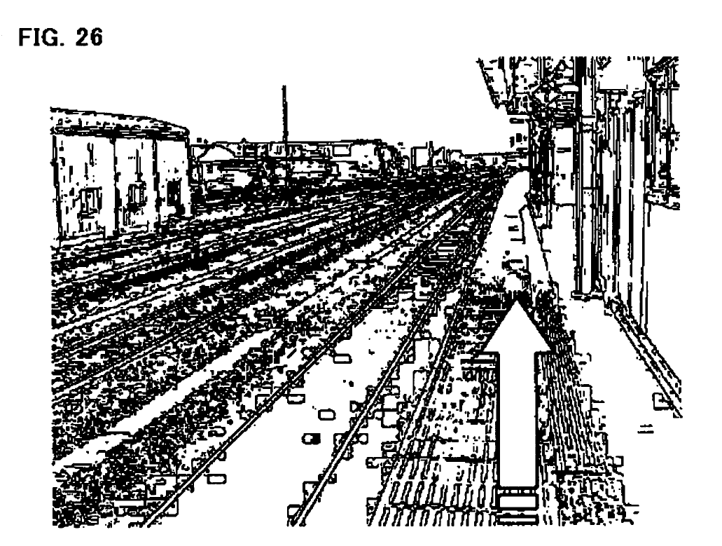

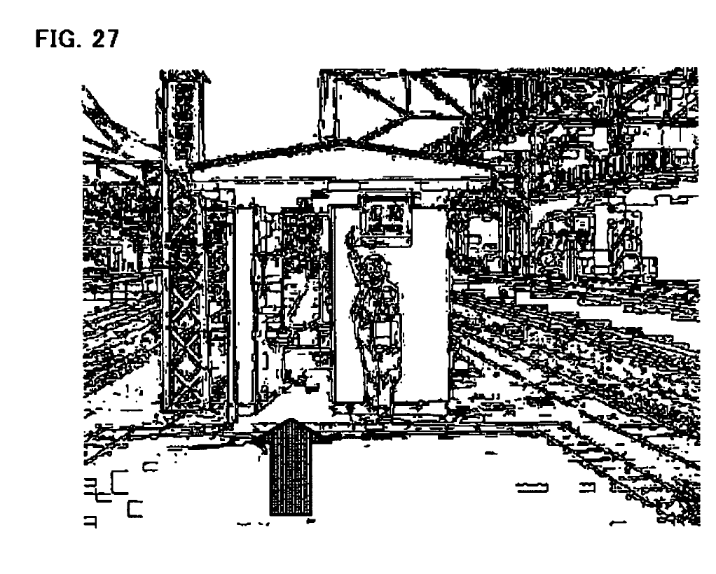

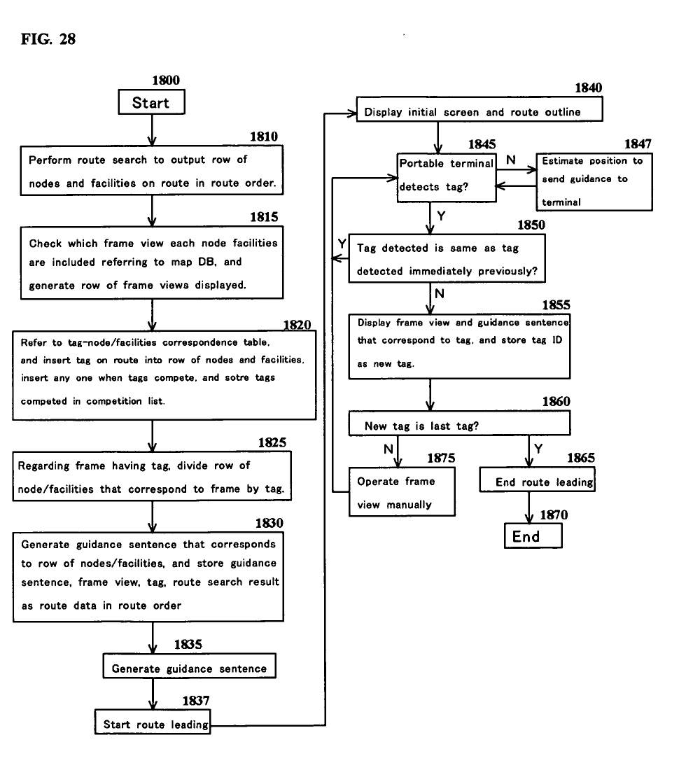

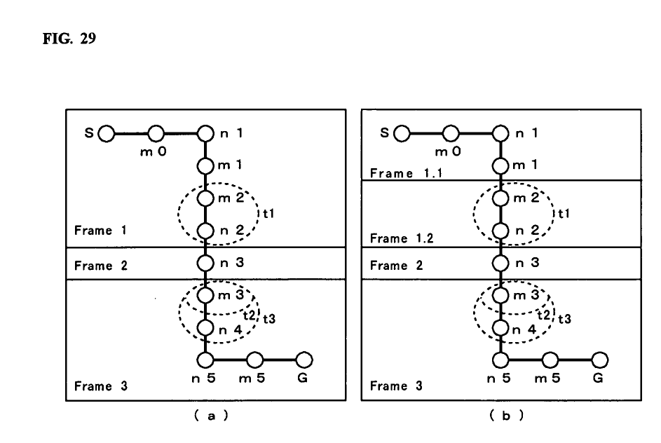

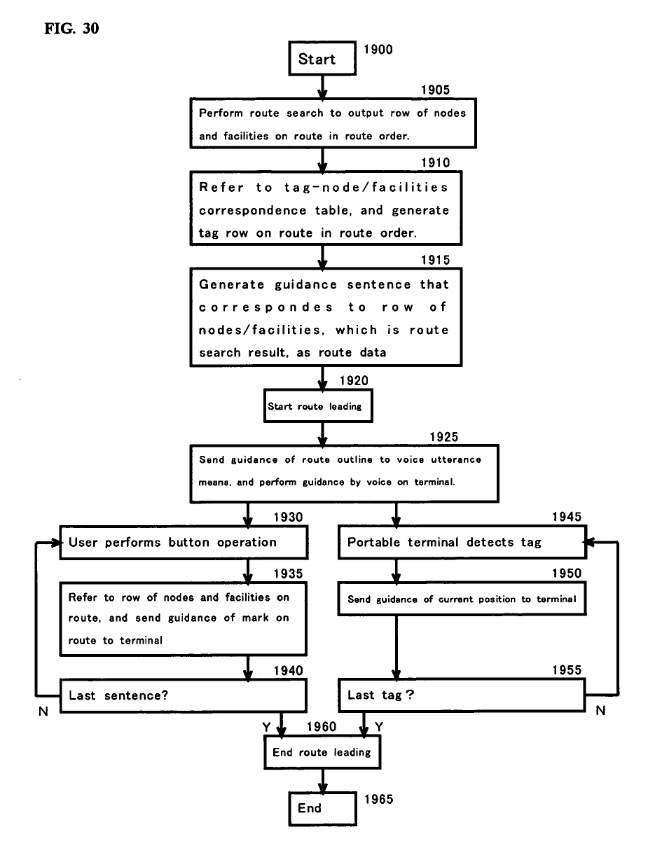

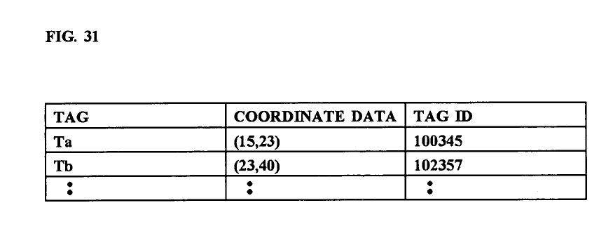

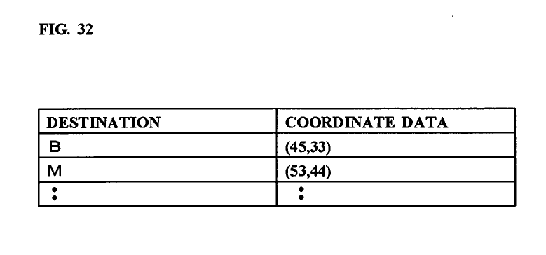

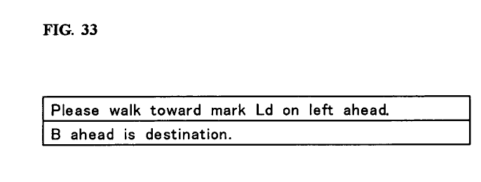

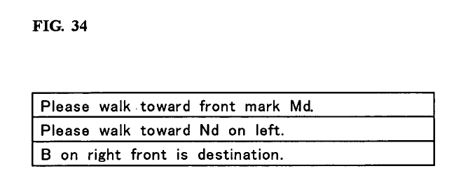

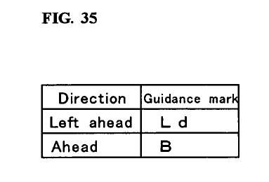

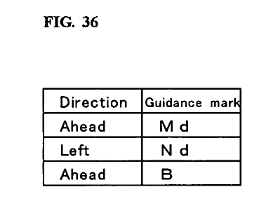

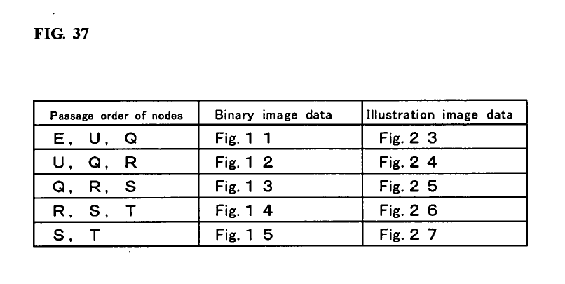

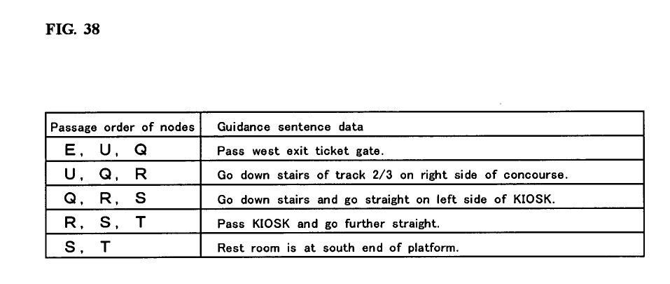

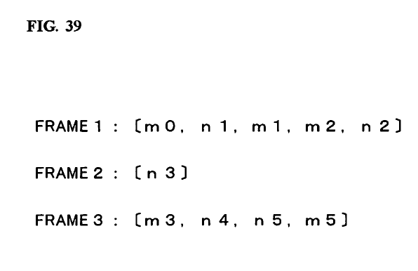

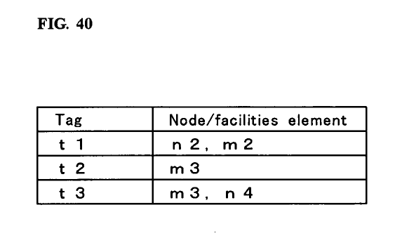

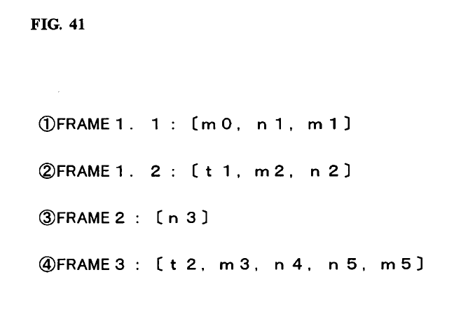

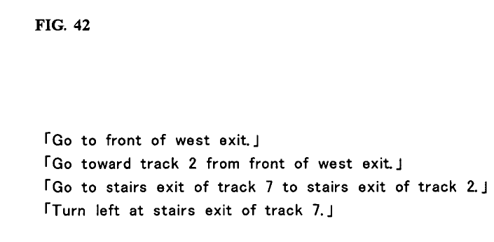

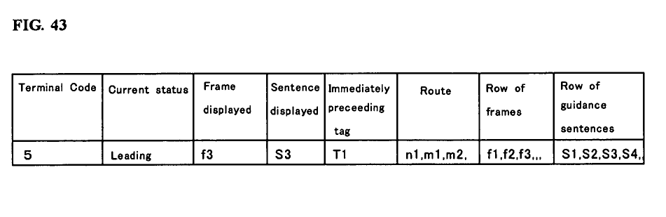

FIG. 10 shows the view in which the visible polygon from E was calculated to find the guidance point u (step 93 to step 98). Herein, when a threshold value n of the route guidance point is set to 10, the route guidance point is smaller than n since the route guidance point of the node row EU QRSTF is 7 (step 99). Referring to the correspondence table between the passage orders of nodes and the binary image data show n in FIG. 37, the binary images to which parameters are sped fled are retrieved from the binary image data DB, and they are arranged in the order of the route search result (step 101). When the route guidance point is larger than n, the correspondence table between the passage orders of nodes and the illustration image data shown in FIG. 37 is referred to and the illustration images to which parameters are specified are retrieved from the illustration image data DB, and they are arranged in the order of the route search result (step 102). Referring to the correspondence table between the passage orders of nodes and the guidance sentence data shown in FIG. 38, the guidance sentence is added to the image (step 103). The images shown in FIG. 11 to FIG. 15 and the guidance sentence are sequentially output to the port able terminal 30 (step 104), the illustration image data extraction means (35) shown in FIG. 4 extracts the illustration image data FIG. 23 to FIG. 27 in the case of the illustration image (step 105), and the processing ends (step 106).

The invention described in embodiment 2 can perform the route guidance easier to understand for the user who has difficulty in reading the route on the map by performing the route guidance that uses the image data, in which an arrow is added to the binary image or the illustration image for the guidance point in the traveling direction of the user, in the route guidance in the premises.

### Embodiment 3

FIG. 16 is the block diagram showing a configuration example of the route guidance means 2 in the present invention, and it comprises: the map DB40 where the route data for searching the route in the premises is accumulated; route search means 161 that searches the route in the premises; frame map generation means 1 that matches connection points of the route in each frame map to generate the frame map; the guidance sentence DB60 where the guidance sentences are accumulated; and guidance sentence generation means 163 that gene rates the guidance sentence from the guidance sentence DB based on the route search result.

The processing of the embodiment of the route guidance means 2 will be described along the flowchart of the route guidance means 2 shown in FIG. 17 and the flowchart of the frame map generation means 162 shown in FIG. 18. Herein, consideration will be given to the case of passing in the premises from E to F as shown by the broken line arrow. In the route guidance means 3, when the route search means 3 is activated (3000), the starting point E, the destination F and the parameter of the output image are entered (step 171). The route search is executed to output the node row of E, U, Q, R, S, T and F is output as the route search result (step 172). The frame map generation means 162 is activated according to the parameter of the output image entered (step 173). In the frame map generation means 162, a circumscribed rectangle of the route is calculated first (step 174). The circumscribed rectangle is expanded to an integral multiplication of the aspect ratio of the portable terminal screen (step 175). The circumscribed rectangle is cut into frames and the frame that does not include the route is abandoned (step 183). The frames are arranged in the route order and are output (refer to FIG. 20). At this point, the premises entire view shown in FIG. 20 is made such that the frame maps do not overlap with each other along the route to fit the screen of the display screen size of the portable terminal shown in FIG. 19, the routes at the boundaries between each of the frame map match, and thus, the frame views of 1 to 4 are formed, that is, as shown in the one-dot chain line. Referring to the correspondence table between the passage orders of nodes and the guidance sentence data shown in FIG. 38, the guidance sentence is added to the image (step 175). The image and the guidance sentence are sequentially output to the port able terminal 30 in the order of route search to end the processing (steps 176, 177).

The invention described in embodiment 3 can provide the route guidance, in which a pedestrian does not lose his/her direction by matching the display direction of the frame view in the route guidance and the direction of a railway and by displaying the frame maps while matching the connection points between each of the maps, in the route guidance in the premises, particularly in the station.

### Embodiment 4

FIG. 16 is the block diagram showing a configuration example of the route guidance means 2, and it comprises: the map DB40 where the route data for searching the route in the premises is accumulated; the route search means 161 that searches the route in the premises; the frame map generation means 162 that matches connection points of the route in each frame map to generate the frame map; frame map generation means 164 that displays the route in each frame map in the center of each frame; the guidance sentence DB60 where the guidance sentences are accumulated; and the guidance sentence generation means 163 that generates the guidance sentence from the guidance sentence DB based on the route search result.

The processing of the embodiment of the route guidance means 3 will be described along the flowchart of the route guidance means 3 shown in FIG. 17 and the flowchart of the frame map generation means 2 shown in FIG. 21. Herein, consideration will be given to the case of passing in the premises from E to F as shown by the broken line arrow. In the route guidance means 3, when the route search means 3 is activated (step 170), the starting point E, the destination F and the parameter of the output image are entered (step 171). The route search is executed to output the node row of E, U, Q, R, S, T and F is output as the route search result (step 172). The frame map generation means 164 is activated according to the parameter of the output image entered (step 174). The nodes having a distance L (10 meters, for example) or more are selected among each of the nodes E, U, Q, R, S, T and F on the route (step 211). The premises entire view shown in FIG. 22 is cut out such that each of the nodes E, U, Q, R, S, T and F is positioned in the center of the frame map as shown in the one-dot chain line along the route, that is. Into the frame views of 1 to 5 (step 212). The frame views are arranged in the order of each node E, U, Q, R, S, T and F (step 213). Refer ring to the correspondence table between the passage orders of nodes and the guidance sentence data shown in FIG. 38, the guidance sentence is added to the image (step 175). The image and the guidance sentence are sequentially output to the portable terminal 30 in the order of route search to end the processing (steps 177).

The invention described in embodiment 4 can perform the route guidance with the frame map easier to watch by matching the display direction of the frame view in the route guidance and the direction of the railway and by displaying the route guidance points such as the mark and the route node in each frame maps in the center of the frame view.

### Embodiment 5

The embodiment of the route leading means 1 will be described based on the flowchart of the route leading means 1 shown in FIG. 28 and the block diagram of the route leading means 1 shown in FIG. 7. Herein, description will be made for the case of passing the route as shown in FIG. 29. In the route leading means 1, when the user activates the route leading means 1(18) (1800), the position determination means 11 converts the starting point automatically detected by the position detection apparatus 20 into the coordinate on the map data, and the map determination means 11 further converts the destination entered by the user into the coordinate on the map data. The converted coordinates of the starting point and the destination are input to the route search means 170 to perform route search, and the row of facilities and nodes on the route is output in the route order (1810). The row of the nodes/facilities output in the example of FIG. 2(b) is shown as follows. m: mark; t: tag; and n: node. [m0, n1, m1, m2, n2, n3, m3, n4, n5, m5] . . . (an example of output of route search result)

The image data synthesis means 181 checks with the element-frame view correspondence table shown on table 16 in the map DB40 to find which frame view the node and the facilities belong to, a corresponding row of the frame views is retrieved from the frame view image 95 to draw the coordinate row of the route search results as the route on the corresponding frame view, it is stored in the frame view image DB90, and a frame-route element row correspondence table is generated as shown in FIG. 39 (1815).

Referring to the tag-node/facilities correspondence table of FIG. 40 in the map DB40, the tags on route are inserted in the row of the nodes and the facilities (1820).

The result where they have been inserted is as follows. [m0, n1, m1, t1, m2, n2, n3, t2, m3, n4, n5, m5] . . . (a: an example of an element row when the tag information is inserted)

The foregoing is the example where t2 and t3 compete and t2 has been selected. The nodes t2 and t3 competed are previously stored in the map DB40 as a competition list such as in (t2, t3). This enables it to deal with the case where t3 is received instead of t2 while the route leading is performed. Regarding the frame with the tag, the row of the nodes/facilities that corresponds to the frame is divided by the tag (1825).

Information of the mark and the node and corresponding guidance sentence are generated in each frame view, and they are respectively stored in the image DB90 and the guidance sentence DB60. ID's of the guidance sentence and the guidance image are stored in the route data 24 in the form of FIG. 43 (1830). In FIG. 43, an ID of each terminal, a status of the terminal specified by a terminal code, an ID of the frame view currently displayed, and ID of the guidance sentence currently displayed, an ID of the tag picked up immediately previously, an element row of the routes, and ID of the frame view displayed, and an ID of the guidance sentence corresponding to each frame are respectively stored in a terminal code, a current status, a field of a frame displayed, a sentence for display, an immediately previous tag, a route, a row of frames, and a row of guidance sentences, the current status is updated when the status changes, the frame for display and the sentence for display are updated when the frame and the guidance sentence displayed on the terminal change, and the immediately previous tag is updated every time the tag is detected.

Next, the route leading begins (1835). At the starting point, the frame of 1.1 in FIG. 29(b), which corresponds to \textcircled{1} of FIG. 41, is transmitted and displayed (1840). The positional information sent from the position detection apparatus 20 is checked by the position determination means 11 (1845), it checks whether or not the tag detected is the same as the immediately previous tag of FIG. 43 (1850) if a tag has been detected, and ignores the tag detected if they are the same and return to (1845). If they are different, the frame of 1.2 in FIG. 29(b), which corresponds to \textcircled{2} and \textcircled{3} of FIG. 41, is transmitted, \textcircled{2} is displayed first, and the tag t1 detected is stored as a new tag (1855). Whether or not the new tag t1 is the last tag t2 or the competing t3 in the row of the route fields of FIG. 43 (1860) is checked, and the frame of 2 in FIG. 29(b), which corresponds to \textcircled{3}, is displayed by a button operation if it is not the last tag. If it is the last tag, the route leading ends (1865). If a tag is not detected in (1845), the position determination means estimates the user's posit ion, it generates the guidance sentence such as ‘You are between track no. 7 and no. 2 now.’ and sends it to the terminal (1847), and returns to (1845). The terminal displays the guidance sentence. Now, in step (1855), when t3 is received instead of the tag t2, a correspondence relation between t2 and t3 is found out by referring to the competition list, and the frame 3 is displayed. In generating the guidance sentence that shows a direction to proceed next at the node n1 and the node, which are the first direction turning points, when the node n1 is within a range of error of the position detection by radio wave of the tag from the starting point S, a relative directional indication such as ‘Right turn’ that cannot be shown unless the starting point is assured is inappropriate and should be avoided, and the positional information of the node n1 and the guidance sentence of the mark showing the next traveling direction are generated as in the top line of FIG. 42. FIG. 42 is the example of the guidance sentences of embodiment 5.

Regarding the frame view, the map on which the illustration image, the binary image, and a town block shape are described may be used corresponding to each frame of FIG. 29.

The invention described in embodiment 5 synchronizes a guidance frame view of the route with tag detection in performing the route guidance, and assures the user of receiving information regarding the traveling direction near the tag before detecting the tag without fail even when there is an error in the range where the radio wave reach in the tag, and furthermore, the first traveling direction turning point and the mark that can be seen from the first traveling direction turning point are guided even when the positional information of the first traveling direction turning point includes an error, and thus information provision where the route information is not complex can be performed.

### Embodiment 6

The embodiment of the route leading means 2 will be described based on the flowchart of the route leading means 2 shown in FIG. 30 and the block diagram of the route leading means 2 shown in FIG. 8. Herein, description will be made for the case of passing the route as shown in FIG. 29. In the route leading means 2, when the user activates the route leading means 2(16) (1900) from the terminal 30, the starting point automatically detected by the position detection means 20 and the destination that the user enters by the portable terminal 30 are input to the route search means 170 to perform the route search, and the row of nodes and facilities on the route is output in the route order (1905). The row of the nodes/facilities output in the example of FIG. 29(a) is shown as follows. m: mark; t: tag; and n: node. [m0, n1, m1, m2, n2, n3, m3, n4, n5, m5] . . . (example of output of route search result)

Referring to the row of the node s/facilities and the tag-node/facilities correspondence table of FIG. 40, the row of the tags on the route is generated in the route order is generated (1915). The guidance sentence synthesis means 193 generates the guidance sentences shown in FIG. 45, which correspond to the row of the nodes and the facilities, from the guidance sentence DB60 and the gene ration rule in the guidance sentence DB, and the guidance sentences and the row of the nodes and the facilities, which is the route search result, are stored in the route data 24 in the form shown in FIG. 44 in the route order (1915). At the same time, the route leading begins (1920). Firstly, guidance of a route out line is sent to the speech synthesis means 13, and the guidance by voice is performed from the terminal (1925). When the position detection apparatus 20 detects the tag (1945), the guidance sentence from the tag t1 detected to before the tag t2 out of the guidance sentence data of FIG. 45 is sent to the terminal (1950). Whether or not t1 is the last tag on the route is checked by referring to the route field of FIG. 44 (1955). Command waiting from the portable terminal is performed if it is not the last tag, and the route leading ends if it is the last tag (1960). When the user performs the button operation on the portable terminal (1930), the fields of the rows of the sentence for display and the guidance sentence of FIG. 44 are referred to, the guidance sentence before or after the sentence for display is sent to the terminal in accordance with the button operation, and the field of the sentence for display is updated (1935). Whether or not the sentence for display updated is the last guidance sentence is checked by referring to the row of the guidance sentences, the command waiting of the portable terminal is performed if it is not the last one, the route leading ends if it is the last one (1960), and the processing ends (1965).

### An Example of the Guidance Sentence:

FIG. 45 is the example in the case where the tag t1 is detected after the mark m2.

The invention described in embodiment 6 provides the vision-impaired person of a provision method of the route information and an information provision method of the current position separately, the current position is provided when the tag is detected and the information of the traveling direction is provided by the button operation of the user, and thus information provision where the route information is not intricate can be performed.

### Embodiment 7

FIG. 46 exemplifies the function block diagram of the route guidance apparatus in embodiment 7 of the present invention. In FIG. 46, a route guidance apparatus 4600 comprises: position determination means 4601; visible region calculation means 4602; route search means 4603; traveling direction calculation means 4604; mark extraction means 4605; and guidance sentence generation means 4606.

The position determination means 4601 detects the current position of the user. For example, a tag that emits the radio wave including its own number is embedded in a wall or a floor in the premises, the portable terminal that the user has is designed to receive the radio wave from the tag, and the position determination means 4601 receives the number of the tag, which the portable terminal transmits, and detects the current position of the user from the number of the tag. Alternatively, the portable terminal that the user has emits the radio wave, a receiving apparatus installed on the wall or the floor receives the radio wave, and the current position may be detected depending on which receiving apparatus has received the radio wave of the portable terminal.

The visible region calculation means 4602 calculates the visible region that is the range where the user can see from the current position detected. Specifically, it calculates the range where the user can see from the current posit ion of the user detected by the position determination means 4601. When obstacles that block the range of vision of the user are approximated by polygons and their positions are stored, the range where the user can see can be calculated by a visible region calculation method by the conventional plane scanning method. Or other methods may be used.

The route search means 4603 searches the route from the starting point to the destination. FIG. 47 exemplifies an example of the table used in the route search, and FIG. 47 expresses that from which point to which point one can directly reach. For example, the first line of the table of FIG. 47 means that one can directly reach from point A to point C. By using such a table, to obtain the route from any starting point given to any destination, a line where the first starting point given appears in the row of the starting points is retrieved, a value of the row of a final destinations on the line is obtained, a line that has the value obtained as the starting point is retrieved, and a value of the row of the final destinations on the line is obtained, which are repeated and continued until the destination is obtained as the value of the row of the final destinations. For example, when A is set as the starting point and G is set as the destination, the line that has A as the value of the row of the starting points is retrieved, the first line of FIG. 47 is obtained, and C is obtained as the final destination. Next, the line where C appears as the value of the row of the starting points, the third line, the fourth line, and the fifth line are obtained and D, E and F are obtained as the final destination, the lines where each of the three appears in the row of the starting points are retrieved, the sixth line is obtained as the line where D appears in the row of the starting points when the row of the final destinations is obtained, the processing ends because its final destination is G, and finally, a route A→C→D→G is obtained.

The traveling direction calculation means calculates the traveling direction from the visible region and the route. Specifically, it calculates the traveling direction where the user should proceed from the range, where the user can see, calculated by the visible region calculation means 4602 and the route searched by the route search means 4603. As a calculation method, in which direction the direction of a posit ion to be proceeded next from the starting point is within the visible region is calculated if the current position of the user detected by the position determination means 4601 is the starting point of the route searched by the route search means 4603. For example, the starting point is A and when the route search means 4603 has searched that the position to be proceeded next is C, in which direction the direction from A to C is within the visible region is calculated. For this calculation, the coordinate position of each point is stored in the route guidance apparatus 4600 as shown in FIG. 48, and the direction may be calculated from the coordinate positions. Alternatively, the route searched by the route search means 4603 is expressed in the row of the line segments that has the position on the route as the end point, the intersecting point between the row of the line segments and the visible region calculated by the visible region calculation means 4602 is obtained, and the direction that directs from the current position to the intersecting point may be the traveling direction.

The mark extraction means 4605 extracts the mark to be guided from the visible region. Specifically, it extracts the mark to be guided out of the marks within the visible region calculated by the visible region calculation means 4602. In this processing of extraction, the mark near the traveling direction calculated by the traveling direction calculation means 4604 is extracted. The mark that exists within the visible region calculated by the visible region calculation means 4602 can be extracted by correlating the marks and their coordinate positions as shown in FIG. 49, and further the mark near the traveling direction calculated by the traveling direction calculation means 4604 can be extracted. If it does not exist in the mark near the traveling direction calculated by the traveling direction calculation means 4604, the mark in the direction opposite to the traveling direction may be calculated or the mark in the direction 90 degrees in the left or 90 degrees in the right may be extracted.

The guidance sentence generation means 4606 gene rates the route guidance sentence of the route found. Specifically, it generates the guidance sentence that guides the route in the case of proceeding the route searched by the route search means 4603 while relying on the traveling direction calculated by the traveling direction calculation means 4604 or the mark extracted by the mark extraction means 4605. To generate this guidance sentence, a template of the guidance sentence that includes variables as ‘Please proceed while looking at A on B.’ is prepared, the name of the mar k is inserted in ‘A’, the direction where the mark can be seen is inserted in ‘B’, and thus the guidance sentence may be generated. For example, by the mark extraction means 4605, when a mark called Ld has been extracted by the mark extraction means and calculation has been made that the mark was on the left side of the traveling direction, Ld is substituted for ‘A’ and ‘Left ahead’ is substituted for ‘B’ to generate the sentence as ‘Please proceed while looking at Ld on left ahead’. Alternatively, complete sentences as shown in FIG. 33 are prepared from the beginning, searching is performed depending on the mark and the direction where it can be seen, and the guidance sentence on the first line of the table may be obtained. Further, when it is found out that the destination is within the visible reed, on and it is ahead of the user, the second line of the lines of FIG. 33 is obtained.

In this embodiment, the visible region calculation means 4602 may calculate not only the range that can be see n from the current position of the user, which has been detected by the position determination means 4601, but also the range that can be seen from the point on the route, which has been searched by the route search means 4603. FIG. 5 is the flow chart that explains the operation of the route guidance apparatus 4600 in such a case.

Firstly the positional information, that is, the cur rent position of the user is detected by the position determination means (51), and the current position is set as Entrance. Specifically, the coordinate of the current position is substituted for a variable called Entrance (52). Next, the route from the cur rent position to the destination is searched by the route search means 4603 (53). The visible polygon from Entrance to the direction of the destination is calculated (54). Specifically, the visible polygon, which is the visible range seen from the point substituted for the variable called Entrance, is calculated using the visible region calculation means 4602. Next, determination is made whether or not there is the intersecting point between the route search result and the visible polygon (55). Specifically, whether or not there is the intersecting point between the route searched by the route search means 4603 and the visible region calculation means 4602 is checked, and the intersecting point between the route search result and the visible polygon is set as Exit if there is the intersecting point (56). In other words, the intersecting point is substituted for the variable called Exit. The direction from the point substituted for Entrance to the point substituted for Exit is found by the traveling direction calculation means 4604, the mark having the minimum direction difference is extracted by the mark extraction means 4605, and the direction and the mark found are registered (57). Next, the point substituted for Exit is substituted for Entrance to return to step 54.

If there is no intersecting point at step 55, the destination is substituted for Exit when the destination is in the visible polygon that is the visible region (59). Then, the destination and the direction of the destination are registered (60), and all the marks and the directions registered are output by inserting them in the guidance sentence (61).

With this embodiment, the route that can reach the destination faster can be guided even if the route search means has searched a circuitous route.

Further, the position determination means may obtain the current position of the terminal at a regular time interval, and the guidance sentence generation means may gene rate the guidance sentence of the route regarding the next mark to the terminal when determination is made that it has approached the mark that exists in the route searched by the route search means. Specifically, one in which the guidance sentence of the route regarding the next mark is generated is transmitted to the terminal. As described, the direction or the like when the user has approached the next mark can be previously informed to the user by generating the guidance sentence regarding the next mark to the terminal for the user, and smooth route guidance is thus made possible.

### Embodiment 8

FIG. 50 exemplifies the function block diagram of the route guidance apparatus in embodiment 8 of the present invention. In FIG. 50, the route guidance apparatus is one in which an image data retrieval means 5001 is added to the route guidance apparatus 4600 of embodiment 7.

The image data retrieval means 5001 searches viewpoint image data specified to guide points to pass on the route. Specifically, it retrieves the image data to guide the route in the case of proceeding the route searched by the route search means 4603 while relying on the traveling direction calculated by the traveling direction calculation means 4604 or the mark extracted by the mark extraction means 4605. The image data in this case is the viewpoint image data. The viewpoint image data is data of an image when a landscape is see n from a particular viewpoint, and is image data where the landscape is expressed three-dimensionally. For example, the image expressed by perspective or the image in which the landscape is viewed in bird's-eye is cited.

The image data retrieval means 5001 performs retrieval of the image data from the user's position and the direction calculated by the traveling direction calculation means 4604 or in accordance with the user's position and the mark extracted by the mark extraction means 4605, for example. FIG. 51 is the table where ‘points to pass’ and ‘image data’ are correlated, in which the ‘points to pass’ comprises three elements, in which the first element, the second element, and the third element respectively express the starting point, a point to pass through in halfway, and a point to be reached after passing through, or the first element is the position, the second element and the third element respectively express the direction and the mark, and it expresses that the image data stored in the row of ‘image data’ is retrieved for the three elements.

FIG. 52 exemplifies the table in which the data used for generating the guidance sentence by the guidance sentence generation means 4606 in this embodiment is stored. In FIG. 52, although the same row as the row of ‘points to pass’ in the table of FIG. 51 exists in FIG. 52 in order to gene rate the guidance sentence while synchronizing with the image data retrieved by the image data retrieval means 5001, it is not limited to the point where the guidance sentence is generated while synchronizing with the image data retrieved by the image data retrieval means 5001, and it may generate the guidance sentence of the contents to complement the image data or the contents more detail than the image data.

According to the route guidance apparatus by this embodiment, provision of the guidance sentence with the viewpoint image data expressed three-dimensionally to the user guided is made possible, and guidance service easier to understand can be provided to the user.

### Embodiment 9

FIG. 53 exemplifies the function block diagram of the route guidance apparatus according to embodiment 9 of the present invention, and a route guidance apparatus 5300 includes: route search means 5301; frame map generation means 5302; a map database 5303; and guidance sentence generation means 5304.

The route search means 5301 searches the route from the starting point to the destination as described in embodiment 7 and embodiment 8.

Frame map generation means 5302 cuts out maps around the points to pass as the frame map from the map database 5303 in order to guide the points to pass, and it cuts out each frame such that a part of the route in each frame overlaps in cutting out them. The ‘point to pass’ is the point to be passed in moving an the route searched by the route search means 5301. The map database 5301 holds the maps around the point to be passed when moving on the route, and it is one in which the map around a coordinate is retrieved when the coordinate of the point is given, for example. ‘A part of the route in each frame overlaps in cutting out the m.’ means that when a map is cut out as a frame and the frame of the map cut out next is compared with it, the routes displayed on the both frames have caiman areas.

The guidance sentence generation means 5304 gene rates the guidance sentence to guide the point to pass. As in embodiment 8, the guidance sentence may be generated while synchronizing with the frame generated in the frame map generation means 5302, or the guidance sentence of the contents to complement the contents of the frame or the contents more detail than the frame may be generated.

FIG. 54 is the flowchart that explains the processing of the route guidance apparatus 5300, mainly the processing of the frame map generation means. Firstly, the route is searched by the route search means 5301 to obtain the route (S5401). Next, the starting point is substituted for a variable L (S5402). Substituting the starting point means to substitute the coordinate of the starting point. Then, determination is made whether or not L is the destination (S5403). Specifically, determination is made whether or not the coordinate of L is the coordinate of the destination, the processing ends when it is the destination, and the map around L is obtained when it is not (S5404). In other words, the map around the coordinate substituted for L is obtained as the frame from the map database 5303. When the frame is obtained, it is displayed for the user or it is correlated with the coordinate position substituted for L and accumulated, and the frame is displayed when detection is made that the user has reached the position of the coordinate. When the map of the vicinity is obtained, L is moved along the route (S5405). Specifically, the coordinate position substituted for L is updated to the coordinate after it has moved along the route. At this point, by setting the coordinate position substituted for L to the position on the route, which is displayed on the map of the frame, ‘A part of the route in each frame overlaps in cutting out them.’ is done. After L is moved, the processing returns to step S5403.

As described, by overlapping a par t of the route in each frame in cutting out the frames, the current position of the user, which is displayed on the frame, does not change largely on the screen when the next frame is displayed for the user, and displaying easy to see for the user is made possible.

### Embodiment 10

In embodiment 9 of the present invention, when the frame nap generation means 5302 cuts out the frames in embodiment 8, they are cut out so that the route in each frame is displayed in the center of the screen instead of overlapping the route in each frame.

For example, in the case where the route search means 5301 has searched the one that passes the points E, U, Q, R, S, T and F as shown in FIG. 22, the points that are remote by a predetermined distance L (10 m for example) or more are selected among them, each of the points E, U, Q, R, S, T and F is cut into the frame views of 1 to 5 as shown in the one-dot chain line of FIG. 22, and arranging the frame views in the order of E, U, Q, R, S, T and F is performed.

As described, by cutting out such that route is displayed in the center of the screen, the points to be passed on the route are displayed on the center of the frame views, and performing the route guidance by the frame view easier to see is made possible.

### Embodiment 11

In embodiment 7 to embodiment 10, the guidance sentence generation means may generate the guidance sentence based on the user's moving direction to guide the point to pass. The user's moving direction is the direction where the user moves when the user travels on the route, where the route has bee n searched by the route search means. By generating the guidance sentence in this manner, when the route is bent at a certain point, the guidance sentence regarding which way to turn for the moving direction until the user reaches the point is generated. For example, assuming that the route from S to G shown in FIG. 29(a) has been searched by the route search means, although the route is bent at the point of n1, the guidance sentence that says ‘Please turn right at n1.’ is generated because the user who moves from the point of m0 to n1 turns right when the guidance sentence to turn at n1 is generated.

As described, by generating the guidance sentence based on the user's moving direction, guiding of the user by the guidance sentence easier to understand than the guidance sentence such as ‘At n1, please turn to the direction where m1 exists.’ for example, is made possible.

### Embodiment 12

In embodiment 7 to embodiment 11, in the case where the route guidance apparatus guides the route that passes the points in a platform of the train station premises, the guidance sentence generation means may generate the guidance sentence using the direction of the railway for the user in the station platform as a reference in order to guide the points to pass.

Since the railway usually extends in a straight line and it is a noticeable structure, the guidance easy for the user to understand is made possible when the guidance sentence such as ‘Please turn right for the rail way.’ or ‘Please to straight directly along the railway.’ are generated using the direction of the railway as a reference.

### Embodiment 13

In embodiment 7 to embodiment 12, the guidance sentence generation means does not give guidance of turning right or left at the first direction turning point when the starting point is near the point where a direction turn is made for the first time, but may generate the guidance sentence of the mark that shows a direction turning direction from the direction turning point. For example, assume that the route search means has searched the route shown in FIG. 29(a) as the route having S as the starting point and G as the destination and that the starting point S and the first direction turning point n1 are near.

If the starting point S is the posit ion detected by using the radio wave of the tag or the like, it is possible that the user is not actually at S but at the opposite side of S when seen from n1 in FIG. 29(a) because the position is detected with an error. If the user is actually at the opposite side of S when seen from n1, the user moves to the opposite direction to m1 at n1 when the guidance sentence generation means assumes that the user is at S to generate the guidance sentence as ‘Please turn right at n1.’. Therefore, when the starting point and the first direction turning point are near, the guidance of turning right or left is not performed but the guidance sentence of the mark that shows the direction turning direction from the direction turning point is generated.

FIG. 55 is the flowchart that explains the processing of the guidance sentence generation by the guidance sentence generation means in this embodiment. Firstly, whether or not the guidance to the destination has been per formed is determined at step S5501. Specifically, whether or not the guidance sentence to the destination has been generated is determined, the processing ends if the guidance sentence to the destination has been generated, the processing moves to the step S5502 if not and whether or not the point to be guided is the direction turning point is determined. If it is not the direction turning point, the processing moves to step S5503 to generate the guidance sentence, and returns to step S5501. If it is the direction turning point, the processing returns to step S5504, whether or not the direction turning point is near the starting point, that is, whether or not they are within an error range since this direction turning point is the first direction turning point, and the processing moves to step S5505 if they are within the error range and the guidance sentence of the mark that shows the direction turning direction is generated. For example. In the case of FIG. 29(a), the guidance sentence as ‘Please turn to the direction where m1 can be seen.’ is generated at n1. If the first direction turning point and the starting point are not within the error range at step S5504, the processing moves to step S5506 and the guidance sentence that guides the direction of the direction turn is generated.

Hereinafter, in step S5507 and step S5508, generation of the guidance sentence in a regular manner is repeated until the guidance sentence to the destination is generated.

As described, when the first direction turning point is near the starting point, the movement of the user to a totally different direction can be prevented by generating the guidance sentence of the mark that shows the direction turning direction.

### Embodiment 14

In embodiment 7 to embodiment 13, the route guidance apparatus may include the tag detection means, and the guidance sentence generation means may generate the guidance sentence that guides the positional information near the tag detected by the tag detection means. As the positional information near the tag, information such as where the tag is or what is around the tag is cited as an example.

FIG. 56 is the flowchart that explains the processing of the route guidance apparatus in this embodiment. In step S5601, whether or not the tag has been detected by the tag detection means is determined. If the tag is not detected, the processing moves to step S5602 and whether or not the guidance has ended is determined. As the case where the guidance ends, a case where the user has pushed a button for guidance end or the like is cited. The processing ends if the guidance has ended, and returns to step S5601 if not.

When the tag has been detected in step S5601, the processing moves to step S5603 to obtain the position of the tag. To obtain the position of the tag, it may be obtained from the contents where the ID's of tags and coordinate positions are correlated and stored, as shown in FIG. 31. In step S5604, the guidance sentence that guides the positional information near the position obtained is gene rated, and the processing returns to step S5601.

As described, when the tag is detected, the guidance sentence that guides the positional information near the position thereof is generated, and thus the user guided can know whether or not he/she is moving to a right direction. Further, in a museum or the like, the user can be informed of the guidance sentence regarding an art object when he/she moves in front of the art object.

Furthermore, in this embodiment, the guidance sentences for each of mark information along the route are arranged in the route order and each guidance sentence may be read out synchronously with the detection of a tag by the tag detection means. Specifically, to give guidance such that the user moves on the route, the information regarding the marks is arranged in the order of the marks that app ear as the user travels on the route, and each of information may be read out every time the tag is detected.

### Embodiment 15

In embodiment 7 to embodiment 14, the guidance sentence generation means may have a guidance sentence request acceptance function, and the guidance sentence generation means may arrange the guidance sentences for each of the mark information along the route in the route order and may read out each guidance sentence when it accepts a guidance sentence request based on the guidance sentence request acceptance function.

FIG. 57 shows a part of the function block diagram of the route guidance apparatus in this embodiment, in which the guidance sentence generation means 5304 has a guidance sentence request acceptance function 5701, and the guidance sentence request acceptance function 5701 accepts the guidance sentence request that is a request for reading out the guidance sentence. The guidance sentence request acceptance function 5701 includes input means such as a button, voice recognition, and a touch panel. When the guidance sentence request acceptance function 5701 accepts the guidance sentence request, the guidance sentence generation means arranges the guidance sentences for each of the mark information, which is the information regarding the marks to guide the user along the route in the route order, and reads out each guidance sentence sequentially. In other words, the guidance sentence generation means arranges and accumulates the guidance sentences for each of the mark information in the route order, and performs reading out of each guidance sentence when the guidance sentence request is accepted.

FIG. 58 is the flowchart that explains the processing of the guidance sentence generation means 5304 in this embodiment. In step S5801, whether or not the guidance sentence request has been accepted by the guidance sentence request acceptance function 5701 is determined, the processing moves to step S5802 if it has been accepted, and the guidance sentence of the mark information is read out. For example, reading out of the guidance sentence regarding the mark seen from the current position is performed such that in which direction it can be seen and such as which way to proceed for the direct ion. When reading out is finished, the processing returns to step S5801.

In the case where the guidance sentence request has not been accepted in step S5801, the processing moves to step S5803 to determine whether or not the guidance has ended, the processing ends if it has ended, and returns to step S5801 if not. Whether or not the guidance has ended is determined, for example, by detecting the operation of the button or the like by the user or detecting that the user has reached the destination with the position determination means.

As described, the route guidance apparatus accepts the guidance sentence request with the guidance sentence request acceptance function 5701 and reads out the guidance sentence, and thus provision of the guidance sentence when the user wants the guidance sentence is made possible.

Further, the guidance sentence generation means 5304 may have a user characteristic information acceptance function, and the guidance sentence generation means 5304 may provide the route information in accordance with user characteristic information that is information regarding a user's characteristic accepted based on the user characteristic information acceptance function. The user characteristic information acceptance function is a function to accept the user characteristic information that is the information regarding the user's characteristic, and it accepts a characteristic to be considered in performing the route guidance such as the user's age, whether or not the user is a foreigner, which language his/her mother tongue is if he/she is not a Japanese, whether or not the user is a vision-impaired person, a hearing-impaired person, a walking-impaired person or an able-bodied person, for example. The guidance sentence generation means provides the route information in accordance with the user characteristic information accepted by the user characteristic information acceptance function. For example, reading out of the guidance sentence is performed slowly or characters included in a map are made large in the case of displaying the map when the user is a child or an aged person, and Chinese characters are used as little as possible in the case of a child. When the user is a foreigner, reading out of the guidance sentence and displaying of the map in his/her mother tongue is performed. Particularly, reading out of the route information is not performed but the route information is provided by displaying characters when the user is a hearing-impaired person, and the route information is not displayed but reading out is performed in the case of a vision-impaired person. Further, if there is an obstacle such as stairs is on the route, the guidance sentence that informs of it in advance may be generated and read out. More over, the guidance sentence regarding the marks meaningful particularly to the vision-impaired person, such as where textured paving blocks are, which direction to proceed for a direct ion from which a specific sound is heard, what kind of a feeling and a sound are made when poking a road surface with a stick, or how they change, and where a large object, a noticeable light source, and a guidance display in braille are, may be generated and read out. Further, when the user characteristic information that the user feels it difficult to move on the same passage as the able-bodied person or the user characteristic information that he/she walks slower than the able-bodied person, the information such as in which direction a slope and an elevator are instead of stairs and how far they are may be pro vided, or an existence of a route where people's movement is slow may be provided.

### Embodiment 16

In embodiment 16 of the present invention, the route guidance apparatus in embodiment 7 or 8 further includes the tag detection means and route leading means. The tag detection means detects tags planed in the premises, the posit ion of the tag is obtained and the position where the apparatus is now is detected by detecting the tag by the tag detection means. The route leading means performs displaying of the frame view or the viewpoint image, which correspond to the tag position, and the route guidance sentence or reading out of the guidance sentence synchronously with detecting the tag by the tag detection means.

As described, since an appropriate frame view or viewpoint image and the route guidance sentence are displayed and the guidance sentence is read out as the user moves on the route by performing detection of the position with the tag detection and per forming displaying of the frame view or the viewpoint image and the route guidance sentence or reading out of the guidance sentence, service of the route guidance easy to understand for the user can be provided.

### Embodiment 17

In this embodiment of the present invention, the position determination means 4601 in embodiment 7 or 8 detects the current position of the user, and user request obtaining means and route leading means are further included. FIG. 60 shows the function block diagram of the route guidance apparatus in this embodiment, and user request obtaining means 6001 and route leading means 6002 are added to FIG. 46.

The user request obtaining means 6001 obtains the user's request. Specific ally, it obtains a request that the user wants to receive provision of the route information, and it includes input means such as the button, the voice recognition, and the touch panel, for example.

The route leading means 6002 performs displaying of the frame view or the viewpoint image, which correspond to the tag, and the route guidance sentence on the terminal or reading out of the guidance sentence in the route order in accordance with the user's request that the user request obtaining means 6001 obtains. Specifically, it stores which tag has detected with the movement of the user to recognize the current position, displays the frame view or the viewpoint image, which correspond to the current position recognized, and the route guidance sentence an the terminal or reads out the guidance

sentence, and performs leading such that the user moves an the route when the user's request is made.

FIG. 59 is the flowchart that explains the operation of the position determination means 4601, the user request obtaining means 6001, and the route leading means 6002 in this embodiment. Firstly, on step S5901, whether or not the user request has been obtained is deter mined on the user request obtaining means 6001. If it has been obtained, the processing moves to step S5902 to obtain the position detected by the tag. The position detected by the tag is detecting an identifier of the tag by receiving the radio wave from the tag and detecting the position by information where the identifier of the tag and the position are corresponded with each other. In step S5903, obtaining and displaying of the frame view or the viewpoint image, which correspond to the position, is performed (step S5903 is not executed if the image data search means does not exist.). In step S5904, reading out of the guidance sentence that corresponds to the position is performed, and the processing returns to step S5901.

In the case where it is determined that the user request has not been obtained in step S5901, the processing moves to step S5905 to determine whether or not the tag has been detected by the position determination means 4601, and the processing moves to step S5906 to store the tag if the tag has bee n detected. Specifically, the identifier of the tag is stored to make it possible to detect the position in step S5902. Then, the processing returns to step S5901.

In step S5905, whether or not the guidance has ended is determined if the tag is not detected, the whole process ends if it has ended, and the processing returns to step S5901 if not. Whether or not the guidance has ended is performed by detecting whether or not the tag detected in the position determination means 4601 is the one of the destination or by detecting that the user performs d a button operation of a guidance end.

### Embodiment 18

This embodiment relates to the visible region calculator. In this embodiment, the visible region calculator, when the viewpoint and one or a plurality of polygons are in one polygon, the visible region from the viewpoint regarding an outermost polygon is computed first. Next, a part seen from the viewpoint only for each polygon is computed as in a row of continuous line segments regarding the polygons other than the outermost polygon, the row of the line segments computed is arranged in the argument order, the row of the line segments, a part of the line segment seen from the viewpoint is computed in the order of arrangement taking in consideration a positional relation between the row of the line segments and a visible region generated at the point where the processing of a previous row of line segments ends, and the range seen from the viewpoint is calculated with the processing to find a new visible region by connecting the area computed and the visible region.

FIG. 61 is the flowchart that explains the operation of the visible region calculator in this embodiment.

In step 2110, the visible region regarding the outer most polygon is computed. The visible region calculator in this embodiment is one to calculate the visible region when the viewpoint and one or a plurality of polygons are in one polygon, and the ‘one polygon’ that includes the ‘viewpoint and one or a plurality of polygons’ inside thereof is the outermost polygon. In this step, the visible region that is a visible range seen from the viewpoint regarding the outermost polygon is calculated. When the outermost polygon is a convex figure, the outermost polygon becomes the visible region as it is, but when the outermost polygon is a concave figure, the range narrower than the outermost polygon sometimes becomes the visible region.

In step 2120, the visible polygonal line of only each facilities is calculated regarding the facilities. The ‘each facilities’ means the polygon inside the outermost polygon, and the ‘visible polygonal line’ is the continuous line segments of the part seen from the viewpoint of the polygon.

In step 2130, regarding the row of line segments called the visible polygonal lines calculated in step 2120, the visible polygonal line is sorted in the order that the argument for either end point of the visible polygonal line is small. The ‘argument’ is an angle in which a predetermined direction is specified and the direction is set as a reference.

In step 2140, 0 is substituted for a variable I in order to bring out sequentially the visible polygonal line sorted.

Steps 2145, 2150 and 2160 are steps that correspond to the foregoing ‘a part of the line segment seen from the viewpoint is calculated taking in consideration a positional relation between the row of the line segments and a visible region generated at the point where the processing of a previous row of line segments ends, and the range seen from the viewpoint is calculated with the processing to find a new visible region by connecting the area calculated and the visible region’.

Firstly, step 2145 determines whet her or not both ends are inside or outside the visible region regarding an I-th visible polygonal line. The processing of step 2160, 2170 or 2150 is executed respectively if the both ends are inside, the both ends are outside, or either one is inside.

Step 2150 is the processing when either one of the end points of the visible polygonal line is inside the visible region, in which the intersecting point between the visible polygonal line and the visible region and the intersecting point between the half line from the viewpoint, which passes another end of the visible polygonal line, and the visible region are calculated, a new visible region is generated such that the coordinates that constitute the two intersecting points, the visible polygonal line within the visible region, and the visible region become counter-clockwise, and a pointer to the visible polygonal line is stored. Specifically, in FIG. 69, a line segment 6901 is the I-th visible polygonal line, point B is inside the visible region, and the end point of the line segment 6901, which is not point B, is outside the visible region. A polygonal line 6902 is a side of the polygonal line that constitutes the visible region. In this case,

intersecting point C between the line segment 6901 that is the visible polygonal line and the visible region is calculated.

Further, intersecting point B′ between the half line from the viewpoint, which passes point B that is another end of the line segment 6901 as the visible polygonal line, and the visible region is compute d. The new visible region is gene rated such that the coordinates between the two intersecting points C and B′ and the visible polygonal line BC within the visible region become counter-clockwise. In other words, a new visible region having a polygonal line rat lad CBB′ as a boundary is generated. The pointer of CBB′ that is the boundary of the new visible region is stored. The ‘pointer’ is one that indicates a thing by its position, and the pointer of CBB′ is the one that indicates the position of the polygonal line called CBB′. For example, when data of sides called CB and BB′ is accumulated in a memory of a computer, a memory address where the data of sides is accumulated is stored. When this processing ends, it moves to step 2170.

Step 2160 is the processing when both of the end points of the visible polygonal line are inside the visible region, in which two line segments that connect the intersecting point, where two half lines passing the both ends of the visible region from the viewpoint cross the visible region, and the both ends of the visible region, which correspond to each of the intersecting points, and the visible polygonal line are set as new three line segments, a new visible region is generated such that the coordinates that constitute the new line segments and the visible region become counter-clockwise, and the pointer to the visible polygonal line is stored. FIG. 68 exemplifies the case where the both of the end points of the visible polygonal line are inside the visible region, where a side 6801 having end points as A and B is the visible polygonal line and the boundary of the visible region is a line segment 6802. In this case, a half line passing A is drawn from the viewpoint, and a point that crosses the line segment 6802 is computed, which is set as A′. Further, a half line passing B is draw n from the viewpoint and a point that crosses the line segment 6802 is computed, which is set as B′. Accordingly, AA′ and BB′ are obtained as the two line segments that connect to the both ends of the visible region, and A′ABB′ are connected to generate a new visible region such that the coordinates that constitute the line segments and the visible polygonal line 6801 become counter-clockwise. The pointer of A′ABB′ that is the boundary of the new visible region is store d. Sped finally, when the data of the sides called A′A, AB, and BB′ is accumulated in the memory, the memory address accumulated is stored. When this processing ends, it moves to step 2170.

Step 2170 is the processing executed after the processing of step 2160 ends after the processing of step 2150 ends in the case where the bot h ends of the I-th visible polygonal line are outside the visible region, the value of I is increased only by 1, the processing moves to step 2180 since the processing of all the visible polygonal lines has ended if I becomes equal to the number of the polygonal line s, it moves to step 2145 if not, and the processing of the next visible polygon al line is performed.

In step 2180, since the processing of all the visible polygonal lines has ended and the visible region has been computed, outputting of the visible region computed polygon data and the pointers of all the visible polygonal lines that has become a part of the visible region is performed. Specifically, to output the visible region as the polygon data, the pointer of all the visible polygonal lines that constitute the visible region are output.

In such an embodiment, since the direction that becomes a reference to decide the argument is arbitrarily specified and the visible region can be calculated, the range see n from the viewpoint can be calculated faster than using a conventionally known method when the viewpoint and the polygons exist inside the outermost polygon.

### Embodiment 19

The visible region calculator in this embodiment is one that calculates the range seen from the viewpoint in the case where the viewpoint and one or a plurality of polygons are inside one polygon (hereinafter, referred to as the ‘outermost polygon’). FIG. 62 shows the function block diagram of the visible region calculator in this embodiment, and a visible region calculator 6200 includes: an outermost visible region calculation section 6201; a visible polygonal line calculation section 6202; a visible polygonal line rearrangement section 6203; and a temporary visible polygon update section 6204.

The outermost polygon visible region calculation section 6201 finds the visible polygon that is the range seen from the viewpoint of the outermost polygon, and calculates the first temporary visible polygon. The outermost polygon and the temporary visible polygon match when the outermost polygon is the convex figure, and the flowchart that explains the calculation processing of the temporary polygon in a general shape is exemplified in FIG. 64. Firstly, in step S6401, the half lines are drawn from the view point to each vertex of the outermost polygon. Steps from step S6402 are the processing performed, where each one of the half lines drawn are brought out, and whether or not a half line is left is determined in step S6402. The processing ends if it is not left, and the polygon at this point is the temporary visible polygon. The processing moves to step S6403 if a half line is left to brought out. In step S6404, whether or not the half line crosses at an intersecting point other than the vertex of the outermost polygon is determined, the processing returns to step S6402 if not, the vertex of the outermost polygon is set as P and another intersecting point is set as Q if the half line crosses at the intersecting point other than the vertex of the outermost polygon, and the processing moves to step S6405.

In step S6405, whether or not P is nearer the viewpoint than Q. If P is not nearer the viewpoint than Q, it is the state as shown in FIG. 65 and at least the vicinity of Q can be seen from the viewpoint, and thus the processing returns to step S6402 without performing anything. If P is nearer the viewpoint than Q, it is in the situation as shown in FIG. 66, the processing thus moves to step S6406, and the area from P to Q of the outermost polygon is removed to add a line segment PQ. In other words, in FIG. 66, since the region surrounded by a line segment 6601 and a line segment 6602 cannot be seen from the viewpoint, the area from P to Q of the outermost polygon, that is, the line segment 6601 and the line segment 6602 are removed from a side 6600 of the outermost polygon to add the line segment PQ, and thus the temporary visible polygon is formed. Then, the processing returns to step S6402 to perform the processing of the next half line.

The visible polygonal line calculation section 6202 computes the visible polygonal line that is a part seen from the viewpoint for each polygon inside the outermost polygon ignoring the existence of other polygons. Specifically, regarding each polygon in the outer most polygon, it is assumed that only the polygon exists and selecting of visible sides out of the ones of the polygon is performed. In this processing, the half line is drawn from the viewpoint to a point on each side of the polygon and if the half line crosses an other side of the polygon before it crosses the side, the side cannot be seen from the viewpoint, and thus it does not become the visible polygonal line, and on the contrary. If the half line does not cross another side before it crosses the side, the side can be seen from the viewpoint, and it becomes the visible polygonal line. Note that the visible polygonal line calculation section 6202 may compute individual line segment that constitutes the visible polygonal line that is a polygonal line, instead of the polygonal line where the line segments called the visible polygonal lines are connected at the end points. Hereinafter, the individual line segment that constitutes the visible polygonal line is simply called the ‘visible polygonal line’ to simplify description.

The visible polygonal line rearrangement section 6203 arranges the visible polygonal line computed in the visible polygonal line calculation section 6202 in the argument order of a visible limit point, which has a smaller argument to a reference line that is the half line drawn from the viewpoint and the end points of the visible polygonal line. For example, in the case where there are the viewpoint and a visible polygonal line AB as exemplified in FIG. 79, when the reference line that is the half line drawn from the viewpoint is a half line 7901, the argument of end point A is 6 that is an angle formed by the half line drawn from the viewpoint to A and the reference line, the argument of end point B is τ similarly, and thus the end point A is the visible limit point of the visible polygonal line AB because θ is smaller than x. The visible polygonal rearrangement section 6203 arranges the visible polygonal line in the argument order of the visible limit point. In the following description, it is assumed that the visible polygonal line is arranged in the order of the smaller argument of the visible limit point.

The temporary visible polygon update section 6204 performs the foil owing first processing and second processing regarding the visible polygonal line in the order where the visible polygonal line has been arranged in the visible polygonal line rearrangement section. Firstly, the first processing is the processing in the case where A and B are inside the temporary visible polygon when the both ends of the visible polygonal line are set as A and B (A is set as the visible limit point), in which visible lines that are the half lines severally passing A and B are drawn from the viewpoint to the temporary polygon. A′ and B′ that are the intersecting points between the visible lines and the temporary polygon are corrupted, an area of the side from A′ to B′ of the temporary visible polygon is removed, and A′ to A, A to B, and B to B′ are sequentially connected to form a new temporary visible polygon.

Specifically, the case where the first processing is performed is the case where the visible polygonal line 6801 having A and B as the end points is inside the temporary visible polygon 6802, which is a side where the viewpoint exists, as shown in FIG. 68. In this case, the visible line that is the half line passing

A is drawn from the viewpoint to find the intersecting point with the temporary visible polygon 6802, and it is set as A′. Similarly regarding B, the visible line that is the half line passing B is draw n from the viewpoint to find the intersecting point with the temporary polygon 6802, and it is set as B′. In finding a new temporary visible polygon, 6803 and 6804 that are an area of the side from A′ to B′ of the temporary visible polygon are removed, and adding of a side A′A, a side AB and a side BB′ is performed.

The second is the processing in the case where A is outside the temporary visible polygon and B is inside where the both ends of the visible polygonal line are set as A and B (A is set as the visible limit point), and it is the processing in which an intersecting point C between the visible polygonal line and the temporary visible polygon is computed, the visible line that is the half line passing B is drawn, B′ that is the intersecting point with the temporary visible polygon is computed, an area of the side from C to B′ of the temporary visible polygon is removed, and C to B, and B to B′ are sequentially connected to form a new temporary visible polygon. Specifically, the case where the sec and processing is performed is the case where the end point B of the visible polygonal line 6901 is inside the temporary visible polygon and another end point is outside the temporary visible polygon as shown in FIG. 69. In this case, the visible polygonal line 6901, the temporary visible polygon, and the intersecting point C are computed. Further, the visible line that passes from the viewpoint to B is drawn to find B′ that is the intersecting point with the temporary visible polygon. Then, 6901 and 6902 that are an area of the side from C to B′ of the temporary visible polygon are removed, and adding of a side CB and a side BB′ is performed.

Note that a case can be considered where the both ends of the visible polygonal line exist outside the temporary visible polygon, but the temporary visible polygon is formed after the visible polygonal line is rearranged according to the argument of the visible limit point and an area see n from the viewpoint does not exist in the visible polygonal line in this case, and thus there is no need to perform processing to such a visible polygonal line.

FIG. 63 and FIG. 67 are the flowcharts that explain the operation of the visible region calculator 6200, and they can be regarded as the flowcharts that explain steps executed by the computer in order to realize the visible region calculator 6200 by the computer. In the case of realizing the visible region calculator 6200 by the computer, the function block diagram of the visible region calculator exemplified in FIG. 62 can be regarded as the diagram that shows a module configuration of a program executed by the computer.

Step S6301 is an outermost visible region calculation step, and computation of the first temporary visible region is obtained in the outermost visible region calculation section 6201. Step S6302 is a visible polygonal line calculation step, and the visible polygonal line is calculated by the visible polygonal line calculation section 6202. Step S6303 is a visible polygonal line rearrangement step, and arranging of the visible polygonal line according to the argument of the visible limit point is performed by the visible polygonal line rearrangement section 6203.

Step S6304 to step S6306 are steps in which the visible polygonal line is brought out by one to perform processing, whether or not there is no visible polygonal line is determined in step S6304, the processing ends when there is no visible polygonal line, and the temporary visible region at this point is the visible polygon. If the visible polygonal line is left, the processing moves to step S6305 to bring out the visible polygonal line. Step s6306 is a temporary visible polygon update step, and the temporary visible polygon is updated by the temporary visible polygon update section 6204.

The processing of updating the temporary visible polygon is shown by the flowchart in FIG. 67, and whether or not the both ends of the visible polygonal line are inside the temporary visible polygon is determined first in step S6701. If so, the processing moves to step S6702, and moves to step S6704 if not.

Step S6702 is executed when the both ends of the visible polygonal line are inside the temporary visible polygon, which is the case of FIG. 68. In this case, the half lines are severally drawn from the viewpoint to the end points A and B of the visible polygonal line, an intersecting point A′ and the half line passing A and the temporary visible polygon is computed, and B′ is computed similarly regarding B. In step S6703, an area from A′ to B′ of the temporary visible polygon, that is, 6803 and 6804 are removed, and A′ to A, A to B, and B to B′ are sequentially connected to form a new temporary visible polygon.

Step S6704 is executed is when neither both ends of the visible polygonal line are inside the temporary visible polygon, whether or not the end point of the visible polygon al line, which is not the visible limit point, is inside the temporary visible polygon is determined, the processing moves to step S6705 if so, and the processing of the flowchart in FIG. 67 ends if not.

The case where the processing has moved to step 6705 is the case exemplified in FIG. 69, and C that is the intersecting point between the temporary visible polygon and the visible polygonal line is computed. In step S6706, the half line passing B is draw n from the viewpoint to find B′ that is the intersecting point with the temporary visible polygon. In step S6707, an area of the side from C to B′ of the temporary visible polygon is remove d, and C to B and B to B′ are sequentially connected to form a new visible polygon.

According to the visible region calculator or the visible region calculation program by this embodiment. It is possible that the reference line is specified in any direction to start calculation of the visible region, and the visible region can be computed more efficiently than to find by the conventionally known method.

### Embodiment 20

FIG. 70 shows the function block diagram of the route information generator of embodiment 20 in the present invention. In this embodiment, a route information generator 7000 has: visible region calculation means 7001; route search means 7002; mark extraction means 7003; guidance map generation means 7004; and guidance sentence generation means 7005.

The visible region calculation means 7001 calculates the range seen from the user. As the visible region calculation means 7001, calculation means using a conventionally known algorithm or the visible region calculator in embodiment 18 or embodiment 19 may be used.

The route search means 7002 searches the route from the point where the user is now or the starting point that the user enters to the destination that the user enters. To obtain the point where the user is now, a GPS (global positioning system) is used or the identifier of the tag is obtained by receiving the radio wave emitted from the tag embedded in the wall surface or the floor, and the position is obtained from the identifier. Further, the point where the user is now may be found by detecting an acceleration and integrating it. Further more, the map may be displayed on the touch panel to allow the user to instruct the starting point and the destination, the starting point and the destination may be accepted by using an input device such as a keyboard, or the starting point and the destination may be accepted by the voice recognition. A table in which the starting points and the destinations are correlated is pre pared as FIG. 47 to search the route, and to obtain the route from the starting point give n to any destination, a line where the starting point given appears in the row of the starting points is retrieved, a value of the row of the final destinations on the line is obtained, a line that has the value obtained as the starting point is retrieved, and a value of the row of the final destinations on the line is obtained, which are repeated and continued until the destination is obtained as the value of the row of the final destinations. By performing such processing, a row of two pairs that consist of a point (origin) and another point (ending point) is obtained.

The mark extraction means 7003 extracts the mark to be guided out of the visible region from the current position or the point where the guidance is given. Specifically, the visible region, which is the range seen from the current position or the point where the guidance is given, is calculated by the visible region calculation means 7001 such that the user proceeds on the route searched by the route search means 7002, the landmark to be guided to, that is, the landmark that shows the direction where the user should proceed next is extracted out of the visible region. For this extraction, using the table where the points on the route and their coordinate positions are correlated as shown in FIG. 48 and the table where the marks and their coordinate positions are correlated shown in FIG. 49, when the user has reached a point on the route, the direction from the point to a point where he/she should proceed is calculated, and finding of the landmark seen in the direction near the direction is performed.

The guidance map generation means 7004 generates the map for route guidance, on which the route, the mark extracted, and the point to be guided are displayed. Specifically, it generates the map where the route searched by the route search means 7002, the landmark extracted by the mark extracting means 7003, and the point to be guided, that is, the point where the user should go next are displayed. For this purpose, the table where the points and their coordinates are correlated shown in FIG. 48 and the table where the land marks and their coordinates are correlated shown in FIG. 49 are used, and out of the coordinate of the landmark, the coordinate of the point to be guided, and the coordinate of the point to go to next, the map including these coordinates may be searched from the map database.

The guidance sentence generation means 7005 gene rates the guidance sentence of the route. For example, the table as shown in FIG. 38 where two or three points, which continuously constitute the route searched by the route search means 7002, and the guidance sentence data are correlated is prepared, and the guidance sentence is generated referring to the table, which is cited as one example.

FIG. 71 is the flowchart that explains the processing of the route information generator 7000 in this embodiment. In step S7101, the route from the point where the user is now or the starting point where the user enters to the destination where the user enters is searched by using the route search means 7002. A loop is formed after step 7102, and from step S7103 to step S7107 are repeated until it is determined that the route is not left in step S7102.

In step S7103, the route is brought out. Specifically, a pairs of the origin and the ending point is brought out. In step S7104, the visible region from the origin is calculated by the visible region calculation means 7001. In step S7105, the mark is extracted by the mark extraction means 7003 from the visible region calculated at step S7104. In step S7106, the map is generated by the guidance map generation means 7004. In step S7107, the guidance sentence is generated by the guidance sentence generation means.

The map and the guidance sentence generated in this manner are accumulated once by accumulation means inside or outside the route guidance information generator, and are provided to the user when necessary, or moving of the user on the route is detected and, for example, in the case where passing of the point to be guided is detected, the map and the guidance sentence regarding the point to be guided next may be generated and provided to the user.

### Embodiment 21

FIG. 72 exemplifies the function block diagram of the route guidance system according to embodiment 21 of the present invention. In this embodiment, the route guidance system has: a route guidance apparatus 7201; a route information database 7205; a terminal 7204; a position detection apparatus 7206; a map database 7207; and a guidance sentence database 7208.

The route guidance apparatus 7201 has the route information generator 7000 and the position determination means 7202. The route information generator 7000 is the one described in embodiment 20.

The position determination means 7202 detects the current position of the terminal 7204, that is, a current terminal position. As a detection method, a method in which the user operates the terminal and the current position entered is received, or the tag is used as the position detection apparatus 7206, in which the identifier of the tag is obtained by receiving the radio wave emitted from it, and the terminal 7204 may transmit it to the position determination means 7202. Conversely, the terminal emits the radio wave and the position detection apparatus 7206 receives it, and then the position determination means 7202 may obtain which position detection apparatus has received to detect the position of the terminal 7204.

The route information database 7205 accumulates the information regarding the route obtained. The ‘information regarding the route obtained’ is the information regarding the route obtained by the route information generator 7000, and the map for route guidance, which has been generated by the guidance map generation means 7004 of the route information generator 7000, and the guidance sentence of the route, which has been generated by the guidance sentence generation means 7005, are accumulated. At this point, the point searched by the route search means 7002, the map, and the guidance sentence are correlated and accumulated.

The position detection means 7206 is means for obtaining the current positional information. The ‘current positional information’ is the position where the terminal 7204 is now, and the tag may be used as the position detection means 7206 or the position detection means 7206 may be a satellite of the GPS.

The map database 7207 accumulates the map data. Specifically, it is the database to obtain, from the current position of the terminal, which has been detected by the position determination means 7202, what is around it, in which direction it is, and in what kind of situation it is (situation of the floor or the like, situation of congestion of people, level of danger, or the like).

The guidance sentence database 7208 accumulates the data for generating the guidance sentence. The data for generating the guidance sentence is the template for generating the guidance sentence, which is a sentence including variables X, Y and Z such as ‘Y of X is Z.’, for example, and it is data from which a specific guidance sentence is generated if specific

values of X, Y and Z are determined.

FIG. 73 is the flowchart that explains the operation of the route guidance system in this embodiment. In step S7301, the route information generator 7000 obtains the starting point and the destination. For example, it obtains the starting point and the destination entered from the terminal 7204.

Alternatively, it may obtain them from an input apparatus connected to the route guidance apparatus 7201. In step S7302, the route information generator 7000 searches the route, and it generates the route information to accumulate in the route information database at step S7303.

From step S7304 to step S7307 form the loop executed until the guidance ends, and whether or not the guidance has ended is determined at step S7304. For example, it is determined whether or not the position determination means 7202 has detected that the terminal 7204 is at the destination, or whether or not the user has informed that he/she did not desire further guidance by pressing a button on the terminal 7204. The processing ends if the end of guidance has been detected, and it moves to step S7305 if not. In step S7305, the position of the terminal 7204 is detected and obtained by the position determination means 7202. In step S7306, the route information of the position, which has been obtained in step S7305, is obtained by retrieving the route information database. At this point, the map database 7207 and the guidance sentence database are retrieved simultaneously, what is around the position obtained from the map database 7207 or the like is obtained, the template for generating the guidance sentence is obtained from the guidance sentence database 7208, and the retrieval result of the map database 7207 may be embedded in the variable areas of the template. For example, ‘ahead’ as X, ‘stairs’ as Y, and ‘dangerous’ as Z are obtained from the map database 7207, the template saying ‘Y of X is Z.’ is obtained, and the guidance sentence saying ‘The stairs ahead are dangerous.’ may be generated. In step S7307, the route information obtained in step S7306 is transmitted to the terminal 7204. And at this point, the guidance sentence, which is obtained by embedding the retrieval result of the map database 7207 in the variable areas of the template, may be transmitted.

### Embodiment 22

FIG. 74 is the flowchart that explains the processing of a route leading unit in the present invention. The route leading unit is an apparatus to allow the terminal to display the mark on the map to lead the user, and the route leading unit of the present invention obtains the current position of the terminal at a regular time interval, and switches the map displayed on the terminal to a map on which the next mark in the route data is displayed when it detects approach to a mark that exists in the route data. Firstly, the route leading unit waits until a predetermined time passes in step S7401 and after a predetermined time has passed, the processing moves to step S7402 to obtain the position of the terminal. For example, the terminal receives the radio wave of the tag and the position of the terminal is obtained based on the identifier of the tag that has received the radio wave, or the terminal receives the radio wave from GPS satellites and the position is obtained form its result. In step S7403, whether or not it has approached the mark is deter mined, the processing moves to step S7404 if it is determined that it has approached it, and returns to step S7401 if not. In step S7404, the map on which the next mark is displayed is transmitted to the terminal in order to switch to the map on which the next mark is displayed. The foregoing description is based on the premise that the terminal and the route leading unit are in remote positions, but the terminal may include the route leading unit.

As described, when it is detected that it has approached the landmark, the user having the terminal can be notified beforehand of the direction to go at the next point by switching to the map on which the next mark is displayed, and route leading easy for the user to understand ca n be performed. Further,

since an error is involved in obtaining the current position, display of the map on which the next landmark is displayed after the user has passed the landmark can be prevented, and the user can be prevented from being confused.

### Embodiment 23

FIG. 75 is the function block diagram that explains an embodiment of the route guidance system of the present invention. In this embodiment, the route guidance system includes: a route guidance apparatus 7500; the route information database 7205; the terminal 7204; the position detection apparatus 7206; the map database 7207; and the guidance sentence database 7208. The route guidance apparatus 7500 includes a route leading unit 7501 and the position determination means 7202.

The route leading unit 7501 is an apparatus to allow the terminal to display the mark on the map to lead the user, and the route leading unit in embodiment 22 is used in this embodiment.

The position determination means 7202 detects the current position of the terminal 7204. The result detected is sent to the route leading unit 7501 to enable the route leading unit 7501 to obtain the current position periodically.

The route information database 7205 accumulates the information regarding the route obtained. Although not shown in FIG. 75, the route guidance apparatus has a route information generator that searches the route from the starting point and the destination and generates the information regarding the route, and the route information database 7205 accumulates the information regarding the route generated and obtained by this route information generator. The ‘information regarding the route’ includes the points to pass, the image data and the guidance sentence to guide the points to pass, and the like.

FIG. 76 and FIG. 77 show one example of the contents of the route information database 7205, and the table of FIG. 76 correlates the routes formed by the points to pass with the origins and the ending points and stores them. For example, the first line of this table means that the points to be passed are u, w and y when the starting point is A and the destination is D. FIG. 77 is the table in which the map data and the guidance sentences to be displayed on the terminal are correlated with the point to be passed and stored, which means that map 1024 is displayed on the terminal as the map and s7055 is used as the guidance sentence as the guidance sentence when the point to be guided is g, for example. The route leading unit 7501 obtains the position of the terminal from the position determination means 7202 at a predetermined time interval, reads out the table of FIG. 76 to obtain the point to be guided next when the terminal approaches the mark that exists in the route, that is, the point to be guided, and obtains the map and the guidance sentence from FIG. 77 to transmit them to the terminal.

The terminal 7204 displays the route guidance information. The route guidance information is information such as the map and the guidance sentence transmitted from the route leading unit 7501, which guides the user so as to move on the route.

The map database 7207 accumulates the map data. Specifically, it is the database to obtain what is around it, in which direction it is, and in what kind of situation it is (situation of the floor or the like, situation of congestion of people, level of danger, or the like), from the current position of the terminal, which has been detected by the position determination means 7202.

The guidance sentence database 7208 accumulates the data for generating the guidance sentence. The data for generating the guidance sentence is the template for generating the guidance sentence, which is a sentence including variables X, Y and Z such as ‘Y of X is Z.’, for example, and it is data from which a specific guidance sentence is generated if specific values of X, Y and Z are determined.

The route leading unit 7501, after having obtained the current position of the terminal, determines whether or not the terminal has approached the mark and retrieves the map database 7207 to obtain the situation around the terminal, and generates the guidance sentence by using the data for generating the guidance sentence obtained from the guidance sentence database

7208 and transmits it to the terminal 7204.

With this kind of route guidance system, when it is detected that the user has approached the mark, the user having the terminal can be notified beforehand of the direction to go at the next point by switching to the map on which the next mark is displayed, and route leading easy for the user to understand can be performed. Further, sine e an error is Involved in obtaining the current position, displaying of the map on which the next mark is displayed after the user has passed the mark can be prevented, and the user can be prevented from being confused. Furthermore, by generating an appropriate guidance sentence while the map database 7207 is retrieved to obtain a surrounding situation, the guidance service easy for the user to understand can be provided.

### Embodiment 24

FIG. 78 shows the function block diagram of the route guidance system of embodiment 24 of the present invention. The difference from the route guidance system of embodiment 23 is that the route in formation generator 7000 is clarified in a route guidance apparatus 7800 and the route information generator 7000 uses the route information generator of embodiment 20.

Since the visible region of the user who moves on the route is calculated to generate the route information and the guidance is given based on it by using the route information generator of embodiment 20, the guidance service easy for the user to understand can be provided.

### Embodiment 25

FIG. 80 is the block diagram that shows a configuration example of a route guidance system in embodiment 25 according to the present invention, and it comprises: a position detection apparatus 820 that obtains the user's current positional information; a portable terminal 830 that transfers the information from the position detection apparatus to the route guidance apparatus and displays the route guidance information from the route guidance apparatus; a map database 840 where the database of map is accumulated; a guidance sentence database 860 where the data to constitute the guidance sentence of route based on the route search result; a route information database 850 where the route guidance information generated by the route information generation means is stored; and a route guidance apparatus 810 that generates the route information and leads the route based on the route in formation generated.

The route guidance apparatus 810 comprises: position determination means 811 that converts the information of the position detection apparatus into coordinates; route information generation means 814 that generates the route information; and route leading means 818 that leads the route based on the route information generated.

FIG. 81 is the block diagram of the route information generation means, and it comprises: visible region calculation means 971 that calculates the range seen from the current position; route search means 970 that searches the route to the destination; signpost extraction means 981 that extracts the mark to be guided from the visible region; guidance map generation means that generates the map for route guidance based on the route search result; and guidance sentence synthesis means 983 that generates the route guidance sentence.

FIG. 82 is the block diagram of the route leading means, the route leading means 818 receives the user's current position from the position determination means 811 and determines the guidance sentence and the map to be displayed, obtains the route information to be displayed from the route information data 850 if the route guidance data currently displayed needs to be converted, and send it to the portable terminal 830.

The processing in the route information generation means 814 will be described according to the processing shown in FIG. 83. A case is considered where the outermost polygon, the facilities A, B and C are arranged, and the route network winds in front of the facilities A as in FIG. 89. When the positional information detected by the position detection apparatus 820 is passed from the portable terminal 830 of FIG. 80 to the position determination means 811 of the route guidance apparatus 810, the route information generation means 814 is activated to send the positional information if it is sent from the portable terminal to which the route leading is not performed. When it is sent from the portable terminal to which the route leading is performed, the positional information is sent to the route leading means 818. The route information generation means 814 is activated and the positional information of the starting point and the destination is passed from the position determination means 811, and reads the data related to the map from the map database 840 and the data to generate an amount for guidance from the guidance sentence database 860 (1800). The positional information of a starting point a and a destination d is passed to the route search means 970, and the route search is performed to receive a node row of a, b, c and d on the route (1810). The starting point a is set as the guidance point (1815). The visible region from the guidance point a is computed by the visible region calculation means 971 as in FIG. 90, the mark extraction means 981 finds the facilities A, B and C that are within the visible region by tracing the pointers of the polygonal line, and the node b which has not been reached on the route within the visible region is obtained (1820). Whether or not the destination d is within the visible region is determined (1825). Since it is not within the visible region, appropriate facilities that is the facilities C, which is the facilities adjacent to the visible region and farthest from a on the route, is selected to store as the mark in this case, and the node b on the route nearest from the mark C is set as the next guidance point (1830), for example. The visible region calculation means 971 finds the visible region from the guidance point b as in FIG. 91, the mark extraction means 981 finds the facilities A, B and C that are within the visible region by tracing the pointers of the polygonal line, and the node c which has not been reached on the route within the visible region is obtained (1820). Whether or not the destination d is within the visible region (1825). Since it is not within the visible region, appropriate facilities that is the facilities B, which is the facilities adjacent to the visible region and farthest from b on the route, is selected to store as the mark in this case, and the node c on the route nearest from the mark B is set as the next guidance point (1830), for example. The visible region calculation means 971 finds the visible region from the guidance point c as in FIG. 92, the mark extract ion means 981 finds the facilities A, B and C that are within the visible region by tracing the pointers of the polygonal line, and the node d which has not been reached on the route within the visible region is obtained (1820). Whether or not the destination d is within the visible region (1825) is determined. Since d is within the visible region, facilities' name X of the marks C and B extracted, ‘kiosk’ and ‘coffee shop’ for example, and typical points of the fascinating are found from the map database 840 after storing D as the mark, a traveling direction Z at the nodes, that is, corners b and c are found as left turn and right turn respectively from the coordinate data of the nodes a, b, c and d. Further, a positional relation Y with the corresponding marks C and B is found as ahead and right from the coordinate data of the typical points and the coordinate data of the nodes (1835). The guidance map generation means 184 generates the maps for guidance, which correspond to the facilities, as in FIG. 93 and FIG. 94, and they are arranged in the route order, that is, in this order (1840). The guidance sentence synthesis means 183 selects the guidance sentence template in the guidance sentence database in accordance with types of the variables, which are the facilities name, the traveling direction, and the node position in this case, inserts the data of the marks and the direction found in (1835) into ‘Z at Y of X’ to generate the guidance sentences such as ‘Left turn at the front of the kiosk’ and ‘Right turn at the right of the coffee shop’ (1835), and arranges them in the route order, that is, in this order (1845). The route guidance sentence generated and the map for route guidance are output to the route information database 850.

### Embodiment 26

The processing in the route leading means 818 will be described according to the processing shown in FIG. 84. A case is considered where leading is performed on the route generated in embodiment 25. At the point when the leading begins. FIG. 93 and a corresponding guidance sentence are displayed, a mark currently displayed is applied to the mark C. When the positional information detected by the position detection apparatus 820 is passed from the portable terminal 830 of FIG. 80 to the position determination means 811 of the route guidance apparatus 810, the positional information is sent to the route leading means 818 if it is sent from the portable terminal to which the route guidance is performed. When the route leading means 818 is activated (1900), the positional coordinate shown by an asterisk of FIG. 95 is obtained as the position of the portable terminal 830 from the posit ion determination means 811 (1910). Referring to the map database 840, since there is no mark in which the positional coordinate obtained has the distance from the coordinates of the nodes showing the marks in the route information data, which becomes a thresh old value (10 meters for example) or less (1920), the map FIG. 93 currently displayed is superposed by the current position with the asterisk, and it is displayed on the portable terminal 830 as in FIG. 95 (1922). The current positional information is obtained as the position of the portable terminal 830, the positional coordinate shown by the asterisk of FIG. 96 from the position determination means 811 (1910). Referring to the map database 840, since there is no mark in which the positional coordinate obtained has the distance from the coordinates of the nodes showing the marks in the route information data, which becomes the threshold value or less (1920), the map FIG. 93 currently displayed is superposed by the current position with the asterisk, and it is displayed as in FIG. 96 (1922). The current positional information is obtained as the position of the portable terminal 830, the positional coordinate shown by the asterisk of FIG. 97 from the position determination means 811 (1910). Refer ring to the map database 840, there is a mark c in which the positional coordinate obtained has the di stance from the coordinates of the nodes showing the marks in the route information data, which becomes the threshold value or less, it is different from the mark C currently displayed (1920), and the mark B is not the destination (1925), therefore, a mark currently displayed is applied to the mark B and the map for guidance FIG. 94, in which the mark B in the route information database 850 is displayed, is brought out and the current position is super posed, and it is sent to the portable terminal 830 together with the guidance sentence that corresponds to the map (1930). Hereinafter, as it is similarly performed and the portable terminal approaches the destination, the destination D becomes the mark (1920), therefore, the mark is determined as the destination (1925), a message that tells of reaching the destination is sent (1940), and the processing ends (1950).

As described, the present invention has effects that performing an appropriate route guidance even in the open space is made possible by guiding the signpost or the destination to the user in the open space and that it is made possible even in the portable terminal of low resolution by the frame view, the illustration image or the binary image, where the direction is made constant in the route guidance in the premises, which has been hard to understand in a conventional frame view, regardless of how the route diagram is drawn in the open space, or without re-editing the route to the point to be guided even when a large number of destinations are in the open space.

Further, in performing the route leading by setting the tag detection as a trigger, provision of the appropriate route information is made possible eve n in the case of causing a position detection error involved with the range where the radio wave reaches from the tag and when tag reading means fail to read the tag, or the like.

The present invention is one to provide the route information easy for a person with normal vision to understand regardless of the state of the route network by forming the visible region in a high-speed and providing the mark seen by eyes when the user moves on the route based on the visible region formed. Note that the present invention is applicable not only in the premises but also outside if the region is compartmentalized to constitute the outermost polygon.

1. A route guidance apparatus, which is comprised of: position determination means that detects a current position of a user; visible region calculation means that calculates a range where the user can see from the current position detected; route search means that searches a route from a starting point to a destination; traveling direction calculation means that calculates a traveling direction from a visible region and the route; signpost extraction means that extracts a signpost to be guided from the visible region; and route guidance sentence generation means that generates a route guidance sentence of the route found.

2. A route guidance apparatus, which is comprised of: position determination means that detects a current position of a user; visible region calculation means that calculates a range where the user can see from the current position detected; route search means that searches a route from a starting point to a destination; traveling direction calculation means that calculates a traveling direction from a visible region and the route; mark extraction means that extracts a mark to be guided from the visible region; image data retrieval means that retrieves binary image data or illustration image data, which are specified to guide a point to pass on said route; guidance sentence synthesis means for synthesizing a guidance sentence to guide the point to pass.

3. A route guidance apparatus, which is comprised of: route search means that searches a route from a starting point to a destination; first frame map generation means that cuts out points to pass from map data in a size, which can be displayed on a display screen of a portable terminal, in order to guide the point to pass, and cuts out such that connection points of the route in each of frames match in cutting out; guidance sentence synthesis means that synthesizes a guidance sentence to guide the point to pass.

4. A route guidance apparatus, which is comprised of: route search means that searches a route from a starting point to a destination; second frame map generation means that cuts out point to pass from map data in a size, which can be displayed on a display screen of a portable terminal, in order to guide the point to pass, and cuts out such that the route in each of frames is displayed in the center of the screen in cutting out; guidance sentence synthesis means that synthesizes a guidance sentence to guide the point to pass.

5. A route guidance apparatus of claim 3, wherein the guidance sentence synthesis means synthesizes a guidance sentence using a moving direction of a user as a reference in order to guide point to pass.

6. A route guidance apparatus of claim 3, wherein the guidance sentence synthesis means synthesizes a guidance sentence using a railway direction as a reference in order to guide point to pass on a platform of a train station.

7. A route guidance apparatus of claim 3, wherein the guidance sentence synthesis means does not perform guidance to turn right/left at a first direction turning point taking into consideration an error of position determination means at a starting point when the starting point is near the point where a direction turn is made for the first time, but guides a mark showing a direction turning direction from the direction turning point and performs guidance to turn right/left from a second direction turning point.

8. A route guidance apparatus of claim 3, wherein the guidance sentence synthesis means provides information of a route such that it guides positional information of a vicinity of a tag when it detects the tag for a vision-impaired person, in guidance regarding the route, guidance sentences regarding mark information along the route, which are severally punctuated by punctuations, are arranged in a route order and a user performs a button operation for each guidance sentence to read out the sentences sequentially.

9. A route guidance apparatus according to claim 1, comprising: route leading means that displays a frame view, a binary image or an illustration image, which corresponds to a tag, and a route guidance sentence on a terminal or reads out a guidance sentence, synchronously with detecting a tag placed in premises.

10. A route guidance apparatus according to claim 1, comprising: route leading means that displays a frame view, a binary image or an illustration image, which corresponds to a tag, and a route guidance sentence on a terminal or reads out a guidance sentence, in accordance with input of the user.

11. A route guidance apparatus, which is comprised of: position determination means that detects a current position of a user; visible region calculation means that calculates a visible region which is a range where the user can see from the current position detected; route search means that searches a route from a starting point to a destination; traveling direction calculation means that calculates a traveling direction from the visible region and the route; mark extraction means that extracts a mark to be guided from the visible region; and guidance sentence generation means that generates a route guidance sentence of the route found.

12. A route guidance apparatus according to claim 11 wherein when an intersecting point exists between the route searched by said route search means and a boundary of the visible region calculated by said visible region calculation means, the traveling direction calculation means calculates a direction of the intersecting point as a traveling direction, and the mark extraction means extracts a mark seen from said user in a direction that exists within a visible region calculated by said visible region calculation means and that is near the direction calculated by said traveling direction calculation.

13. A route guidance apparatus, which is comprised of: position determination means that detects a current position of a user; visible region calculation means that calculates a range where the user can see from the current position detected; route search means that searches a route from a starting point to a destination; traveling direction calculation means that calculates a traveling direction from a visible region and the route; mark extraction means that extracts a mark to be guided from the visible region; image data search means that searches viewpoint image data specified in order to guide point to pass on said route; and guidance sentence generation means for generating a guidance sentence in order to guide the point to pass.

14. A route guidance apparatus, which is comprised of: route search means that searches a route from a starting point to a destination; and first frame map generation means that cuts out a map around a point to pass as a frame from a map database in order to guide the point to pass, and cuts out each frame such that a part of the route in each frame overlaps in cutting out; and guidance sentence generation means that generates a guidance sentence to guide the point to pass.

15. A route guidance apparatus, which is comprised of: route search means that searches a route from a starting point to a destination; second frame map generation means that cuts out a map around a point to pass as a frame from a map database in order to guide the point to pass, and cuts out such that the route in each frame is displayed in the center of a screen in cutting out; and guidance sentence generation means that generates a guidance sentence to guide the point to pass.

16. A route guidance apparatus according to claim 11, wherein the guidance sentence generation means generates the guidance sentence using a moving direction of the user as a reference in order to guide the point to pass.

17. A route guidance apparatus according to claim 11, wherein in the case where the route guidance apparatus guides a route passing the points in a platform of train station premises, said guidance sentence generation means generates the guidance sentence using a direction of a railway for the user in the train station platform as a reference in order to guide the point to pass.

18. A route guidance apparatus according to claim 11, wherein the guidance sentence generation means does not perform guidance to turn right/left at a first direction turning point when the starting point is near the point where a direction turn is made for the first time but generates the guidance sentence of a mark showing a direction of turning direction at the direction turning point.

19. A route guidance apparatus according to claim 11, comprising: tag detection means that detects a tag, and characterized in that the guidance sentence generation means generates the guidance sentence that guides positional information near the tag detected by the tag detection means.

20. A route guidance apparatus according to claim 11, wherein the guidance sentence generation means has a guidance sentence request acceptance function that accepts a guidance sentence request being a request for reading out the guidance sentence, and the guidance sentence generation means arranges the guidance sentences for each of mark information along the route in the route order and reads out each guidance sentence sequentially when it accepts a guidance sentence request based on the guidance sentence request acceptance function.

21. A route guidance apparatus according to claim 19, wherein the apparatus arranges the guidance sentences for each of mark information along the route in the route order and reads out each guidance sentence sequentially, synchronously with detecting the tag by the tag detection means.

22. A route guidance apparatus according to claim 11, wherein the guidance sentence generation means has a user characteristic information acceptance function that accepts user characteristic information being information regarding a user's characteristic, and the guidance sentence generation means provides route information in accordance with user characteristic information accepted based on the user characteristic information acceptance function.

23. A route guidance apparatus according to claim 11, wherein the guidance sentence generation means, in the case where the user characteristic information accepted based on the user characteristic information acceptance function shows that the user is a vision-impaired person, said guidance sentence generation means arranges the guidance sentences for each mark information along the route in the route order and reads out each guidance sentence sequentially.

24. A route guidance apparatus according to claim 11, comprising: tag detection means that detects tags placed in premises; and route leading means that displays a frame view or a viewpoint image, which corresponds to a tag position, and the guidance sentence or reads out the guidance sentence, synchronously with detecting the tag by the tag detection means.

25. A route guidance apparatus according to claim 11, wherein the position detection means detects the current position of the user by a tag, which comprises: user request obtaining means that obtains a user's request; and route leading means that displays a frame view or a viewpoint image, which corresponds to the tag, and the guidance sentence on a terminal or reads out the guidance sentence in a route order in accordance with the user's request obtained by said user request obtaining means.

26. A visible region calculator, wherein, in the case where a viewpoint and one or a plurality of polygons are in one polygon, a visible region from the viewpoint regarding an outermost polygon is computed first, an area seen from the viewpoint only for each polygon is computed next as in a row of continuous line segments regarding the polygons other than the outermost polygon, the row of the line segments computed is arranged in an argument order, an area of the line segment seen from the viewpoint is computed in an arrangement order taking in consideration a positional relation of the row of the line segments with a visible region generated at the point where the processing of the row of the line segments and a previous row of line segments ends, and the range seen from the viewpoint is calculated by the processing to find a new visible region by connecting the area computed and the visible region.

27. A visible region calculator that calculates a range seen from a viewpoint in the case where the viewpoint and one or a plurality of polygons are in an outermost polygon having the following configuration: a) an outermost visible region calculation section that finds a visible polygon being a range seen from the viewpoint inside the outermost polygon and calculates a first temporary visible polygon; b) a visible polygonal line calculation section that computes a visible polygonal line being a part seen from said viewpoint of the polygon regarding each polygon inside the outermost polygon; c) a visible polygonal line rearrangement section that arranges the visible polygonal lines in the order of the argument of a visible limit point, which has a smaller argument between a reference line that is a half line drawn from the viewpoint and the end points of the visible polygonal line; d) a temporary visible polygon update section that performs the following processing 1 and 2 regarding the visible polygonal line in an arrangement order: 1) the processing where, when both ends of the visible polygonal line are set as A and B, wherein A is set as the visible limit point, in the case where A and B are inside the temporary visible polygon, half lines severally passing A and B are drawn from the viewpoint to the temporary visible polygon, A′ and B′ that are intersecting points between the visible lines and the temporary visible polygon are computed, an area of the side from A′ to B′ of the temporary visible polygon is removed, and A′ to A, A to B and B to B′ are sequentially connected to form a new temporary visible polygon; and 2) the processing where, in the case where A is outside the temporary visible polygon and B is inside, an intersecting point C between the visible polygonal line and the temporary visible polygon is computed, the visible line being the half line passing B is drawn from the viewpoint, B′ being the intersecting point with the temporary visible polygon is computed, an area of the side from C to B′ of the temporary visible polygon is removed, and C to B, and B to B′ are sequentially connected to form a new temporary visible polygon.

28. A visible region calculation program for calculating a range seen from a viewpoint in the case where the viewpoint and one or a plurality of polygons are in an outermost polygon, wherein it allows a computer to execute the following steps: a) an outermost visible region calculation step where a visible polygon being a range seen from the viewpoint inside the outermost polygon is computed and a first temporary visible polygon is calculated; b) a visible polygonal line calculation step in which a visible polygonal line being an area seen from said viewpoint of the polygon is computed regarding each polygon inside the outermost polygon; c) a visible polygonal line rearrangement step where the visible polygonal lines are arranged in the order of the arguments of a visible limit point, which has a smaller argument between a reference line that is a half line drawn from the viewpoint and the end points of the visible polygonal line; d) a temporary visible polygon update step where the following processing 1 and 2 is performed regarding the visible polygonal line in an arrangement order: 1) the processing where, when both ends of the visible polygonal line are set as A and B, wherein A is set as the visible limit point, in the case where A and B are inside the temporary visible polygon visible lines that are half lines severally passing A and B are drawn from the viewpoint to the temporary polygon, A′ and B′ that are the intersecting points between the visible lines and the temporary polygon are computed, an area of the side from A′ to B′ of the temporary visible polygon is removed, and A′ to A, A to B, and B to B′ are sequentially connected to form a new temporary visible polygon; and 2) the processing where, in the case where A is outside the temporary visible polygon and B is inside, an intersecting point C between the visible polygonal line and the temporary visible polygon is computed, the visible line being the half line passing B is drawn from the viewpoint, B′ being the intersecting point with the temporary visible polygon is computed, an area of the side from C to B′ of the temporary visible polygon is removed, and C to B and B to B′ are sequentially connected to form a new temporary visible polygon.

29. A route information generator, comprising: visible region calculation means that calculates a range seen from a user; route search means that searches a route from a point where the user is now or a starting point that the user enters to a destination that the user enters; mark extraction means that extracts a mark to be guided out of a visible region from a current position or a point where guidance is given; guidance map generation means that generates a map for the route guidance, on which said route, the mark extracted, the current position and the point where the guidance is given are displayed; and guidance sentence generation means that generates a guidance sentence of the route.

30. A route information generator according to claim 29, wherein said visible region calculation means is a visible region calculator, wherein, in the case where a viewpoint and one or a plurality of polygons are in one polygon, a visible region from the viewpoint regarding an outermost polygon is computed first an area seen from the viewpoint only for each polygon is computed next as in a row of continuous line segments regarding the polygons other than the outermost polygon, the row of the line segments computed is arranged in an argument order, an area of the line segment seen from the viewpoint is computed in an arrangement order taking in consideration a positional relation of the row of the line segments with a visible region generated at the point where the processing of the row of the line segments and a previous row of line segments ends, and the range seen from the viewpoint is calculated by the processing to find a new visible region by connecting the area computed and the visible region.

31. A route guidance system, comprising: a route guidance apparatus having a route information generator comprising: visible region calculation means that calculates a range seen from a user; route search means that searches a route from a point where the user is now or a starting point that the user enters to a destination that the user enters; mark extraction means that extracts a mark to be guided out of a visible region from a current position or a point where guidance is given; guidance map generation means that generates a map for the route guidance, on which said route, the mark extracted, the current position and the point where the guidance is given are displayed; and guidance sentence generation means that generates a guidance sentence of the route, and position determination means that detects a current position of a terminal; a route information database that accumulates information regarding a route obtained; a terminal that displays route guidance information; a position detection apparatus that obtains current positional information; a map database that accumulates map data; and a guidance sentence database to accumulate data for generating a guidance sentence.

32. A route leading unit to allow a terminal to display a mark on a map to lead a user, wherein it obtains a current position of the terminal at a predetermined time interval, and switches the map displayed on the terminal to a map on which the next mark in route data is displayed when it detects approach to a mark that exists in the route data.

33. A route guidance apparatus according to claim 11, wherein the position determination means obtains the current position of the terminal at a predetermined time interval, and the guidance sentence generation means generates the guidance sentence of the route regarding the next mark to the terminal when it detects approaching to a mark that exists in the route searched by the route search means.

34. A route guidance system, comprising: a route guidance apparatus having a route leading unit to allow a terminal to display a mark on a map to lead a user, wherein it obtains a current position of the terminal at a predetermined time interval, and switches the map displayed on the terminal to a map on which the next mark in route data is displayed when it detects approach to a mark that exists in the route data, and position determination means that detects a current position of a terminal; a route information database that accumulates information regarding a route obtained; a terminal that displays route guidance information; a position detection apparatus that obtains current positional information; a map database that accumulates map data; and a guidance sentence database that accumulate data for generating a guidance sentence.

35. A route guidance system, comprising: a route guidance apparatus having a route information generator comprising: visible region calculation means that calculates a range seen from a user; route search means that searches a route from a point where the user is now or a starting point that the user enters to a destination that the user enters; mark extraction means that extracts a mark to be guided out of a visible region from a current position or a point where guidance is given; guidance map generation means that generates a map for the route guidance, on which said route, the mark extracted, the current position and the point where the guidance is given are displayed; and guidance sentence generation means that generates a guidance sentence of the route, a route leading unit to allow a terminal to display a mark on a map to lead a user, wherein it obtains a current position of the terminal at a predetermined time interval, and switches the map displayed on the terminal to a map on which the next mark in route data is displayed when it detects approach to a mark that exists in the route data, and position determination means that detects a current position of a terminal; a route information database that accumulates information regarding a route obtained; a terminal that displays route guidance information; a position detection apparatus that obtains current positional information; a map database that accumulates map data; and a guidance sentence database that accumulate data for generating a guidance sentence.

36. A route guidance apparatus of claim 4, wherein the guidance sentence synthesis means synthesizes a guidance sentence using a moving direction of a user as a reference in order to guide point to pass.

37. A route guidance apparatus of claim 4, wherein the guidance sentence synthesis means synthesizes a guidance sentence using a railway direction as a reference in order to guide point to pass on a platform of a train station.

38. A route guidance apparatus of claim 4, wherein the guidance sentence synthesis means does not perform guidance to turn right/left at a first direction turning point taking into consideration an error of position determination means at a starting point when the starting point is near the point where a direction turn is made for the first time, but guides a mark showing a direction turning direction from the direction turning point and performs guidance to turn right/left from a second direction turning point.

39. A route guidance apparatus of claim 4, wherein the guidance sentence synthesis means provides information of a route such that it guides positional information of a vicinity of a tag when it detects the tag for a vision-impaired person, in guidance regarding the route, guidance sentences regarding mark information along the route, which are severally punctuated by punctuations, are arranged in a route order and a user performs a button operation for each guidance sentence to read out the sentences sequentially.

40. A route guidance apparatus according to claim 13, wherein the guidance sentence generation means generates the guidance sentence using a moving direction of the user as a reference in order to guide the point to pass.

41. A route guidance apparatus according to claim 14, wherein the guidance sentence generation means generates the guidance sentence using a moving direction of the user as a reference in order to guide the point to pass.

42. A route guidance apparatus according to claim 15, wherein the guidance sentence generation means generates the guidance sentence using a moving direction of the user as a reference in order to guide the point to pass.

43. A route guidance apparatus according to claim 13, wherein in the case where the route guidance apparatus guides a route passing the points in a platform of train station premises, said guidance sentence generation means generates the guidance sentence using a direction of a railway for the user in the train station platform as a reference in order to guide the point to pass.

44. A route guidance apparatus according to claim 14, wherein in the case where the route guidance apparatus guides a route passing the points in a platform of train station premises, said guidance sentence generation means generates the guidance sentence using a direction of a railway for the user in the train station platform as a reference in order to guide the point to pass.

45. A route guidance apparatus according to claim 15, wherein in the case where the route guidance apparatus guides a route passing the points in a platform of train station premises, said guidance sentence generation means generates the guidance sentence using a direction of a railway for the user in the train station platform as a reference in order to guide the point to pass.

46. A route guidance apparatus according to claim 13, wherein the guidance sentence generation means does not perform guidance to turn right/left at a first direction turning point when the starting point is near the point where a direction turn is made for the first time but generates the guidance sentence of a mark showing a direction of turning direction at the direction turning point.

47. A route guidance apparatus according to claim 14, wherein the guidance sentence generation means does not perform guidance to turn right/left at a first direction turning point when the starting point is near the point where a direction turn is made for the first time but generates the guidance sentence of a mark showing a direction of turning direction at the direction turning point.

48. A route guidance apparatus according to claim 15, wherein the guidance sentence generation means does not perform guidance to turn right/left at a first direction turning point when the starting point is near the point where a direction turn is made for the first time but generates the guidance sentence of a mark showing a direction of turning direction at the direction turning point.

49. A route guidance apparatus according to claim 13, comprising: tag detection means that detects a tag, and characterized in that the guidance sentence generation means generates the guidance sentence that guides positional information near the tag detected by the tag detection means.

50. A route guidance apparatus according to claim 14, comprising: tag detection means that detects a tag, and characterized in that the guidance sentence generation means generates the guidance sentence that guides positional information near the tag detected by the tag detection means.

51. A route guidance apparatus according to claim 15, comprising: tag detection means that detects a tag, and characterized in that the guidance sentence generation means generates the guidance sentence that guides positional information near the tag detected by the tag detection means.

52. A route guidance apparatus according to claim 13, wherein the guidance sentence generation means has a guidance sentence request acceptance function that accepts a guidance sentence request being a request for reading out the guidance sentence, and the guidance sentence generation means arranges the guidance sentences for each of mark information along the route in the route order and reads out each guidance sentence sequentially when it accepts a guidance sentence request based on the guidance sentence request acceptance function.

53. A route guidance apparatus according to claim 14, wherein the guidance sentence generation means has a guidance sentence request acceptance function that accepts a guidance sentence request being a request for reading out the guidance sentence, and the guidance sentence generation means arranges the guidance sentences for each of mark information along the route in the route order and reads out each guidance sentence sequentially when it accepts a guidance sentence request based on the guidance sentence request acceptance function.

54. A route guidance apparatus according to claim 15, wherein the guidance sentence generation means has a guidance sentence request acceptance function that accepts a guidance sentence request being a request for reading out the guidance sentence, and the guidance sentence generation means arranges the guidance sentences for each of mark information along the route in the route order and reads out each guidance sentence sequentially when it accepts a guidance sentence request based on the guidance sentence request acceptance function.

55. A route guidance apparatus according to claim 49, wherein the apparatus arranges the guidance sentences for each of mark information along the route in the route order and reads out each guidance sentence sequentially, synchronously with detecting the tag by the tag detection means.

56. A route guidance apparatus according to claim 50, wherein the apparatus arranges the guidance sentences for each of mark information along the route in the route order and reads out each guidance sentence sequentially, synchronously with detecting the tag by the tag detection means.

57. A route guidance apparatus according to claim 51, wherein the apparatus arranges the guidance sentences for each of mark information along the route in the route order and reads out each guidance sentence sequentially, synchronously with detecting the tag by the tag detection means.

58. A route guidance apparatus according to claim 13, wherein the guidance sentence generation means has a user characteristic information acceptance function that accepts user characteristic information being information regarding a user's characteristic, and the guidance sentence generation means provides route information in accordance with user characteristic information accepted based on the user characteristic information acceptance function.

59. A route guidance apparatus according to claim 14, wherein the guidance sentence generation means has a user characteristic information acceptance function that accepts user characteristic information being information regarding a user's characteristic, and the guidance sentence generation means provides route information in accordance with user characteristic information accepted based on the user characteristic information acceptance function.

60. A route guidance apparatus according to claim 15, wherein the guidance sentence generation means has a user characteristic information acceptance function that accepts user characteristic information being information regarding a user's characteristic, and the guidance sentence generation means provides route information in accordance with user characteristic information accepted based on the user characteristic information acceptance function.

61. A route guidance apparatus according to claim 13, wherein the guidance sentence generation means, in the case where the user characteristic information accepted based on the user characteristic information acceptance function shows that the user is a vision-impaired person, said guidance sentence generation means arranges the guidance sentences for each mark information along the route in the route order and reads out each guidance sentence sequentially.

62. A route guidance apparatus according to claim 14, wherein the guidance sentence generation means, in the case where the user characteristic information accepted based on the user characteristic information acceptance function shows that the user is a vision-impaired person, said guidance sentence generation means arranges the guidance sentences for each mark information along the route in the route order and reads out each guidance sentence sequentially.

63. A route guidance apparatus according to claim 15, wherein the guidance sentence generation means, in the case where the user characteristic information accepted based on the user characteristic information acceptance function shows that the user is a vision-impaired person, said guidance sentence generation means arranges the guidance sentences for each mark information along the route in the route order and reads out each guidance sentence sequentially.

64. A route guidance apparatus according to claim 13, comprising: tag detection means that detects tags placed in premises; and route leading means that displays a frame view or a viewpoint image, which corresponds to a tag position, and the guidance sentence or reads out the guidance sentence, synchronously with detecting the tag by the tag detection means.

65. A route guidance apparatus according to claim 13, wherein the position detection means detects the current position of the user by a tag, which comprises: user request obtaining means that obtains a user's request; and route leading means that displays a frame view or a viewpoint image, which corresponds to the tag, and the guidance sentence on a terminal or reads out the guidance sentence in a route order in accordance with the user's request obtained by said user request obtaining means.

66. A route information generator according to claim 29, wherein said visible region calculation means is a visible region calculator that calculates a range seen from a viewpoint in the case where the viewpoint and one or a plurality of polygons are in an outermost polygon having the following configuration: a) an outermost visible region calculation section that finds a visible polygon being a range seen from the viewpoint inside the outermost polygon and calculates a first temporary visible polygon; b) a visible polygonal line calculation section that computes a visible polygonal line being a part seen from said viewpoint of the polygon regarding each polygon inside the outermost polygon; c) a visible polygonal line rearrangement section that arranges the visible polygonal lines in the order of the argument of a visible limit point, which has a smaller argument between a reference line that is a half line drawn from the viewpoint and the end points of the visible polygonal line; d) a temporary visible polygon update section that performs the following processing 1 and 2 regarding the visible polygonal line in an arrangement order: 1) the processing where, when both ends of the visible polygonal line are set as A and B, wherein A is set as the visible limit point, in the case where A and B are inside the temporary visible polygon, half lines severally passing A and B are drawn from the viewpoint to the temporary visible polygon, A′ and B′ that are intersecting points between the visible lines and the temporary visible polygon are computed, an area of the side from A′ to B′ of the temporary visible polygon is removed, and A′ to A, A to B and B to B′ are sequentially connected to form a new temporary visible polygon; and 2) the processing where, in the case where A is outside the temporary visible polygon and B is inside, an intersecting point C between the visible polygonal line and the temporary visible polygon is computed, the visible line being the half line passing B is drawn from the viewpoint, B′ being the intersecting point with the temporary visible polygon is computed, an area of the side from C to B′ of the temporary visible polygon is removed, and C to B, and B to B′ are sequentially connected to form a new temporary visible polygon.

67. A route guidance system as claimed in claim 31 wherein said visible region calculation means is a visible region calculator, wherein, in the case where a viewpoint and one or a plurality of polygons are in one polygon, a visible region from the viewpoint regarding an outermost polygon is computed first, an area seen from the viewpoint only for each polygon is computed next as in a row of continuous line segments regarding the polygons other than the outermost polygon, the row of the line segments computed is arranged in an argument order, an area of the line segment seen from the viewpoint is computed in an arrangement order taking in consideration a positional relation of the row of the line segments with a visible region generated at the point where the processing of the row of the line segments and a previous row of line segments ends, and the range seen from the viewpoint is calculated by the processing to find a new visible region by connecting the area computed and the visible region.

68. A route guidance system as claimed in claim 31 wherein said visible region calculation means is a visible region calculator that calculates a range seen from a viewpoint in the case where the viewpoint and one or a plurality of polygons are in an outermost polygon having the following configuration: a) an outermost visible region calculation section that finds a visible polygon being a range seen from the viewpoint inside the outermost polygon and calculates a first temporary visible polygon; b) a visible polygonal line calculation section that computes a visible polygonal line being a part seen from said viewpoint of the polygon regarding each polygon inside the outermost polygon; c) a visible polygonal line rearrangement section that arranges the visible polygonal lines in the order of the argument of a visible limit point, which has a smaller argument between a reference line that is a half line drawn from the viewpoint and the end points of the visible polygonal line; d) a temporary visible polygon update section that performs the following processing 1 and 2 regarding the visible polygonal line in an arrangement order: 1) the processing where, when both ends of the visible polygonal line are set as A and B, wherein A is set as the visible limit point, in the case where A and B are inside the temporary visible polygon, half lines severally passing A and B are drawn from the viewpoint to the temporary visible polygon, A′ and B′ that are intersecting points between the visible lines and the temporary visible polygon are computed, an area of the side from A′ to B′ of the temporary visible polygon is removed, and A′ to A, A to B and B to B′ are sequentially connected to form a new temporary visible polygon; and 2) the processing where, in the case where A is outside the temporary visible polygon and B is inside, an intersecting point C between the visible polygonal line and the temporary visible polygon is computed, the visible line being the half line passing B is drawn from the viewpoint, B′ being the intersecting point with the temporary visible polygon is computed, an area of the side from C to B′ of the temporary visible polygon is removed, and C to B, and B to B′ are sequentially connected to form a new temporary visible polygon.

69. A route guidance system as claimed in claim 35 wherein said visible region calculation means is a visible region calculator, wherein, in the case where a viewpoint and one or a plurality of polygons are in one polygon, a visible region from the viewpoint regarding an outermost polygon is computed first, an area seen from the viewpoint only for each polygon is computed next as in a row of continuous line segments regarding the polygons other than the outermost polygon, the row of the line segments computed is arranged in an argument order, an area of the line segment seen from the viewpoint is computed in an arrangement order taking in consideration a positional relation of the row of the line segments with a visible region generated at the point where the processing of the row of the line segments and a previous row of line segments ends, and the range seen from the viewpoint is calculated by the processing to find a new visible region by connecting the area computed and the visible region.

70. A route guidance system as claimed in claim 35 wherein said visible region calculation means is a visible region calculator that calculates a range seen from a viewpoint in the case where the viewpoint and one or a plurality of polygons are in an outermost polygon having the following configuration: a) an outermost visible region calculation section that finds a visible polygon being a range seen from the viewpoint inside the outermost polygon and calculates a first temporary visible polygon; b) a visible polygonal line calculation section that computes a visible polygonal line being a part seen from said viewpoint of the polygon regarding each polygon inside the outermost polygon; c) a visible polygonal line rearrangement section that arranges the visible polygonal lines in the order of the argument of a visible limit point, which has a smaller argument between a reference line that is a half line drawn from the viewpoint and the end points of the visible polygonal line; d) a temporary visible polygon update section that performs the following processing 1 and 2 regarding the visible polygonal line in an arrangement order: 1) the processing where, when both ends of the visible polygonal line are set as A and B, wherein A is set as the visible limit point, in the case where A and B are inside the temporary visible polygon, half lines severally passing A and B are drawn from the viewpoint to the temporary visible polygon, A′ and B′ that are intersecting points between the visible lines and the temporary visible polygon are computed, an area of the side from A′ to B′ of the temporary visible polygon is removed, and A′ to A, A to B and B to B′ are sequentially connected to form a new temporary visible polygon; and 2) the processing where, in the case where A is outside the temporary visible polygon and B is inside, an intersecting point C between the visible polygonal line and the temporary visible polygon is computed, the visible line being the half line passing B is drawn from the viewpoint, B′ being the intersecting point with the temporary visible polygon is computed, an area of the side from C to B′ of the temporary visible polygon is removed, and C to B, and B to B′ are sequentially connected to form a new temporary visible polygon.
